(19) United States
(12) Patent Application Publication
(10) Pub. No.: US 2024/0286453 A1
(43) Pub. Date: Aug. 29, 2024

(54) VEHICLE SEAT AIR-CONDITIONING DEVICE

(71) Applicant: Panasonic Automotive Systems Co., Ltd., Kanagawa (JP)

(72) Inventors: Takuya NAKAGAWA, Shiga (JP); Yuki MAKITA, Kanagawa (JP); Tatehiko INOUE, Osaka (JP); Yoshihiko MAEDA, Hyogo (JP); Yuki OGAWA, Osaka (JP)

(21) Appl. No.: 18/587,607

(22) Filed: Feb. 26, 2024

(30) Foreign Application Priority Data
Feb. 27, 2023 (JP) 2023-028409
Feb. 27, 2023 (JP) 2023-028410
Feb. 27, 2023 (JP) 2023-028479
Feb. 26, 2024 (JP) 2024-026237

(51) Int. Cl. B60H 1/00

(52) U.S. Cl. CPC B60H 1/00285; B60H 1/00457; B60H 1/00821

(57) ABSTRACT

A vehicle seat air-conditioning device is used for a seat having a seat back and a bottom. The vehicle seat air-conditioning device includes: a blower that is incorporated in the seat and guides air generated by a vehicle air-conditioning apparatus mounted on the vehicle; an outlet ventilation path that guides air guided from the blower to a first outlet provided in a front surface of the seat back that is a surface located to face a person seated on the seat; a processor configured to control the blower when executing the program. The processor is configured to control at least one of an air volume or a temperature of the air generated by the vehicle air-conditioning apparatus, based on a thermal sensation parameter determined from an environmental parameter including a detection result of information regarding a temperature of air discharged from the first outlet.

### CROSS-REFERENCE TO RELATED APPLICATIONS

This application is based upon and claims the benefit of priority from Japanese Patent Applications No. 2023-028409, 2023-028410, and 2023-028479, filed on Feb. 27, 2023 and Japanese Patent Application No. 2024-026237, filed on Feb. 26, 2024, the entire contents of all of which are incorporated herein by reference.

### FIELD

The present disclosure relates to a vehicle seat air-conditioning device.

### BACKGROUND

In recent years, it has been required to provide a comfortable air-conditioning environment for a person seated on a seat. For example, JP 2019-131144 A discloses a vehicle air-conditioning apparatus including an air conditioner main body that is mounted on a vehicle and generates conditioned air, a first duct having one end connected to the air conditioner main body and through which the conditioned air sent from the air conditioner main body flows, a second duct having one end provided inside a seat in which air is sucked at the one end from an occupant side of the seat to the inside by sucking air at the other end, a third duct having one end provided inside the seat, a blower that feeds conditioned air and air sucked in from the first duct and the second duct to the third duct, and a blowout portion capable of blowing out the conditioned air and air flowing from the other end to the one end of the third duct, to the outside of the seat.

However, in the related art, there is a case where a comfortable air-conditioning environment cannot be provided to an occupant seated on the seat.

The present disclosure has been made to solve the above problem, and provides a vehicle seat air-conditioning device capable of providing a more comfortable air-conditioning environment for an occupant seated on a seat.

### SUMMARY

A vehicle seat air-conditioning device according to the present disclosure is disposed in a vehicle and used for a seat having a seat back and a bottom. The vehicle seat air-conditioning device includes a blower, an outlet ventilation path, a memory, and a processor. The blower is incorporated in the seat and guides air generated by a vehicle air-conditioning apparatus mounted on the vehicle. The outlet ventilation path guides air guided from the blower to a first outlet provided in a front surface of the seat back that is a surface located to face a person seated on the seat. The processor is coupled to the memory and configured to control the blower when executing the program. The processor is configured to control at least one of an air volume or a temperature of the air generated by the vehicle air-conditioning apparatus, based on a thermal sensation parameter determined from an environmental parameter including a detection result of information regarding a temperature of air discharged from the first outlet.

### BRIEF DESCRIPTION OF THE DRAWINGS

FIG. 1 is a side view illustrating a vehicle air conditioning system of a vehicle in which a vehicle seat air-conditioning device according to a first embodiment is disposed;

FIG. 2 is a perspective view illustrating an appearance of a seat provided with the vehicle seat air-conditioning device according to the first embodiment;

FIG. 3 is a cross-sectional view of a seat provided with the vehicle seat air-conditioning device taken along line I-I in FIG. 2;

FIG. 4 is a block diagram illustrating a vehicle seat air-conditioning system according to the first embodiment;

FIG. 5 is a diagram for describing a correlation between a temperature and a flow rate ratio in a center console of the vehicle seat air-conditioning device according to the first embodiment;

FIG. 6 is a diagram for describing a correlation between a temperature in a center console of the vehicle seat air-conditioning device according to the first embodiment and a flow rate of air discharged from a first outlet;

FIG. 7 is a flowchart illustrating processing of the vehicle seat air-conditioning device according to the first embodiment;

FIG. 8 is a schematic side view illustrating an air flow path in the seat when Step S103 in FIG. 7 is executed;

FIG. 9 is a schematic side view illustrating an air flow path in the seat when Step S106 or S108 in FIG. 7 is executed;

FIG. 10 is a cross-sectional view of a seat provided with a vehicle seat air-conditioning device according to Modification 1 of the first embodiment;

FIG. 11 is a flowchart illustrating processing of the vehicle seat air-conditioning device according to Modification 1 of the first embodiment;

FIG. 12 is an enlarged cross-sectional view of a first outlet of a vehicle seat air-conditioning device according to Modification 2 of the first embodiment;

FIG. 13 is a flowchart illustrating processing of a vehicle seat air-conditioning device according to Modification 2 of the first embodiment;

FIG. 14 is a block diagram illustrating a vehicle seat air-conditioning device according to the second embodiment;

FIG. 15 is a flowchart illustrating a first example of processing of the vehicle seat air-conditioning device according to the second embodiment;

FIG. 16 is a diagram for describing an outline of thermal sensation parameters of the vehicle seat air-conditioning device according to the second embodiment;

FIG. 17 is a diagram for describing a method for determining a thermal sensation parameter of the vehicle seat air-conditioning device according to the second embodiment;

FIG. 18 is a flowchart illustrating a second example of processing of the vehicle seat air-conditioning device according to the second embodiment;

FIG. 19 is a flowchart illustrating a third example of processing of the vehicle seat air-conditioning device according to the second embodiment;

FIG. 20 is a block diagram illustrating a vehicle seat air-conditioning device according to a modification of the second embodiment;

FIG. 21 is a flowchart illustrating processing of the vehicle seat air-conditioning device according to the modification of the second embodiment;

FIG. 22 is a diagram for describing a method of detecting a temperature in a first ventilation path of the vehicle seat air-conditioning device according to the modification of the second embodiment;

FIG. 23 is a time chart illustrating control of a flow rate ratio of a vehicle seat air-conditioning device according to a third embodiment;

FIG. 24 is a time chart illustrating a first example of control of a discharge flow rate of a vehicle seat air-conditioning device according to a modification of the third embodiment;

FIG. 25 is a time chart illustrating a second example of control of a flow rate ratio in the vehicle seat air-conditioning device according to the modification of the third embodiment;

FIG. 26 is a time chart illustrating a second example of control of a discharge flow rate of the vehicle seat air-conditioning device according to the modification of the third embodiment;

FIG. 27 is a flowchart illustrating processing of a vehicle seat air-conditioning device according to a fourth embodiment;

FIG. 28 is a flowchart illustrating processing of the vehicle seat air-conditioning device according to the fourth embodiment;

FIG. 29 is a flowchart illustrating processing of the vehicle seat air-conditioning device according to the fourth embodiment;

FIG. 30 is a cross-sectional view of a seat provided with a vehicle seat air-conditioning device according to a modification of the fourth embodiment; and

FIG. 31 is a cross-sectional view of a seat provided with a vehicle seat air-conditioning device according to another modification.

### DETAILED DESCRIPTION

Hereinafter, embodiments will be described in detail with reference to the drawings as appropriate. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art.

Note that the accompanying drawings and the following description are provided for those skilled in the art to fully understand the present disclosure, and are not intended to limit the subject matter described in the claims.

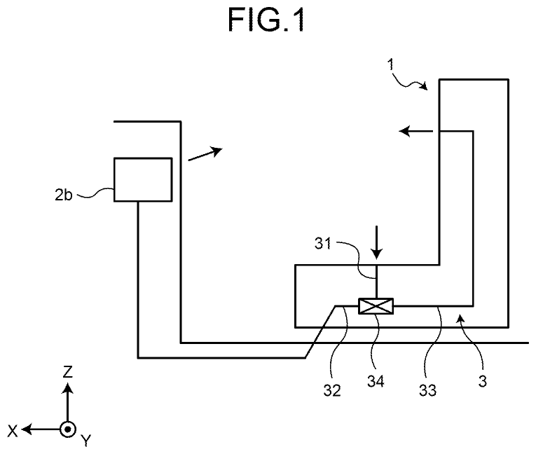

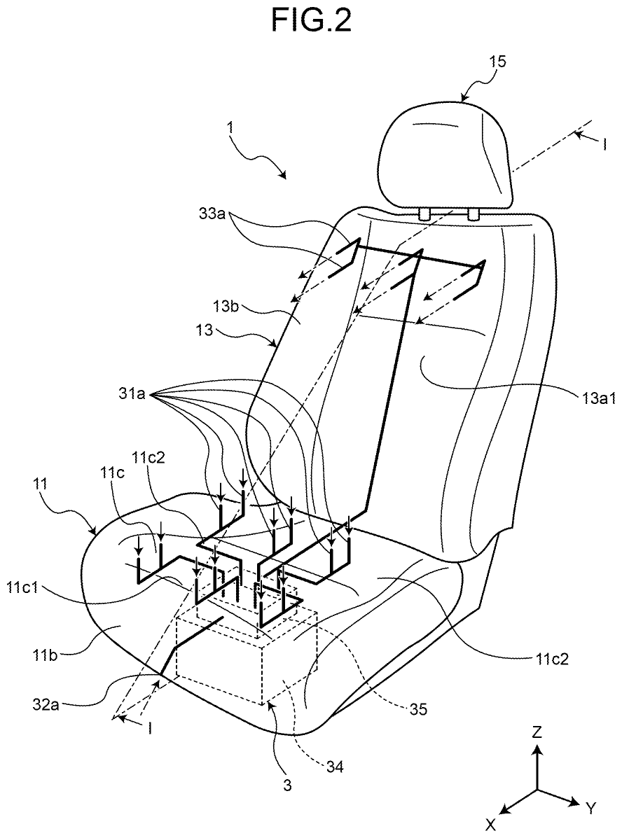

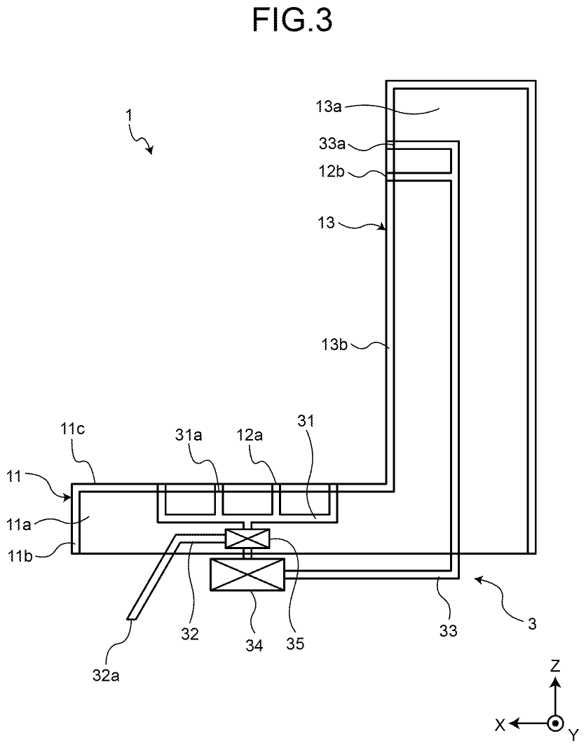

In the following description, a front-back direction of a seat is referred to as an X-axis direction, and a vertical direction of the seat is referred to as a Z-axis direction. Furthermore, a lateral direction of the seat, that is, a direction perpendicular to each of the X-axis direction and the Z-axis direction is referred to as a Y-axis direction. Further, in the X-axis direction, a front side of the seat is referred to as a plus direction side, and a rear side of the seat is referred to as a minus direction side. Further, in the Y-axis direction, a left side of the seat (right front side as viewed in FIG. 2) is referred to as a plus direction side, and the opposite side is referred to as a minus direction side. Further, a right side is a right side of an occupant with respect to a traveling direction of the vehicle when the occupant is seated on the seat, and is a Y-axis minus direction side. Further, a left side is a left side of the occupant with respect to the traveling direction of the vehicle when the occupant is seated on the seat, and is a Y-axis plus direction side. Further, in the Z-axis direction, an upper side of the seat is referred to as a plus direction side, and a lower side of the seat is referred to as a minus direction side. The same applies to FIGS. 1 and 3 and subsequent drawings.

### First Embodiment

### Configuration

FIG. 1 is a side view illustrating a vehicle air conditioning system of a vehicle in which a vehicle seat air-conditioning device 3 according to a first embodiment is disposed.

As illustrated in FIG. 1, the vehicle in which the vehicle seat air-conditioning device 3 is disposed is provided with a seat 1 and a vehicle air-conditioning apparatus 2b.

The seat 1 is a seat on which an occupant is seated, and examples includes, for example, a driver seat, a passenger seat, and the like. The vehicle air-conditioning apparatus 2b is an air-conditioning device for air-conditioning the vehicle interior. Specifically, the vehicle air-conditioning apparatus 2b is mounted on a vehicle body of the vehicle and is covered with an instrument panel of the vehicle. An evaporator for cooling air sucked into the vehicle air-conditioning apparatus 2b is accommodated in the vehicle air-conditioning apparatus 2b. Note that the vehicle air-conditioning apparatus 2b is an example of a “temperature adjustment unit” in the claims.

Next, the vehicle seat air-conditioning device 3 according to the first embodiment will be described.

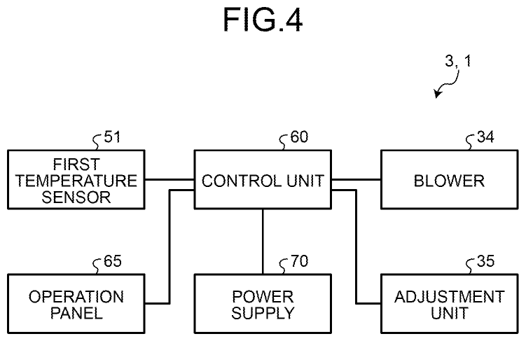

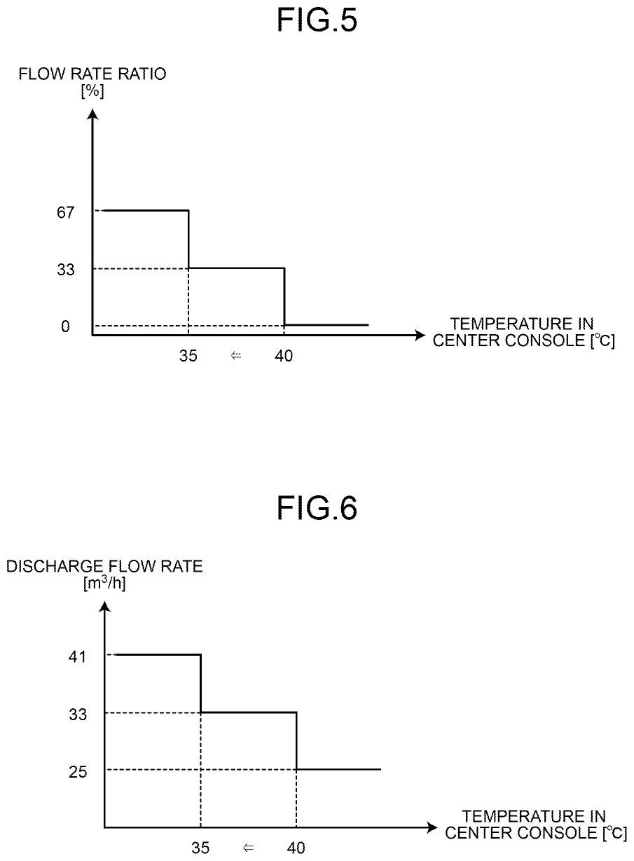

FIG. 2 is a perspective view illustrating an appearance of the seat 1 provided with the vehicle seat air-conditioning device 3 according to the first embodiment. In FIG. 2, a solid arrow corresponds to air guided to a first ventilation path 31 (described later with reference to FIG. 3 and the like), a broken arrow corresponds to air guided to a second ventilation path 32, and a one-dot chain line arrow corresponds to air guided to a third ventilation path 33. FIG. 3 is a cross-sectional view of the seat 1 including the vehicle seat air-conditioning device 3 taken along line I-I in FIG. 2. FIG. 4 is a block diagram illustrating the vehicle seat air-conditioning device 3 according to the first embodiment. FIG. 5 is a diagram for describing a correlation between a temperature in a center console of the vehicle seat air-conditioning device 3 and a flow rate ratio according to the first embodiment. FIG. 6 is a diagram for describing a correlation between the temperature in the center console of the vehicle seat air-conditioning device 3 and a flow rate of air discharged from a first outlet 33a according to the first embodiment.

As illustrated in FIGS. 2 and 3, for example, the seat 1 mounted on the vehicle or the like cools or warms the occupant seated on the seat adjacent to the seat 1 by discharging air to the body of the occupant. Specifically, the seat 1 can cool or warm the body of the occupant seated on the seat 1 by discharging air from the first outlet 33a used in the seat 1 to the head, neck, acromion, and the like of the occupant. Note that the air discharged from the first outlet 33a may flow toward the back, waist, and the like of the occupant. Further, it is also possible to generate an airflow by sucking air from a first inlet 31a formed at a position corresponding to the buttocks and the thighs and to suppress stuffiness between the buttocks and the thighs and the seat 1. Such a seat 1 includes a bottom 11 on which an occupant is seated, a seat back 13, a headrest 15, the vehicle seat air-conditioning device 3, and a power supply 70.

### Bottom 11

As illustrated in FIGS. 2 and 3, the bottom 11 is a seat cushion that supports the buttocks, thighs, and the like of the occupant seated on the seat 1. The bottom 11 includes a first seat pad 11a corresponding to a cushion material and a first seat cover 11b covering the first seat pad 11a.

The first seat pad 11a is made by, for example, urethane foam or the like, and constitutes a bottom main body. The first seat pad 11a has a thick substantially rectangular plate shape, and is disposed in a posture substantially parallel to the X-Y plane. The first seat pad 11a supports the buttocks, thighs, and the like of the seated occupant.

The first seat pad 11a is provided with the first ventilation path 31 for guiding air sucked in from a first ventilation port 12a of a seat surface 11c which is a surface of the first seat cover 11b facing the Z-axis plus direction.

Note that FIG. 3 illustrates an example in which the first ventilation port 12a and the first ventilation path 31 correspond to each other in a one-to-one correspondence, but they are not limited to this configuration. That is, a plurality of the first ventilation ports 12a may be formed for one first ventilation path 31. In this case, for example, a sponge-like cushion member may be disposed between the first seat pad 11a and the first seat cover 11b so as to communicate with the plurality of first ventilation ports 12a with respect to one first ventilation path 31.

The first inlet 31a is formed in the seat surface 11c which is a portion of the seat 1 facing where the occupant is seated on the seat 1. That is, the first inlet 31a opens toward the vehicle interior.

In the present embodiment, a plurality of the first inlets 31a is formed. Specifically, the first inlets 31a are formed in a central portion 11c1 and outer edges 11c2 of the seat surface 11c which is a surface facing where an occupant is seated on the seat 1. In the present embodiment, the outer edges 11c2 are an outer edge 11c2 of the first seat pad 11a to the Y-axis plus direction with respect to the central portion 11c1, and an outer edge 11c2 of the first seat pad 11a to the Y-axis minus direction with respect to the central portion 11c1. A plurality of the first inlets 31a of the central portion 11c1 is formed along the X-axis direction, and a plurality of the first inlets 31a of the outer edge 11c2 is disposed to each of the Y-axis plus direction and the Y-axis minus direction with respect to the first inlets 31a of the central portion 11c1, and is formed along the X-axis direction. That is, the plurality of the first inlets 31a formed along the X-axis direction is formed in a plurality of rows so as to be arranged in the Y-axis direction on a surface of the first seat pad 11a to the Z-axis plus direction.

Further, the second ventilation path 32 for guiding air sucked in from a second inlet 32a is provided in a space to the Z-axis minus direction of the first seat pad 11a. More specifically, the second ventilation path 32 is provided so as to communicate from an inside of the first seat pad 11a to an outside of the surface of the first seat pad 11a opposite to the seat surface 11c. The second inlet 32a is formed at a position other than the seat surface 11c which is the surface facing where the occupant is seated on the seat 1. In the present embodiment, the second inlet 32a is formed on the outside of the surface of the first seat pad 11a opposite to the seat surface 11c, and is connected to the vehicle air-conditioning apparatus 2b mounted on the vehicle.

Further, the first seat pad 11a is provided with, in addition to the first ventilation path 31 and the second ventilation path 32, a part of the third ventilation path 33, a blower 34, an adjustment unit (adjuster) 35, and the like. Air flows into at least one of the first ventilation path 31 or the second ventilation path 32 in the first seat pad 11a by driving of the blower 34. The first ventilation path 31 formed in the first seat pad 11a may be a simple through hole formed in the first seat pad 11a, or may be constituted by a ventilation duct. Further, the second ventilation path 32 formed in the space to the Z-axis minus direction of the first seat pad 11a is constituted by, for example, a ventilation duct. Note that the second ventilation path 32 may be formed in the first seat pad 11a. In this case, the second ventilation path 32 may be a simple through hole formed in the first seat pad 11a, or may be constituted by a ventilation duct.

The first seat cover 11b is a cover that covers the first seat pad 11a. The first seat cover 11b is, for example, a leather cover perforated so as to form the first ventilation ports 12a, a fiber cover, or the like.

The first seat cover 11b is formed with the first ventilation ports 12a for taking in air. The first ventilation ports 12a are formed at positions corresponding to the first inlets 31a of the vehicle seat air-conditioning device 3 in the seat surface 11c which is a surface facing where the occupant is seated on the bottom 11. In the present embodiment, a plurality of the first ventilation ports 12a is formed along the X-axis direction with respect to the first seat cover 11b, and a plurality of rows arranged in the Y-axis direction is formed. In FIG. 2, end points of solid arrows correspond to the first ventilation ports 12a.

Air sucked in from the first ventilation ports 12a is guided to the first inlets 31a of the vehicle seat air-conditioning device 3, is sucked in from the first inlets 31a, and is guided to the first ventilation path 31. Thus, the first ventilation ports 12a also serves as inlets that suck air convecting onto the seat surface 11c by suction force from the first inlets 31a by driving of the vehicle seat air-conditioning device 3. Note that the first ventilation ports 12a may be a part of the first ventilation path 31. In this case, the first ventilation ports 12a are an example of the first inlets 31a.

Note that, in the present embodiment, the first seat cover 11b does not cover the second inlet 32a, but the first seat cover 11b may cover the second inlet 32a. In this case, similarly to the first ventilation ports 12a corresponding to the first inlets 31a, ventilation ports corresponding to the second inlets 32a may be formed in the first seat cover 11b. Air sucked in from the ventilation port may be guided to the second ventilation path 32.

### Seat Back 13

The seat back 13 is a backrest portion that supports an acromion, a back, a waist, and the like of the occupant seated on the seat 1. The seat back 13 is long along the Z-axis direction and is disposed so as to rise with respect to the bottom 11. The seat back 13 includes a second seat pad 13a corresponding to a cushion material and a second seat cover 13b covering the second seat pad 13a.

The second seat pad 13a is made by urethane foam or the like, for example, and is disposed in a posture rotatable about the Y-axis direction. The second seat pad 13a supports the acromion, the back, the waist, and the like of the seated occupant.

The second seat pad 13a is provided with a part of the third ventilation path 33 for discharging air sucked in from the first inlets 31a and the second inlet 32a. In the second seat pad 13a, at least one of the air flowing into the first ventilation path 31 or the air flowing into the second ventilation path 32 in the first seat pad 11a by the driving of the blower 34 is guided to the third ventilation path 33 and discharged from the first outlet 33a. The first outlet 33a is formed in the second seat pad 13a of the seat back 13. The third ventilation path 33 formed in the second seat pad 13a may be a simple through hole formed in the second seat pad 13a or may be constituted by a ventilation duct.

The second seat cover 13b is a cover that covers second seat pad 13a. The second seat cover 13b is, for example, a leather cover perforated so as to form a second ventilation port 12b, a fiber cover, or the like.

The second seat cover 13b is formed with the second ventilation port 12b for discharging sucked air. The second ventilation port 12b is provided in a surface (a surface to the X-axis plus direction) opposed to the occupant seated on the bottom 11, and at a position corresponding to the first outlet 33a of the third ventilation path 33. The first outlet 33a is disposed vertically above the first inlets 31a and the second inlet 32a, that is, to the Z-axis plus direction. In the present embodiment, a plurality of the second ventilation ports 12b is formed in the second seat cover 13b. The plurality of the second ventilation ports 12b is interspersed from the right shoulder to the left shoulder of the occupant seated on the seat 1, for example. For example, the plurality of the second ventilation ports 12b is formed in a portion of the second seat cover 13b corresponding to at least one or more portions of the head, the neck, the acromion, the back, and the waist of the occupant.

The air guided to the third ventilation path 33 and discharged from the first outlet 33a passes through the plurality of the second ventilation ports 12b via at least one of the first ventilation path 31 and the second ventilation path 32. That is, when the air guided to the third ventilation path 33 via at least one of the first ventilation path 31 and the second ventilation path 32 is discharged from the first outlet 33a by the driving of the vehicle seat air-conditioning device 3, the air is guided to the second ventilation ports 12b. Thus, the second ventilation ports 12b also serve as outlets for discharging air to the outside of the seat 1. Note that the second ventilation ports 12b may be a part of the third ventilation path 33. In this case, the second ventilation ports 12b are an example of the first outlet 33a.

### Headrest 15

The headrest 15 is a headrest that supports the head of the occupant seated on the seat 1. The headrest 15 is fixed to an end portion of the seat back 13 to the Z-axis plus direction.

### Vehicle Seat Air-Conditioning Device 3

The vehicle seat air-conditioning device 3 is an air-conditioning device that is used in the seat 1 of the vehicle and can discharge air from behind an occupant seated on the seat 1. The vehicle seat air-conditioning device 3 performs air blowing by sucking in at least one of air convecting around the seat 1 or air generated by the vehicle air-conditioning apparatus 2b mounted on the vehicle, and discharging the sucked air to the occupant to blow air. For example, when the vehicle seat air-conditioning device 3 sucks the air convecting around the seat 1 and discharges the air to the occupant, the air discharged to the occupant by the vehicle seat air-conditioning device 3 is hot air when a temperature around the seat 1 is higher than normal temperature, and is cold air when the temperature is lower than the normal temperature. Further, when the vehicle seat air-conditioning device 3 sucks air from the vehicle air-conditioning apparatus 2b and discharges the air to the occupant, the air discharged to the occupant by the vehicle seat air-conditioning device 3 is hot air when a temperature of air sent from the vehicle air-conditioning apparatus 2b is higher than the normal temperature, and is cold air when the temperature is lower than the normal temperature.

As illustrated in FIGS. 3 and 4, the vehicle seat air-conditioning device 3 includes the first ventilation path 31, the second ventilation path 32, the blower 34, the adjustment unit 35, the third ventilation path 33, a first temperature sensor 51, a control unit (processor) 60, and an operation panel 65.

The blower 34 can suck in air from at least one of the first inlets 31a formed in the first seat cover 11b of the seat 1 or the second inlet 32a, and discharge the sucked air from the second ventilation ports 12b formed in the second seat pad 13a. Specifically, the blower 34 is electrically connected to the control unit 60, and is driven and controlled by the control unit 60 to suck air from at least one of the first inlets 31a or the second inlet 32a, and discharge the air from the first outlet 33a via at least one of the first ventilation path 31 or the second ventilation path 32, the adjustment unit 35, and the third ventilation path 33.

Further, the blower 34 is incorporated in the seat 1. Specifically, the blower 34 is disposed in the space to the Z-axis minus direction of the first seat pad 11a. Note that the blower 34 may be disposed inside first seat pad 11a. When the blower 34 is driven, air is sucked in from the first inlets 31a and the second inlet 32a of the first seat cover 11b.

Further, the blower 34 is disposed downstream of the adjustment unit 35. Specifically, the blower 34 is disposed downstream of the adjustment unit 35 in a flow path of air flowing from the first inlets 31a to the first outlet 33a and a flow path of air flowing from the second inlet 32a to the first outlet 33a. In the present embodiment, the blower 34 is disposed on the third ventilation path 33. Note that, it is sufficient if the air flows from at least one of the first inlets 31a or the second inlet 32a to the adjustment unit 35 and the air flows from the adjustment unit 35 to the first outlet 33a, the arrangement position of the blower 34 is not particularly limited.

The first ventilation path 31 is incorporated in the seat 1. Specifically, the first ventilation path 31 is disposed inside the bottom 11 so as to reach the blower 34 from the seat surface 11c of the bottom 11.

Further, the first ventilation path 31 guides the air sucked in from the first inlets 31a provided in the bottom 11 of the seat 1 to the adjustment unit 35 by the blower 34. The first ventilation path 31 is constituted by, for example, a ventilation duct.

One end of the first ventilation path 31 form the first inlets 31a, and the other end is connected to the adjustment unit 35. That is, the first ventilation path 31 extends from the first inlets 31a to the adjustment unit 35.

Further, the first inlets 31a can suck air from the seat surface 11c of the bottom 11, and corresponds to the first ventilation ports 12a of the first seat cover 11b. When viewed along the Z-axis direction, the first inlets 31a overlap with the first ventilation ports 12a. In the present embodiment, the first inlets 31a sucks air through the first ventilation ports 12a, but may be configured to suck air directly.

The second ventilation path 32 is disposed to the Z-axis minus direction of the seat 1. Specifically, the second ventilation path 32 is disposed in the space to the Z-axis minus direction of the first seat pad 11a so as to reach the blower 34 from a place other than the seat surface 11c of the bottom 11.

The second ventilation path 32 is a ventilation path different from the first ventilation path 31. The second ventilation path 32 guides the air sucked in from the second inlet 32a to the adjustment unit 35 by the blower 34. The second ventilation path 32 is constituted by, for example, a ventilation duct.

One end of the second ventilation path 32 forms the second inlet 32a, and the other end is connected to the adjustment unit 35. That is, the second ventilation path 32 extends from the second inlet 32a to the adjustment unit 35.

Further, the second inlet 32a is an inlet different from the first inlets 31a. The second inlet 32a is formed at a position other than the seat surface 11c of the bottom 11. In the present embodiment, the second inlet 32a is formed in the space to the Z-axis minus direction of the first seat pad 11a, and is connected to the vehicle air-conditioning apparatus 2b mounted on the vehicle.

The adjustment unit 35 is incorporated in the bottom 11 of the seat 1. Specifically, the adjustment unit 35 is provided upstream of, and closer to the first inlets 31a and the second inlet 32a than the blower 34.

Further, the adjustment unit 35 adjusts a ratio (hereinafter, also simply referred to as a flow rate ratio) of a flow rate of air guided from the first ventilation path 31 to the third ventilation path 33 (also referred to as a first flow rate) and a flow rate of air guided from the second ventilation path 32 to the third ventilation path 33 (also referred to as a second flow rate). For example, the adjustment unit 35 is a switching unit (ventilation path switching unit) that can switch the flow path of air to the third ventilation path 33 between the first ventilation path 31 and the second ventilation path 32 such that air is guided from the first ventilation path 31 to the third ventilation path 33 and/or air is guided from the second ventilation path 32 to the third ventilation path 33. The adjustment unit 35 is constituted by, for example, a damper or the like.

Any of air guided only from the first ventilation path 31, air guided only from the second ventilation path 32, and air guided from both the first ventilation path 31 and the second ventilation path 32 is selectively guided to the third ventilation path 33 by the adjustment unit 35. Further, the first flow rate and the second flow rate are adjusted by the adjustment unit 35, and air obtained by mixing the air guided from the first ventilation path 31 to the third ventilation path 33 and the air guided from the second ventilation path 32 to the third ventilation path 33 is guided to the third ventilation path 33.

The third ventilation path 33 is a ventilation path different from the first ventilation path 31 and the second ventilation path 32. The third ventilation path 33 guides air guided from at least one of the first ventilation path 31 or the second ventilation path 32 by the blower 34 from the adjustment unit 35 to the first outlet 33a provided in the seat 1. Specifically, the third ventilation path 33 guides only the air sucked in from the first inlets 31a and guided to the first ventilation path 31 to the first outlet 33a, or guides only the air sucked in from the second inlet 32a and guided to the second ventilation path 32 to the first outlet 33a. Further, the third ventilation path 33 mixes the air simultaneously sucked in from the first inlets 31a and the second inlet 32a and simultaneously guided to the first ventilation path 31 and the second ventilation path 32, and guides the mixed air to the first outlet 33a.

The third ventilation path 33 is constituted by, for example, a ventilation duct. One end of the third ventilation path 33 forms the first outlet 33a, and the other end is connected to the adjustment unit 35.

Note that the third ventilation path 33 may be connected to the adjustment unit 35 via the blower 34. The first outlet 33a corresponds to the second ventilation ports 12b of the second seat cover 13b. When viewed along the Y-axis direction, the first outlet 33a overlaps the second ventilation ports 12b. In the present embodiment, the first outlet 33a discharges air via the second ventilation ports 12b, but may be configured to directly discharge air.

The third ventilation path 33 is incorporated in the seat 1. Specifically, a part of the third ventilation path 33 is disposed in a space to the Z-axis minus direction of the bottom 11, and the remaining part of the third ventilation path 33 is disposed inside the seat back 13.

The third ventilation path 33 extends from the adjustment unit 35 to the first outlet 33a. In the present embodiment, the third ventilation path 33 extends from the adjustment unit 35 in the first seat pad 11a to the second seat pad 13a. Further, in the present embodiment, the third ventilation path 33 extends to the vicinity of the headrest 15 in the second seat cover 13b. Note that the first outlet 33a, which is one end of the third ventilation path 33, may be disposed at a position corresponding to at least one or more of the head, the neck, the acromion, the back, and the waist of the occupant seated on the seat adjacent to the seat 1.

With such configurations of the first ventilation path 31, the second ventilation path 32, and the third ventilation path 33, the first inlets 31a, the second inlet 32a, and the first outlet 33a have the following relationship. The first inlets 31a and the second inlet 32a are disposed vertically below the first outlet 33a. Further, the second inlet 32a is disposed vertically below the first inlets 31a. Thus, air sucked in from the portion corresponding to the buttocks and the thighs of the occupant and the vehicle air-conditioning apparatus 2b mounted on the vehicle is discharged from the portion corresponding to the head, the neck, the acromion, the back, the waist, and the like of the occupant to thereby generate an airflow enclosing the occupant seated on the seat 1.

Further, in the vehicle seat air-conditioning device 3, the first inlets 31a, the second inlet 32a, and the first outlet 33a are provided in the seat 1, and the first ventilation path 31, the second ventilation path 32, the third ventilation path 33, the blower 34, and the adjustment unit 35 are incorporated in the seat 1. In other words, the seat 1 is provided with all of the components that produce the airflow enclosing the occupant seated on the seat 1, so that the configuration of the vehicle seat air-conditioning device 3 can be simplified.

### First Temperature Sensor 51

The first temperature sensor 51 is a temperature sensor such as a thermistor that detects a temperature of air whose temperature has been adjusted by the vehicle air-conditioning apparatus 2b. For example, the first temperature sensor 51 is provided in a ventilation path in the center console through which air generated by the vehicle air-conditioning apparatus 2b flows. The first temperature sensor 51 outputs information indicating the temperature in the center console to the control unit 60 as a result of detecting the information. Note that the first temperature sensor 51 may be a temperature sensor provided in the vehicle air-conditioning apparatus 2b in advance, or may detect a temperature of an outlet of the vehicle air-conditioning apparatus 2b. Further, the first temperature sensor 51 may be a temperature sensor provided in advance in the vehicle seat air-conditioning device 3, or may detect a temperature in the second ventilation path 32. Since the temperature in the center console, the temperature of the outlet of the vehicle air-conditioning apparatus 2b, and the temperature in the second ventilation path 32 all indicate the temperature of air generated by the vehicle air-conditioning apparatus 2b, the first temperature sensor 51 can estimate a temperature of air whose temperature has been adjusted by the vehicle air-conditioning apparatus 2b from the temperature in the center console, the temperature of the outlet of the vehicle air-conditioning apparatus 2b, or the temperature in the second ventilation path 32. Note that, when the vehicle seat air-conditioning device 3 includes a Peltier module 39 to be described later, the first temperature sensor 51 may detect the temperature of the air cooled by the Peltier module 39.

### Control Unit 60

The control unit 60 controls the blower 34 and the adjustment unit 35. The control unit 60 is a microcomputer that controls an output of the blower 34 by switching on/off of a current flowing to the blower 34 and the adjustment unit 35 or changing a current value.

The control unit 60 controls the adjustment unit 35 on the basis of the temperature in the center console to thereby adjust the ratio between the flow rate of the air guided from the first ventilation path 31 to the third ventilation path 33 and the flow rate of the air guided from the second ventilation path 32 to the third ventilation path 33. That is, the control unit 60 adjusts the flow rate ratio between the first flow rate and the second flow rate on the basis of the temperature in the center console. Thus, the control unit 60 adjusts the temperature of the air discharged from the first outlet 33a.

Here, the flow rate ratio means a ratio of the second flow rate to a total flow rate of the first flow rate and the second flow rate (second flow rate/total flow rate). For example, the flow rate ratio of 0% is a state in which the first ventilation path 31 and the third ventilation path 33 are connected, and is a state in which the air guided only from the first ventilation path 31 is guided to the third ventilation path 33 to thereby discharge the air from the first outlet 33a. Further, for example, the flow rate ratio of 100% is a state in which the second ventilation path 32 and the third ventilation path 33 are connected, and is a state in which air guided only from the second ventilation path 32 is guided to the third ventilation path 33 to thereby discharge the air from the first outlet 33a. Further, for example, the flow rate ratio of 50% is a state in which the first ventilation path 31, the second ventilation path 32, and the third ventilation path 33 are connected, and is a state in which the same flow rate of air simultaneously guided from the first ventilation path 31 and the second ventilation path 32 is guided to the third ventilation path 33 and mixed to thereby discharge the air from the first outlet 33a.

When the temperature in the center console is equal to or higher than the first temperature, the control unit 60 controls the adjustment unit 35 to thereby adjust the flow rate ratio to be equal to or lower than a predetermined ratio. Then, when the temperature in the center console is lower than the first temperature, the control unit 60 controls the adjustment unit 35 to thereby adjust the flow rate ratio such that the flow rate ratio increases according to the decrease in the temperature in the center console. Note that the flow rate ratio may linearly increase or may non-linearly increase in a stepwise manner.

For example, as illustrated in FIG. 5, when the temperature in the center console is equal to or higher than the first temperature, the control unit 60 controls the adjustment unit 35 to thereby adjust the flow rate ratio to a predetermined ratio. Further, when the temperature in the center console is lower than the first temperature and equal to or higher than the second temperature, the control unit 60 controls the adjustment unit 35 to thereby adjust the flow rate ratio to a first ratio. The second temperature is lower than the first temperature, and the first ratio is higher than 0%. Further, when the temperature in the center console is lower than the second temperature, the control unit 60 controls the adjustment unit 35 to thereby adjust the flow rate ratio to a second ratio. The second ratio is a ratio higher than the first ratio. For example, the first temperature is 40° C., the second temperature is 35° C., the predetermined ratio is 0%, the first ratio is 33%, and the second ratio is 67%.

Note that the first temperature, the second temperature, the first ratio, and the second ratio may be arbitrarily set. For example, when the temperature in the center console is equal to or higher than the first temperature, the control unit 60 may adjust the flow rate ratio such that the flow rate of the air guided from the first ventilation path 31 to the third ventilation path 33 is larger than the flow rate of the air guided from the second ventilation path 32 to the third ventilation path 33. For example, the second ratio may be 100%. These pieces of information are stored in advance in a storage unit (not illustrated), for example.

Further, the control unit 60 controls the blower 34 on the basis of the temperature in the center console to thereby adjust the rotation speed of the blower 34. That is, for example, the control unit 60 adjusts the flow rate (also referred to as a third flow rate) of the air to be discharged from the first outlet 33a on the basis of the temperature in the center console. Specifically, when the temperature in the center console is lower than the first temperature, the control unit 60 controls the blower 34 to thereby adjust the third flow rate such that the third flow rate increases in accordance with a decrease in the temperature in the center console.

For example, as illustrated in FIG. 6, when the temperature in the center console is equal to or higher than the first temperature, the control unit 60 controls the blower 34 to thereby adjust the third flow rate to the first discharge flow rate. Further, when the temperature in the center console is lower than the first temperature and equal to or higher than the second temperature, the control unit 60 controls the blower 34 to thereby adjust the third flow rate to the second discharge flow rate. Furthermore, when the temperature in the center console is lower than the second temperature, the control unit 60 controls the blower 34 to thereby adjust the third flow rate to the third discharge flow rate. For example, the first discharge flow rate is 25 m³/h, the second discharge flow rate is 33 m³/h, and the third discharge flow rate is 41 m³/h.

Note that the first discharge flow rate, the second discharge flow rate, and the third discharge flow rate may be arbitrarily set. These pieces of information are stored in the storage unit in advance, for example. Further, for example, the control unit 60 may control the blower 34 such that the first flow rate becomes a constant flow rate. That is, when the temperature in the center console is lower than the first temperature, the control unit 60 can set the first flow rate to a constant flow rate by increasing the third flow rate in response to increasing the flow rate ratio as compared with a case where the temperature in the center console is equal to or higher than the first temperature. Here, the flow rate being constant refers to a range obtained by including variation in error in a constant flow rate serving as a reference.

### Operation Panel 65

The operation panel 65 is an input interface mounted on the vehicle, and outputs a setting instruction of, for example, a temperature, an air volume of air, a flow rate ratio, and the like of the vehicle seat air-conditioning device 3 to the control unit 60 by receiving an operation input of an occupant. Note that the operation panel 65 is a control panel for a vehicle, a tablet terminal, a smartphone, or the like. Further, the operation panel 65 may output a setting support of the first temperature and the second temperature to the control unit 60. The operation panel 65 is not limited to a form such as a touch panel, but may include another form for operation such as a button.

Note that the vehicle seat air-conditioning device 3 may be provided with a temperature sensor that detects the skin temperature of the occupant. Such a temperature sensor is, for example, a non-contact thermometer, thermography, or the like that detects the skin temperature of the occupant by infrared rays or the like. The temperature sensor may output information indicating a detected temperature to the control unit 60, and the control unit 60 may control the vehicle seat air-conditioning device 3 on the basis of information indicating the detected temperature instead of an operation input of the occupant on the operation panel 65.

### Power Supply 70

The power supply 70 is a power supply circuit that supplies power to the blower 34 and the adjustment unit 35 via the control unit 60 and the like. Here, the power supply 70 is a DC power supply supplied from a battery mounted on the vehicle. The power supply 70 is controlled by the control unit 60 to thereby adjust the current supplied to the blower 34 and the adjustment unit 35.

### Processing

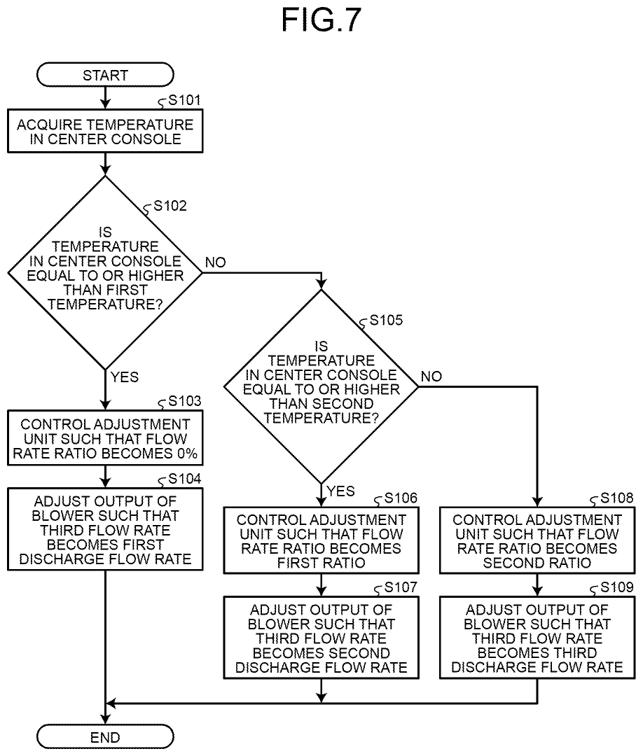

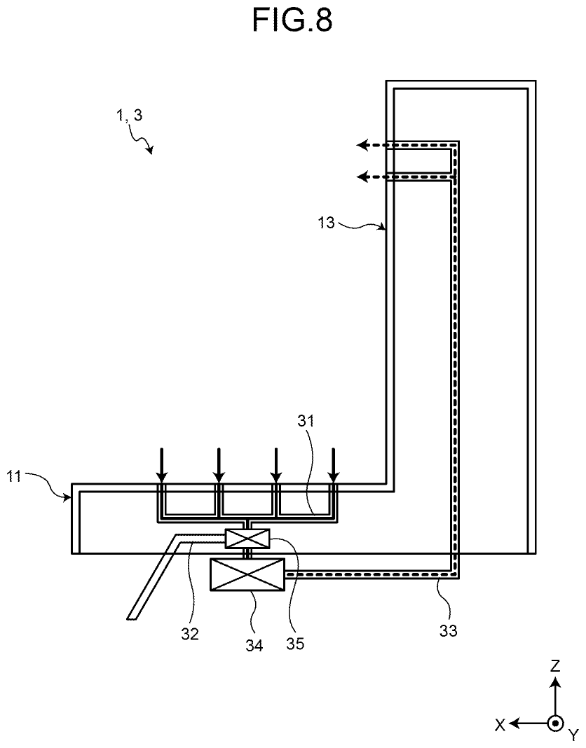

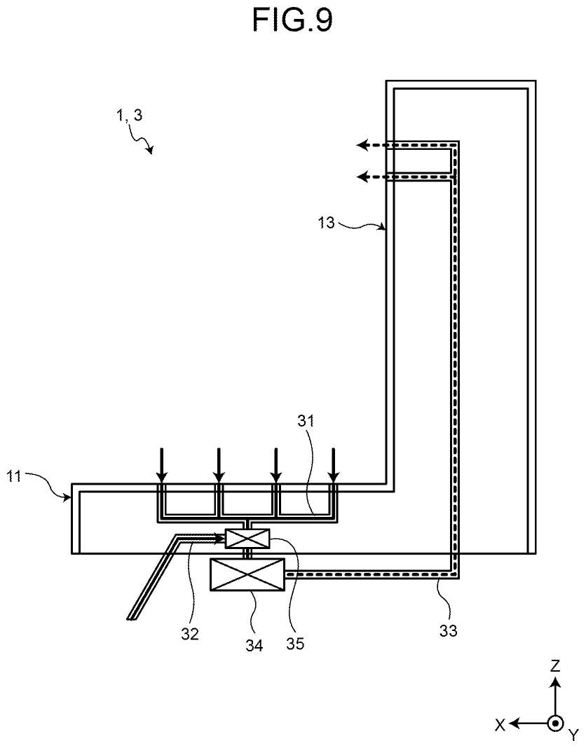

FIG. 7 is a flowchart illustrating processing of the vehicle seat air-conditioning device 3 according to the first embodiment. FIG. 8 is a schematic side view illustrating a flow path of air in the seat 1 when Step S103 in FIG. 7 is executed. FIG. 9 is a schematic side view illustrating a flow path of air in the seat 1 when Step S106 or S108 in FIG. 7 is executed.

In the flowchart of FIG. 7, it is only necessary to be configured to start when the function of the vehicle seat air-conditioning device 3 is turned on. The function of the vehicle seat air-conditioning device 3 is only necessary to be configured to switch on or off in accordance with an input operation received by the operation panel 65.

First, in Step S101, the control unit 60 acquires information indicating the temperature in the center console from the first temperature sensor 51. The control unit 60 controls the adjustment unit 35 and the blower 34 on the basis of the acquired information indicating the temperature in the center console.

Specifically, in Step S102, the control unit 60 determines whether or not the temperature in the center console is equal to or higher than the first temperature.

When the control unit 60 determines that the temperature in the center console is equal to or higher than the first temperature (YES in S102), the process proceeds to Step S103. In Step S103, the control unit 60 controls the adjustment unit 35 to thereby adjust the flow rate ratio to 0%.

Next, in Step S104, the control unit 60 controls the blower 34 to thereby adjust the output (for example, the number of rotations) of the blower 34 such that the flow rate of the air discharged from the first outlet 33a becomes the first discharge flow rate. Then, the control unit 60 ends the process and returns to Step S101 to repeat the process.

For example, when the outside air temperature is high, when the solar radiation amount is large, or the like, the temperature in the vehicle interior tends to be high immediately after an occupant gets in the vehicle, and the air generated by the vehicle air-conditioning apparatus 2b also tends to be high. In this case, the air generated by the vehicle air-conditioning apparatus 2b becomes higher than the body temperature of the occupant. In this case, as illustrated in FIG. 8, air is sucked in from the first inlets 31a on the seat surface 11c side of the seat 1, and the sucked air is discharged from the first outlet 33a, so that the air can be blown to the occupant seated on the seat 1. As a result, since the air can be sucked in from the first inlets 31a, it is possible to suppress stuffiness due to sweating of the buttocks and the thighs of the occupant in contact with the seat surface 11c. Further, it is possible to generate an airflow in the vicinity of the buttocks and the thighs of the occupant and to impart a cooling sensation to the occupant by heat of vaporization due to sweating. In FIG. 8, air guided to the first ventilation path 31 is indicated by a solid line, and air guided to the third ventilation path 33 is indicated by a broken line.

When the control unit 60 determines that the temperature in the second ventilation path 32 is lower than the first temperature (NO in S102), the process proceeds to Step S105. In Step S105, the control unit 60 determines whether or not the temperature in the second ventilation path 32 is equal to or higher than the second temperature.

When the control unit 60 determines that the temperature in the second ventilation path 32 is equal to or higher than the second temperature (YES in S105), the process proceeds to Step S106. In Step S106, the control unit 60 controls the adjustment unit 35 to thereby adjust the flow rate ratio to the first ratio.

Next, in Step S107, the control unit 60 controls the blower 34 to thereby adjust the output of the blower 34 such that the flow rate of the air discharged from the first outlet 33a becomes the second discharge flow rate. Then, the control unit 60 ends the process and returns to Step S101 to repeat the process.

For example, when the outside air temperature is high, when the solar radiation amount is large, or the like, the temperature in the center console may still be equal to or higher than the second temperature although the air generated by the vehicle air-conditioning apparatus 2b starts to cool. In this case, as illustrated in FIG. 9, the air cooled by the vehicle air-conditioning apparatus 2b is sucked in from the second inlet 32a and the air is also sucked in from the first inlets 31a on the seat surface 11c side of the seat 1, and the air simultaneously sucked in from the first inlets 31a and the second inlet 32a is mixed in the third ventilation path 33. By discharging the mixed air from the first outlet 33a, the mixed air can be blown to the occupant seated on the seat 1. As a result, since the air can be sucked in from the first inlets 31a, it is possible to suppress stuffiness due to sweating of the buttocks and the thighs of the occupant in contact with the seat surface 11c. Further, it is possible to generate an airflow in the vicinity of the buttocks and the thighs of the occupant and to impart a cooling sensation to the occupant by heat of vaporization due to sweating. Furthermore, since the air cooled by the vehicle air-conditioning apparatus 2b can be blown to the occupant, a surface temperature of the occupant can be lowered. That is, by increasing the flow rate of the air discharged from the first outlet 33a corresponding to the increase in the flow rate ratio, it is possible to reduce the amount of decrease in the flow rate of the air sucked in from the first inlets 31a due to the increase in the flow rate ratio, and it is possible to reduce the temperature of the air discharged from the first outlet 33a while maintaining the above-described effect by the heat of vaporization. In FIG. 9, the air guided to the first ventilation path 31 and the second ventilation path 32 is indicated by a solid line, and the air guided to the third ventilation path 33 is indicated by a broken line.

When the control unit 60 determines that the temperature in the center console is lower than the second temperature (NO in S105), the process proceeds to Step S108. In Step S108, the control unit 60 controls the adjustment unit 35 to thereby adjust the flow rate ratio to the second ratio.

Next, in Step S109, the control unit 60 controls the blower 34 to thereby adjust the output of the blower 34 such that the flow rate of the air discharged from the first outlet 33a becomes the third discharge flow rate. Then, the control unit 60 ends the process and returns to Step S101 to repeat the process.

For example, when the outside air temperature is high, when the solar radiation amount is large, or the like, the air generated by the vehicle air-conditioning apparatus 2b may be cooled, and the temperature in the center console may be lower than the second temperature. In this case, as illustrated in FIG. 9, the air cooled by the vehicle air-conditioning apparatus 2b is sucked in from the second inlet 32a and the air is also sucked in from the first inlets 31a on the seat surface 11c side of the seat 1, and the air simultaneously sucked in from the first inlets 31a and the second inlet 32a is mixed in the third ventilation path 33. By discharging the mixed air from the first outlet 33a, the mixed air can be blown to the occupant seated on the seat 1. As a result, since the air can be sucked in from the first inlets 31a, it is possible to suppress stuffiness due to sweating of the buttocks and the thighs of the occupant in contact with the seat surface 11c. Further, it is possible to generate an airflow in the vicinity of the buttocks and the thighs of the occupant and to impart a cooling sensation to the occupant by heat of vaporization due to sweating. Furthermore, the flow rate ratio of the second flow rate to the total flow rate is higher, and more air cooled by the vehicle air-conditioning apparatus 2b can be blown to the occupant, so that the surface temperature of the occupant can be more effectively lowered.

Note that, in this processing, the order of the determination processing may be appropriately changed in Steps S102 and S105. For example, the control unit 60 may determine whether or not the temperature in the second ventilation path 32 is equal to or higher than the second temperature in Step S102, and determine whether or not the temperature in the second ventilation path 32 is equal to or higher than the first temperature in Step S105.

### Advantageous Effect

Next, advantageous effects of the vehicle seat air-conditioning device 3 according to the present embodiment will be described.

As described above, the vehicle seat air-conditioning device 3 of the present embodiment is disposed in a vehicle and used in the seat 1 including the seat back 13 and the bottom 11. A vehicle seat air-conditioning device 3 includes the blower 34 incorporated in the seat 1, the first ventilation path 31 through which air sucked in by the blower 34 passes from the first inlets 31a provided in the front surface of the seat 1 that is a surface positioned to face an occupant seated on the seat 1, the second ventilation path 32 through which air sucked in by the blower 34 passes from the second inlet 32a that is an inlet different from the first inlets 31a and is provided at a position other than the front surface of the seat 1 in the seat 1, the third ventilation path 33 that guides air guided from at least one of the first ventilation path 31 and the second ventilation path 32 to the first outlet 33a provided in the front surface of the seat back 13 that is a surface positioned to face the occupant seated on the seat 1, the adjustment unit 35 that adjusts a ratio (flow rate ratio) of a flow rate of air guided from the second ventilation path 32 to the third ventilation path 33 to a total flow rate of air guided from the first ventilation path 31 to the third ventilation path 33 and air guided from the second ventilation path 32 to the third ventilation path 33, and a control unit 60 that controls the blower 34 and the adjustment unit 35. The control unit 60 adjusts the flow rate ratio by controlling the adjustment unit 35 on the basis of the temperature of the air generated by the vehicle air-conditioning apparatus 2b, for example, the temperature in the center console. When the temperature of the air generated by the vehicle air-conditioning apparatus 2b is equal to or higher than the first temperature, the control unit 60 adjusts the flow rate ratio such that the flow rate of the air guided from the first ventilation path 31 to the third ventilation path 33 is larger than the flow rate of the air guided from the second ventilation path 32 to the third ventilation path 33.

For example, when the outside air temperature is high, when the solar radiation amount is large, or the like, the air generated by the vehicle air-conditioning apparatus 2b becomes higher than the body temperature of the occupant immediately after an occupant gets in the vehicle, and the occupant may feel uncomfortable. By the vehicle seat air-conditioning device 3 of the present embodiment, when the temperature of the air generated by the vehicle air-conditioning apparatus 2b is equal to or higher than the first temperature, it is possible to increase the flow rate of air sucked in from the first inlets 31a and guided from the first ventilation path 31 to the third ventilation path 33, and it is possible to suppress stuffiness due to sweating of a portion of the occupant in contact with the front surface of the seat 1 provided with the first inlets 31a. Further, an airflow is generated near the portion of the occupant, and a cooling sensation can be given to the occupant by heat of vaporization due to sweat. That is, even in a period in which it is difficult for the occupant to obtain a cooling sensation by air generated by the vehicle air-conditioning apparatus 2b, such as immediately after the occupant gets in the vehicle, the occupant can obtain the cooling sensation at the portion of the occupant in contact with the front surface of the seat 1 where the first inlets 31a are provided. Thus, it is possible to provide a comfortable air-conditioning environment for the occupant.

More specifically, in the vehicle seat air-conditioning device 3 of the present embodiment, when the temperature of the air generated by the vehicle air-conditioning apparatus 2b is equal to or higher than the first temperature, the control unit 60 adjusts the flow rate ratio such that the flow rate ratio becomes 0%. Accordingly, only the air sucked in from the first inlets 31a and passing through the first ventilation path 31 can be guided to the third ventilation path 33, and more air can be sucked in from the first inlets 31a. Thus, it is possible to further suppress stuffiness due to sweating of the portion of the occupant, and it is possible to further impart a cooling sensation to the occupant by heat of vaporization due to sweating.

Further, in the vehicle seat air-conditioning device 3 of the present embodiment, when the temperature of the air generated by the vehicle air-conditioning apparatus 2b is lower than the first temperature, the control unit 60 adjusts the flow rate ratio such that the flow rate ratio increases in accordance with the decrease in the temperature of the air generated by the vehicle air-conditioning apparatus 2b. Accordingly, air is discharged from the first outlet 33a to be blown to the occupant seated on seat 1. Further, the ratio of the air guided from the second ventilation path 32 to the third ventilation path 33 can be increased in accordance with the decrease in the temperature of the air generated by the vehicle air-conditioning apparatus 2b, and the surface temperature of the occupant can be more efficiently decreased.

Further, in the vehicle seat air-conditioning device 3 of the present embodiment, when the temperature in the second ventilation path 32 is lower than the second temperature higher than the first temperature, the control unit 60 adjusts the flow rate ratio such that the flow rate ratio becomes 100%. Accordingly, only the air passing through the second ventilation path 32 can be guided to the third ventilation path 33, and more air cooled to a temperature lower than the second temperature can be discharged to the occupant. Thus, the surface temperature of the occupant can be further efficiently lowered.

Further, in the vehicle seat air-conditioning device 3 of the present embodiment, when the temperature in the second ventilation path 32 is lower than the first temperature, the control unit 60 controls the blower 34 such that the flow rate of the air discharged from the first outlet 33a increases in accordance with a decrease in the temperature in the second ventilation path 32. Accordingly, it is possible to suppress a decrease in the flow rate of the air sucked in from the first inlets 31a due to the increase in the flow rate ratio. Thus, it is possible to suppress stuffiness due to sweating of the portion of the occupant, and it is possible to impart a cooling sensation to the occupant by heat of vaporization due to sweating.

Further, in the vehicle seat air-conditioning device 3 of the present embodiment, the control unit 60 controls the blower 34 such that the flow rate of the air sucked in from the first inlets 31a becomes constant. Accordingly, since the flow rate of the air sucked in from the first inlets 31a becomes constant even if the flow rate ratio increases, it is possible to further suppress stuffiness due to sweating of the portion of the occupant, and it is possible to further impart a cooling sensation to the occupant by heat of vaporization due to sweat.

Further, in the vehicle seat air-conditioning device 3 of the present embodiment, the first inlets 31a is provided in the seat surface 11c of the bottom 11. Accordingly, it is possible to suppress stuffiness due to sweating of the buttocks and the thighs of the occupant in contact with the seat surface 11c, and to impart a cooling sensation to the occupant by heat of vaporization due to sweat.

### Modification 1 of First Embodiment

The present modification is different from the vehicle seat air-conditioning device of the first embodiment in that the seat 1 is provided with a second outlet 36a. Other configurations according to the present modification are similar to those in the first embodiment, and the same configurations and functions are denoted by the same reference numerals and detailed description of the configurations and functions is omitted.

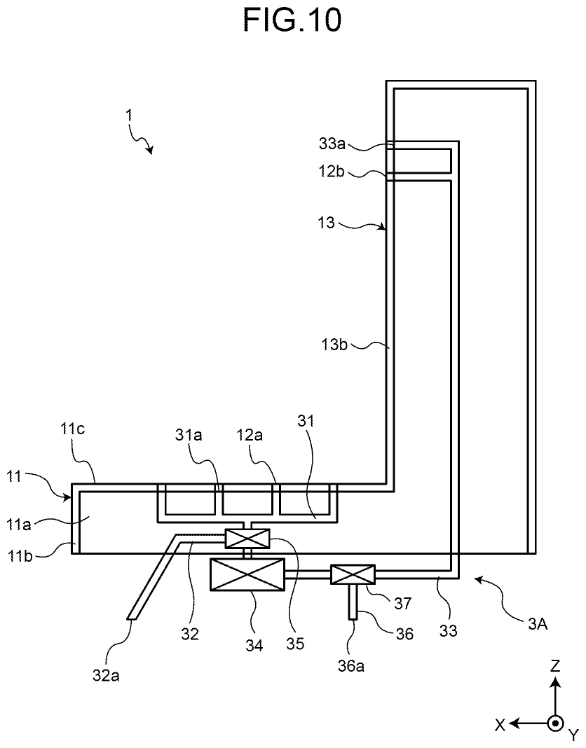

FIG. 10 is a cross-sectional view of a seat 1 including a vehicle seat air-conditioning device 3A according to Modification 1 of the first embodiment.

As illustrated in FIG. 10, the second outlet 36a and a fourth ventilation path 36 are formed in the seat 1 provided with the vehicle seat air-conditioning device 3A according to the present modification. In the present modification, the second outlet 36a is formed in a space to the Z-axis minus direction of the first seat pad 11a. Note that the second outlet 36a may be formed on a side surface of the seat 1 opposed to the door of the vehicle, or may be connected to the outside of the vehicle. Further, the fourth ventilation path 36 is disposed in the space to the Z-axis minus direction of the first seat pad 11a so as to guide air guided from at least one of the first ventilation path 31 or the second ventilation path 32 by the blower 34 to the second outlet 36a.

Further, the first seat pad 11a is provided with a ventilation path selection switching unit 37. The blower 34 sucks in air from at least one of the first inlets 31a formed in the first seat pad 11a or the second inlet 32a, and discharges the sucked air from the first outlet 33a or the second outlet 36a via at least one of the first ventilation path 31 or the second ventilation path 32, the adjustment unit 35, the ventilation path selection switching unit 37, and either the third ventilation path 33 or the fourth ventilation path 36.

Air is guided to the second outlet 36a by the blower 34 via the fourth ventilation path 36. The second outlet 36a is connected to the ventilation path selection switching unit 37 via the fourth ventilation path 36. The fourth ventilation path 36 is constituted by, for example, a ventilation duct.

The ventilation path selection switching unit 37 is provided downstream of, and closer to the first outlet 33a and the second outlet 36a than the blower 34, selects and switches the third ventilation path 33 or the fourth ventilation path 36, and guides the air guided by the blower 34 to the selected ventilation path. The ventilation path selection switching unit 37 is constituted by a damper or the like, and can switch a flow path of air, that is, a ventilation path. The ventilation path selection switching unit 37 can selectively guide the air guided by the blower 34 to only the third ventilation path 33 or only the fourth ventilation path 36.

Specifically, the ventilation path selection switching unit 37 has a first mode and a second mode. The first mode is a mode for connecting the blower 34 and the third ventilation path 33. In the first mode, the ventilation path selection switching unit 37 guides the air guided from the blower 34 only to the third ventilation path 33 to thereby discharge the air from the first outlet 33a. In the second mode, the ventilation path selection switching unit 37 guides the air guided from the blower 34 only to the fourth ventilation path 36 to thereby discharge the air from the second outlet 36a. The ventilation path selection switching unit 37 is electrically connected to the control unit 60 and is driven and controlled by the control unit 60 to select one of the first mode and the second mode.

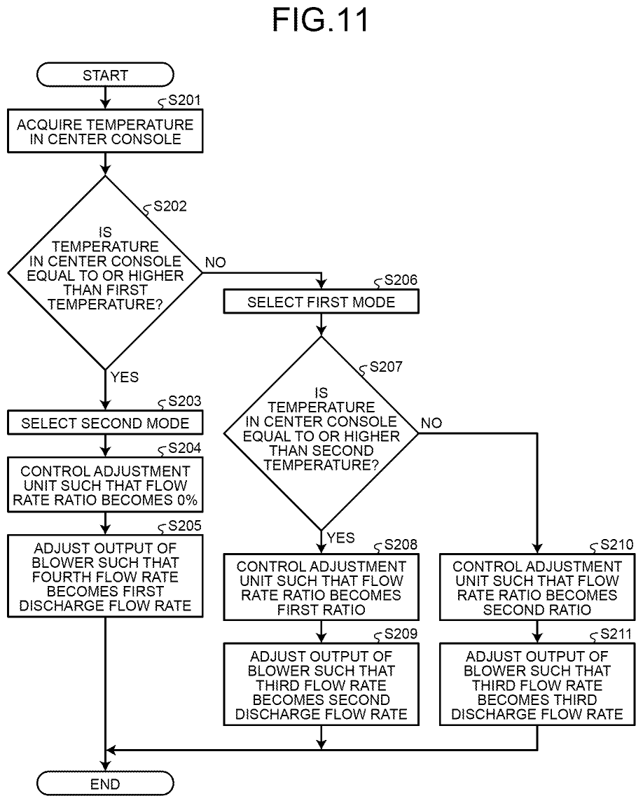

FIG. 11 is a flowchart illustrating processing of the vehicle seat air-conditioning device 3A according to Modification 1 of the first embodiment. Processes in Steps S201 to S202 illustrated in FIG. 11 are similar to the processes in Steps S101 to S102 in the vehicle seat air-conditioning device according to the first embodiment.

When the control unit 60 determines that the temperature in the center console is equal to or higher than the first temperature (YES in S202), the process proceeds to Step S203. In Step S203, the control unit 60 causes the ventilation path selection switching unit 37 to execute the second mode.

Next, in Step S204, the control unit 60 controls the adjustment unit 35 to thereby adjust the flow rate ratio to 0%.

Next, in Step S205, the control unit 60 controls the blower 34 to thereby adjust the output of the blower 34 such that a flow rate (also referred to as a fourth flow rate) of the air discharged from the second outlet 36a becomes the first discharge flow rate. Then, the control unit 60 ends the process and returns to Step S201 to repeat the process.

For example, in a case where the outside air temperature is high, a case where the solar radiation amount is large, or the like, the temperature in the vehicle interior tends to be high immediately after an occupant gets in the vehicle, and when the first mode is executed, air having a temperature higher than the body temperature of the occupant may be discharged from the first outlet 33a, and thus it is considered that air should not be blown to the occupant. Accordingly, the control unit 60 controls the ventilation path selection switching unit 37 to execute the second mode. In the second mode, the air guided from the blower 34 is discharged from the second outlet 36a, and thus the air is not blown to the occupant. As a result, since warm air is not blown to the occupant, the occupant is less likely to feel discomfort.

When the control unit 60 determines that the temperature in the center console is lower than the first temperature (NO in S202), the process proceeds to Step S206. In Step S206, the control unit 60 causes the ventilation path selection switching unit 37 to execute the first mode.

The processes in Steps S207 to S211 illustrated in FIG. 11 are similar to the processes in Steps S105 to S109 in the vehicle seat air-conditioning device according to the first embodiment.

As described above, the vehicle seat air-conditioning device 3A of the present modification further includes the fourth ventilation path 36 that guides air guided from at least one of the first ventilation path 31 or the second ventilation path 32 to the second outlet 36a that is a outlet different from the first outlet 33a and is provided at a position other than the front surface of the seat 1 in the seat 1. When the temperature of the air generated by the vehicle air-conditioning apparatus 2b, for example, the temperature in the center console is equal to or higher than the first temperature, the control unit 60 performs control to discharge the air guided from at least one of the first ventilation path 31 or the second ventilation path 32 from the second outlet 36a. Accordingly, it is possible to suppress the air having a high temperature from being blown to the occupant, and it is possible to suppress the occupant from feeling discomfort.

### Modification 2 of First Embodiment

The present modification is different from the vehicle seat air-conditioning device and the like of the first embodiment in that the first outlet 33a is provided with a drivable airflow direction changing member. Other configurations according to the present modification are similar to those in the first embodiment and the like, and the same configurations and functions are denoted by the same reference numerals and detailed description of the configurations and functions is omitted.

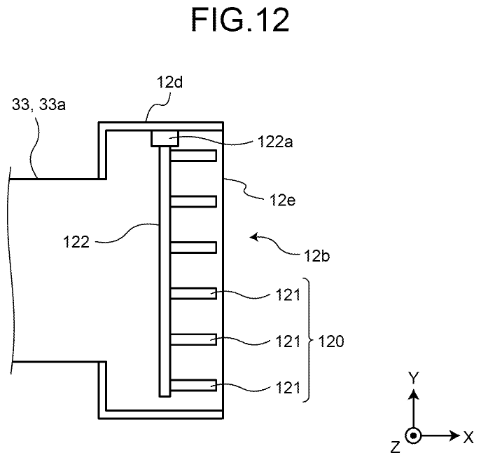

FIG. 12 is an enlarged cross-sectional view of a first outlet 33a of a vehicle seat air-conditioning device 3B according to Modification 2 of the first embodiment.

As illustrated in FIG. 12, a second ventilation port 12b includes a case 12d having a space communicating with the third ventilation path 33, and an opening 12e provided in the case 12d. Thus, the second ventilation ports 12b can discharge air flowing through the third ventilation path 33 from the opening 12e to the occupant seated on the seat 1.

A plurality of vertical plate fins 121 as an airflow direction changing member 120, a link mechanism 122, a drive unit 122a electrically connected to the control unit 60, and the like are provided inside the second ventilation ports 12b. The plurality of vertical plate fins 121 is members for changing a direction of air discharged from the second ventilation ports 12b. The plurality of vertical plate fins 121 is connected by the link mechanism 122. The link mechanism 122 is configured to be able to simultaneously change directions of the plurality of vertical plate fins 121. The drive unit 122a is connected to the link mechanism 122, and is configured to change the directions of the plurality of vertical plate fins 121 by driving the drive unit 122a.

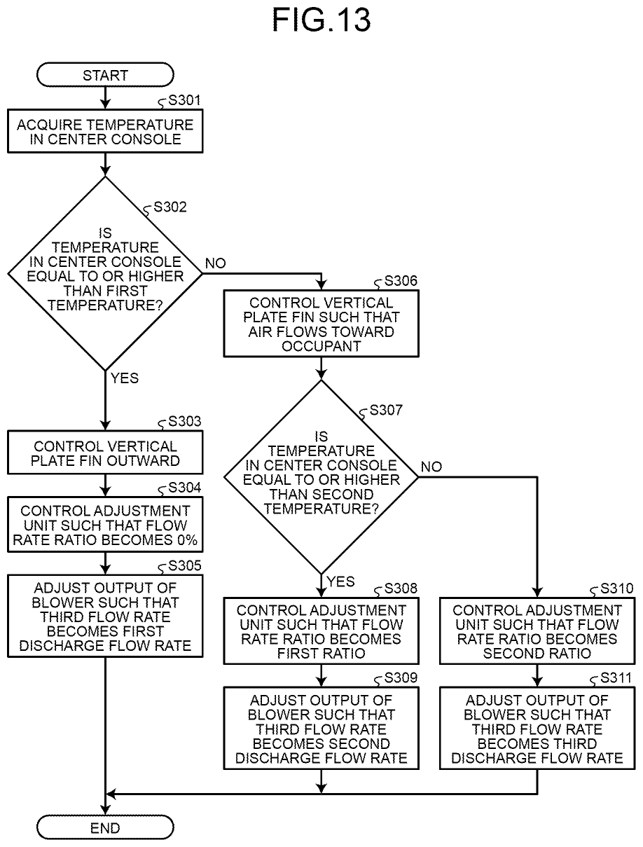

FIG. 13 is a flowchart illustrating processing of the vehicle seat air-conditioning device 3B according to Modification 2 of the first embodiment. Processes in Steps S301 to S302 illustrated in FIG. 13 are similar to the processes in Steps S101 to S102 in the vehicle seat air-conditioning device according to the first embodiment.

When the control unit 60 determines that the temperature in the center console is equal to or higher than the first temperature (YES in S302), the process proceeds to Step S303. In Step S303, the control unit 60 controls the vertical plate fins 121 of the second ventilation ports 12b to adjust a discharge direction such that the air discharged from the first outlet 33a does not flow toward the occupant. Here, the control unit 60 controls the vertical plate fins 121 of the second ventilation ports 12b to adjust the discharge direction outward, that is, in a direction away from a central portion 13a1 of the second seat pad 13a. In short, the control unit 60 may adjust the discharge direction so as to reduce the air discharged from the first outlet 33a and blown to the occupant.

Next, in Step S304, the control unit 60 controls the adjustment unit 35 to thereby adjust the flow rate ratio to 0%.

Next, in Step S305, the control unit 60 controls the blower 34 to thereby adjust the output of the blower 34 such that the flow rate of the air discharged from the first outlet 33a becomes the first discharge flow rate. Then, the control unit 60 ends the process and returns to Step S301 to repeat the process.

For example, in a case where the outside air temperature is high, a case where the solar radiation amount is large, or the like, the temperature in the vehicle interior tends to be high immediately after an occupant gets in the vehicle, and when the first mode is executed, air having a temperature higher than the body temperature of the occupant may be discharged from the first outlet 33a, and thus it is considered that air should not be blown to the occupant. Accordingly, the control unit 60 controls the vertical plate fins 121 of the second ventilation port 12b such that the discharge direction of the air discharged from the first outlet 33a is outward. When the discharge direction is outward, air is less likely to be blown to the occupant. As a result, since warm air is less likely to be blown to the occupant, the occupant is less likely to feel discomfort.

When the control unit 60 determines that the temperature in the center console is lower than the first temperature (NO in S302), the process proceeds to Step S306. In Step S306, the control unit 60 controls the vertical plate fins 121 of the second ventilation ports 12b to adjust the discharge direction such that the air discharged from the first outlet 33a flows toward the occupant.

The processes in Steps S307 to S311 illustrated in FIG. 12 are similar to the processes in Steps S105 to S109 in the vehicle seat air-conditioning device according to the first embodiment.

Note that a plurality of horizontal plate fins may be provided inside the second ventilation ports 12b instead of the plurality of vertical plate fins 121. In this case, the control unit 60 may adjust the discharge direction of the air discharged from the first outlet 33a by controlling the direction of the horizontal plate fins in the vertical direction. In addition, a plurality of vertical plate fins 121 and a plurality of horizontal plate fins may be provided inside the second ventilation ports 12b.

As described above, in the vehicle seat air-conditioning device 3B of the present modification, the airflow direction changing member 120 is provided at the first outlet 33a. When the temperature of the air generated by the vehicle air-conditioning apparatus 2b, for example, the temperature in the center console is equal to or higher than the first temperature, the control unit 60 controls the airflow direction changing member 120 such that the air discharged from the first outlet 33a does not flow toward the occupant seated on the seat 1.

Accordingly, it is possible to suppress the air having a high temperature from being blown to the occupant, and it is possible to suppress the occupant from feeling discomfort.

### Second Embodiment

The present embodiment is different from the vehicle seat air-conditioning device according to the first embodiment in that a vehicle seat air-conditioning device 3C used in the seat 1 controls air conditioning in accordance with a thermal sensation parameter indicating a degree of thermal sensation of an occupant. A configuration of the vehicle seat air-conditioning device 3C according to the present embodiment is similar to that of the vehicle seat air-conditioning device 3 in the first embodiment, and the same configurations and functions are denoted by the same reference numerals and detailed description of the configurations and functions is omitted.

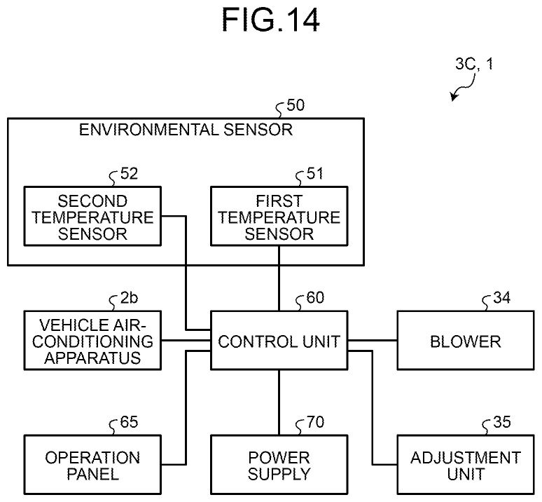

FIG. 14 is a block diagram illustrating the vehicle seat air-conditioning device 3C according to a second embodiment.

In the present embodiment, as illustrated in FIG. 14, the control unit 60 is electrically connected to an environmental sensor 50. Further, the control unit 60 outputs an instruction to the vehicle air-conditioning apparatus 2b to thereby adjust at least one of a temperature or an air volume of the air generated by the vehicle air-conditioning apparatus 2b. The vehicle air-conditioning apparatus 2b may or may not be included in the constituent requirements of the vehicle seat air-conditioning device 3C. Further, the vehicle air-conditioning apparatus 2b may be configured to determine whether or not to execute the content of the instruction in response to the instruction of the control unit 60, or the control unit 60 may be configured to force the vehicle air-conditioning apparatus 2b to execute the content of the instruction.

The environmental sensor 50 acquires environmental parameters, and outputs the acquired environmental parameters to the control unit 60. As the environmental sensor 50, at least one of a first temperature sensor 51, a second temperature sensor 52, a solar radiation sensor installed on an upper portion of an instrument panel or the like, a vehicle interior temperature sensor installed on an occupant side or the like of the instrument panel, and an outside air temperature sensor installed at a place exposed to the outside air or the like is provided. The solar radiation sensor detects information indicating a solar radiation amount and a solar radiation angle, the vehicle interior temperature sensor detects information indicating a vehicle interior temperature, and the outside air temperature sensor detects information indicating an outside air temperature.

The second temperature sensor 52 is a temperature sensor such as a thermistor that detects a temperature in the third ventilation path 33. For example, the second temperature sensor 52 is provided in the third ventilation path 33 or the first outlet 33a, and detects the temperature of the air discharged from the first outlet 33a. The second temperature sensor 52 outputs information indicating the temperature in the third ventilation path 33 to the control unit 60 as a result of detecting the information.

Note that, in the present embodiment, the first temperature sensor 51 and the adjustment unit 35 of the first embodiment may not be provided in the vehicle seat air-conditioning device 3C, and are not necessary components in the present embodiment.

### Processing Example 1

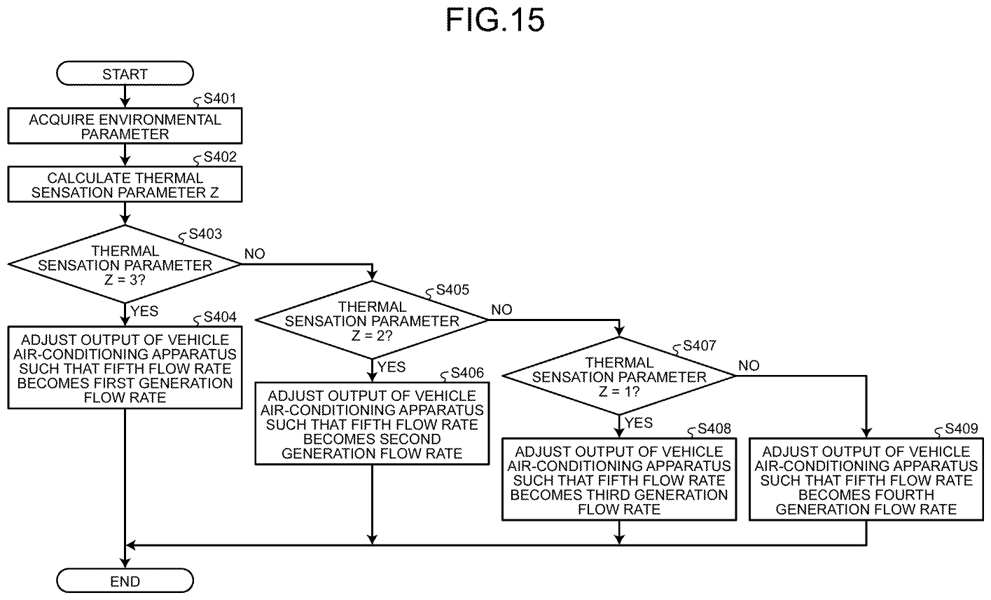

FIG. 15 is a flowchart illustrating a first example of processing of the vehicle seat air-conditioning device 3C according to the second embodiment.

First, in Step S401, the control unit 60 acquires environmental parameters from the environmental sensor 50. The environmental parameters include information indicating the temperature in the third ventilation path 33 detected by the second temperature sensor 52. Further, the environmental parameters may include one or more of a solar radiation amount, a solar radiation angle, a vehicle interior temperature, and an outside air temperature. Hereinafter, a case where the environmental parameters include information indicating the temperature in the third ventilation path 33 and information indicating the vehicle interior temperature will be described.

Next, in Step S402, the control unit 60 determines a thermal sensation parameter Z on the basis of the acquired environmental parameters.

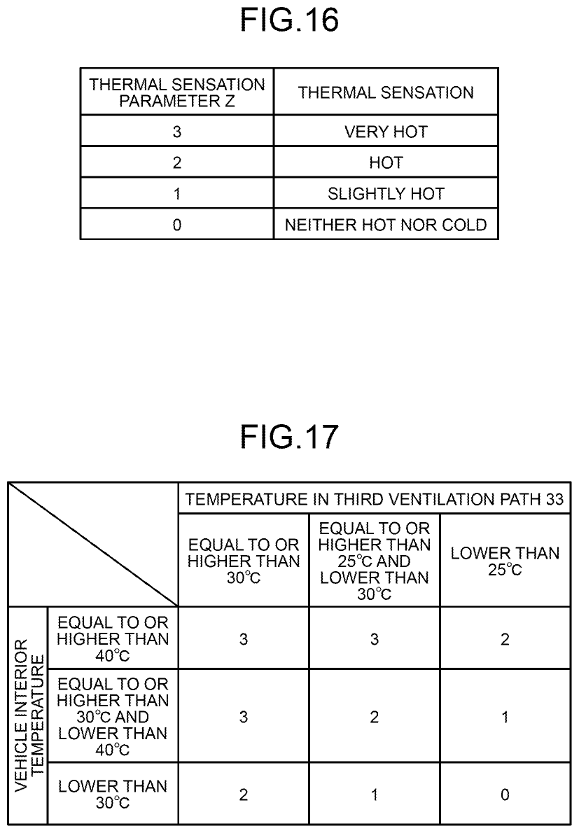

FIG. 16 is a diagram for describing an outline of the thermal sensation parameters of the vehicle seat air-conditioning device 3C according to the second embodiment. The thermal sensation parameter is expressed by quantifying the degree of heat felt by the occupant in four stages as illustrated in the first column of FIG. 16. It can be evaluated that the occupant feels very hot when the thermal sensation parameter Z=3, the occupant feels hot when Z=2, the occupant feels slightly hot when Z=1, and the occupant feels neither hot nor cold when Z=0. That is, the occupant feels hotter as the thermal sensation parameter Z is higher, and the occupant feels cooler as the thermal sensation parameter Z is lower.

FIG. 17 is a diagram for describing a method for determining a thermal sensation parameter of the vehicle seat air-conditioning device 3C according to the second embodiment. In the present embodiment, the control unit 60 determines the thermal sensation parameter Z on the basis of the temperature in the third ventilation path 33 and the vehicle interior temperature included in the environmental parameters. Specifically, when the temperature in the third ventilation path 33 is equal to or higher than 30° C. and the vehicle interior temperature is equal to or higher than 30° C., and when the temperature in the third ventilation path 33 is lower than 30° C. and is equal to or higher than 25° C. and the vehicle interior temperature is equal to or higher than 40° C., the control unit 60 determines that the thermal sensation parameter Z=3. Further, the control unit 60 determines that the thermal sensation parameter Z=2 when the temperature in the third ventilation path 33 is equal to or higher than 30° C. and the vehicle interior temperature is lower than 30° C., when the temperature in the third ventilation path 33 is lower than 30° C. and equal to or higher than 25° C. and the vehicle interior temperature is lower than 40° C. and equal to or higher than 30° C., and when the temperature in the third ventilation path 33 is lower than 25° C. and the vehicle interior temperature is equal to or higher than 40° C. Further, when the temperature in the third ventilation path 33 is lower than 30° C. and equal to or higher than 25° C. and the vehicle interior temperature is lower than 30° C., and when the temperature in the third ventilation path 33 is lower than 25° C. and the vehicle interior temperature is lower than 40° C. and equal to or higher than 30° C., the control unit 60 determines that the thermal sensation parameter Z=1. Further, when the temperature in the third ventilation path 33 is lower than 25° C. and the vehicle interior temperature is lower than 30° C., the control unit 60 determines that the thermal sensation parameter Z=0.

The control unit 60 controls an air volume of air (also referred to as a fifth flow rate) generated by the vehicle air-conditioning apparatus 2b on the basis of the determined thermal sensation parameter Z. For example, the control unit 60 controls the blower of the vehicle air-conditioning apparatus 2b to thereby adjust the air volume of the air generated by the vehicle air-conditioning apparatus 2b.

Specifically, in Step S403, the control unit 60 determines whether or not the thermal sensation parameter Z=3 is satisfied.

When the control unit 60 determines that the thermal sensation parameter Z=3 is satisfied (YES in S403), the process proceeds to Step S404. In Step S404, the control unit 60 controls the vehicle air-conditioning apparatus 2b to thereby adjust the output (for example, the rotation speed of the blower) of the vehicle air-conditioning apparatus 2b such that the air volume of the air generated by the vehicle air-conditioning apparatus 2b becomes a first generation flow rate. Then, the control unit 60 ends the process and returns to Step S401 to repeat the process.

When the control unit 60 determines that the thermal sensation parameter Z=3 is not satisfied (NO in S403), the process proceeds to Step S405. In Step S405, the control unit 60 determines whether or not the thermal sensation parameter Z=2 is satisfied.

When the control unit 60 determines that the thermal sensation parameter Z=2 is satisfied (YES in S405), the process proceeds to Step S406. In Step S406, the control unit 60 controls the vehicle air-conditioning apparatus 2b to thereby adjust the output of the vehicle air-conditioning apparatus 2b such that the air volume of the air generated by the vehicle air-conditioning apparatus 2b becomes a second generation flow rate. The second generation flow rate is a flow rate smaller than the first generation flow rate. Then, the control unit 60 ends the process and returns to Step S401 to repeat the process.

When the control unit 60 determines that the thermal sensation parameter Z=2 is not satisfied (NO in S405), the process proceeds to Step S407. In Step S407, the control unit 60 determines whether or not the thermal sensation parameter Z=1 is satisfied.

When the control unit 60 determines that the thermal sensation parameter Z=1 is satisfied (YES in S407), the process proceeds to Step S408. In Step S408, the control unit 60 controls the vehicle air-conditioning apparatus 2b to thereby adjust the output of the vehicle air-conditioning apparatus 2b such that the air volume of the air generated by the vehicle air-conditioning apparatus 2b becomes a third generation flow rate. The third generation flow rate is a flow rate smaller than the second generation flow rate. Then, the control unit 60 ends the process and returns to Step S401 to repeat the process.

When the control unit 60 determines that the thermal sensation parameter Z=1 is not satisfied (NO in S407), the process proceeds to Step S409. In Step S409, the control unit 60 controls the vehicle air-conditioning apparatus 2b to thereby adjust the output of the vehicle air-conditioning apparatus 2b such that the air volume of the air generated by the vehicle air-conditioning apparatus 2b becomes a fourth generation flow rate. The fourth generation flow rate is a flow rate smaller than the third generation flow rate. Then, the control unit 60 ends the process and returns to Step S401 to repeat the process.

For example, the first generation flow rate is 600 m³/h, the second generation flow rate is 540 m³/h, the third generation flow rate is 480 m³/h, and the fourth generation flow rate is 360 m³/h. Note that the first generation flow rate, the second generation flow rate, the third generation flow rate, and the fourth generation flow rate may be arbitrarily set. These pieces of information are stored in the storage unit in advance, for example.

### Processing Example 2

The present processing example is different from Processing Example 1 in that a temperature of air cooled by the evaporator of the vehicle air-conditioning apparatus 2b is adjusted in accordance with the thermal sensation parameter.

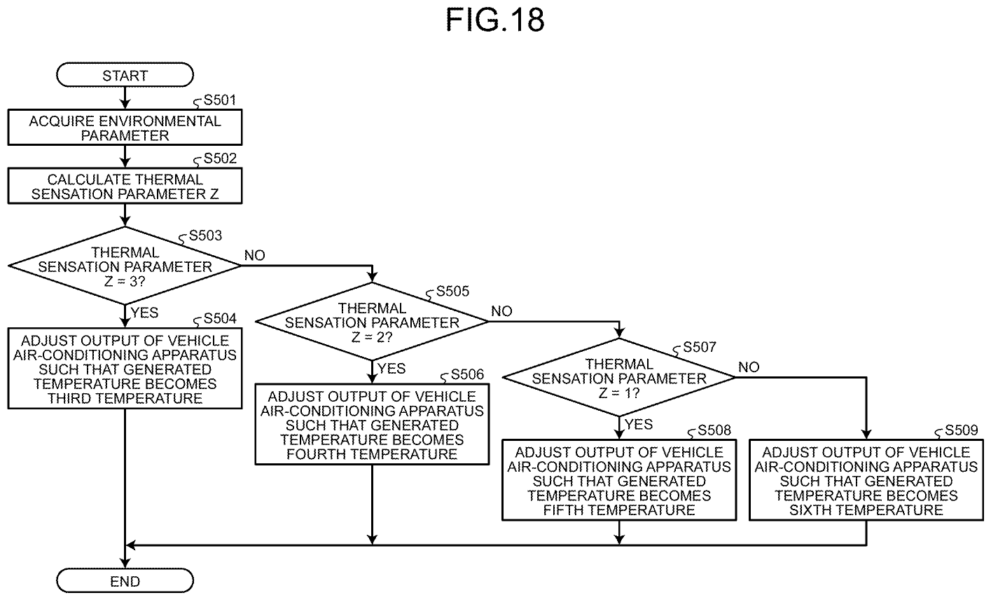

FIG. 18 is a flowchart illustrating a second example of processing of the vehicle seat air-conditioning device 3C according to the second embodiment.

First, in Step S501, the control unit 60 acquires environmental parameters from the environmental sensor 50. The environmental parameters include information indicating the temperature in the third ventilation path 33 detected by the second temperature sensor 52. Further, the environmental parameters may include one or more of a solar radiation amount, a solar radiation angle, a vehicle interior temperature, and an outside air temperature. Hereinafter, a case where the environmental parameters include information indicating the temperature in the third ventilation path 33 and information indicating the vehicle interior temperature will be described.

Next, in Step S502, the control unit 60 determines the thermal sensation parameter Z on the basis of the acquired environmental parameters. The control unit 60 controls the temperature of the air cooled by the evaporator of the vehicle air-conditioning apparatus 2b on the basis of the determined thermal sensation parameter Z. For example, the control unit 60 controls an electric compressor of the vehicle air-conditioning apparatus 2b to thereby adjust the temperature of the air cooled by the evaporator of the vehicle air-conditioning apparatus 2b. Note that the temperature of the air cooled by the evaporator of the vehicle air-conditioning apparatus 2b is also simply referred to as the temperature of the air generated by the vehicle air-conditioning apparatus 2b and also referred to as a generated temperature.

Specifically, in Step S503, the control unit 60 determines whether or not the thermal sensation parameter Z=3 is satisfied.

When the control unit 60 determines that the thermal sensation parameter Z=3 is satisfied (YES in S503), the process proceeds to Step S504. In Step S504, the control unit 60 controls the vehicle air-conditioning apparatus 2b to thereby adjust the output (for example, the number of revolutions of the electric compressor) of the vehicle air-conditioning apparatus 2b such that the temperature of the air cooled by the evaporator of the vehicle air-conditioning apparatus 2b becomes a third temperature. Then, the control unit 60 ends the process and returns to Step S501 to repeat the process.

When the control unit 60 determines that the thermal sensation parameter Z=3 is not satisfied (NO in S503), the process proceeds to Step S505. In Step S505, the control unit 60 determines whether or not the thermal sensation parameter Z=2 is satisfied.

When the control unit 60 determines that the thermal sensation parameter Z=2 is satisfied (YES in S505), the process proceeds to Step S506. In Step S506, the control unit 60 controls the vehicle air-conditioning apparatus 2b to thereby adjust the output of the vehicle air-conditioning apparatus 2b such that the temperature of the air cooled by the evaporator of the vehicle air-conditioning apparatus 2b becomes a fourth temperature. The fourth temperature is higher than the third temperature. Then, the control unit 60 ends the process and returns to Step S501 to repeat the process.

When the control unit 60 determines that the thermal sensation parameter Z=2 is not satisfied (NO in S505), the process proceeds to Step S507. In Step S507, the control unit 60 determines whether or not the thermal sensation parameter Z=1 is satisfied.

When the control unit 60 determines that the thermal sensation parameter Z=1 is satisfied (YES in S507), the process proceeds to Step S508. In Step S508, the control unit 60 controls the vehicle air-conditioning apparatus 2b to thereby adjust the output of the vehicle air-conditioning apparatus 2b such that the temperature of the air cooled by the evaporator of the vehicle air-conditioning apparatus 2b becomes a fifth temperature. The fifth temperature is higher than the fourth temperature. Then, the control unit 60 ends the process and returns to Step S501 to repeat the process.

When the control unit 60 determines that the thermal sensation parameter Z=1 is not satisfied (NO in S507), the process proceeds to Step S509. In Step S509, the control unit 60 controls the vehicle air-conditioning apparatus 2b to thereby adjust the output of the vehicle air-conditioning apparatus 2b such that the temperature of the air cooled by the evaporator of the vehicle air-conditioning apparatus 2b becomes a sixth temperature. The sixth temperature is higher than the fifth temperature. Then, the control unit 60 ends the process and returns to Step S501 to repeat the process.

For example, the third temperature is 6° C., the fourth temperature is 8° C., the fifth temperature is 10° C., and the sixth temperature is 12° C. Note that the third temperature, the fourth temperature, the fifth temperature, and the sixth temperature may be arbitrarily set. These pieces of information are stored in the storage unit in advance, for example.

### Processing Example 3

The present processing example is different from Processing Example 1 and the like in that the air volume of air generated by the vehicle air-conditioning apparatus 2b and the temperature of the air cooled by the evaporator of the vehicle air-conditioning apparatus 2b are adjusted in accordance with the thermal sensation parameter.

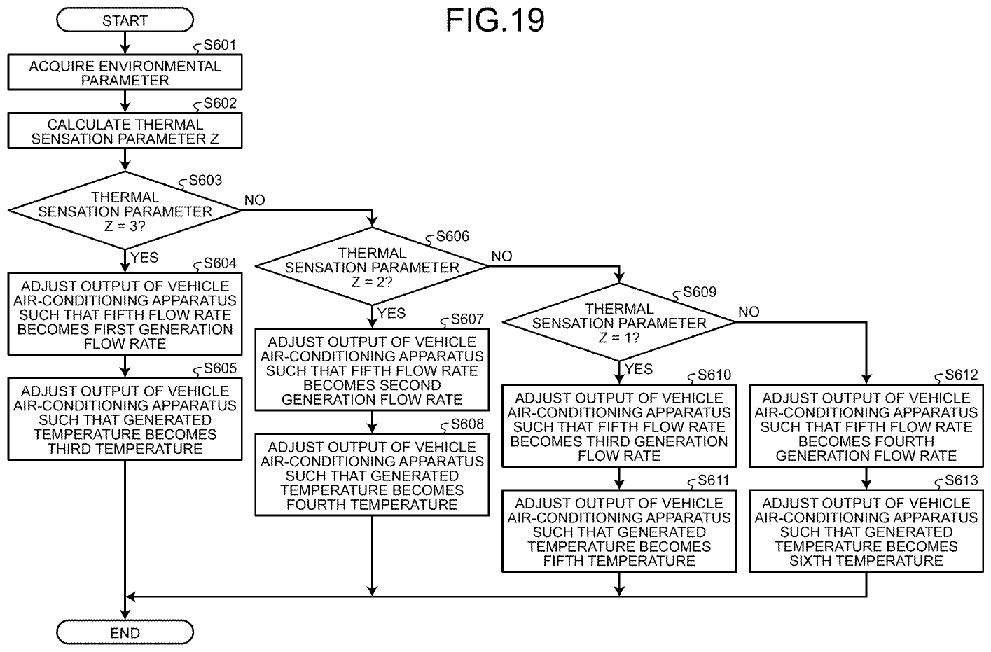

FIG. 19 is a flowchart illustrating a third example of processing of the vehicle seat air-conditioning device 3C according to the second embodiment. First, in Step S601, the control unit 60 acquires environmental parameters from the environmental sensor 50. The environmental parameters include information indicating the temperature in the third ventilation path 33 detected by the second temperature sensor 52. Further, the environmental parameters may include one or more of a solar radiation amount, a solar radiation angle, a vehicle interior temperature, and an outside air temperature. Hereinafter, a case where the environmental parameters include information indicating the temperature in the third ventilation path 33 and information indicating the vehicle interior temperature will be described.

Next, in Step S602, the control unit 60 determines the thermal sensation parameter Z on the basis of the acquired environmental parameters. The control unit 60 controls the air volume of the air generated by the vehicle air-conditioning apparatus 2b and the temperature of the air cooled by the evaporator of the vehicle air-conditioning apparatus 2b on the basis of the determined the thermal sensation parameter Z. Specifically, in Step S603, the control unit 60 determines whether or not the thermal sensation parameter Z=3 is satisfied.

When the control unit 60 determines that the thermal sensation parameter Z=3 is satisfied (YES in S603), the process proceeds to Step S604. In Step S604, the control unit 60 controls the vehicle air-conditioning apparatus 2b to thereby adjust the output of the vehicle air-conditioning apparatus 2b such that the air volume of the air generated by the vehicle air-conditioning apparatus 2b becomes the first generation flow rate.

Next, in Step S605, the control unit 60 controls the vehicle air-conditioning apparatus 2b to thereby adjust the output of the vehicle air-conditioning apparatus 2b such that the temperature of the air cooled by the evaporator of the vehicle air-conditioning apparatus 2b becomes the third temperature. Then, the control unit 60 ends the process and returns to Step S601 to repeat the process.

When the control unit 60 determines that the thermal sensation parameter Z=3 is not satisfied (NO in S603), the process proceeds to Step S606. In Step S606, the control unit 60 determines whether or not the thermal sensation parameter Z=2 is satisfied.

When the control unit 60 determines that the thermal sensation parameter Z=2 is satisfied (YES in S606), the process proceeds to Step S607. In Step S607, the control unit 60 controls the vehicle air-conditioning apparatus 2b to thereby adjust the output of the vehicle air-conditioning apparatus 2b such that the air volume of the air generated by the vehicle air-conditioning apparatus 2b becomes the second generation flow rate.

Next, in Step S608, the control unit 60 controls the vehicle air-conditioning apparatus 2b to thereby adjust the output of the vehicle air-conditioning apparatus 2b such that the temperature of the air cooled by the evaporator of the vehicle air-conditioning apparatus 2b becomes the fourth temperature. Then, the control unit 60 ends the process and returns to Step S601 to repeat the process.

When the control unit 60 determines that the thermal sensation parameter Z=2 is not satisfied (NO in S606), the process proceeds to Step S609. In Step S609, the control unit 60 determines whether or not the thermal sensation parameter Z=1 is satisfied.

When the control unit 60 determines that the thermal sensation parameter Z=1 is satisfied (YES in S609), the process proceeds to Step S610. In Step S610, the control unit 60 controls the vehicle air-conditioning apparatus 2b to thereby adjust the output of the vehicle air-conditioning apparatus 2b such that the air volume of the air generated by the vehicle air-conditioning apparatus 2b becomes the third generation flow rate.

Next, in Step S611, the control unit 60 controls the vehicle air-conditioning apparatus 2b to thereby adjust the output of the vehicle air-conditioning apparatus 2b such that the temperature of the air cooled by the evaporator of the vehicle air-conditioning apparatus 2b becomes the fifth temperature. Then, the control unit 60 ends the process and returns to Step S601 to repeat the process.

When the control unit 60 determines that the thermal sensation parameter Z=1 is not satisfied (NO in S609), the process proceeds to Step S612. In Step S612, the control unit 60 controls the vehicle air-conditioning apparatus 2b to thereby adjust the output of the vehicle air-conditioning apparatus 2b such that the air volume of the air generated by the vehicle air-conditioning apparatus 2b becomes the fourth generation flow rate.

Next, in Step S613, the control unit 60 controls the vehicle air-conditioning apparatus 2b to thereby adjust the output of the vehicle air-conditioning apparatus 2b so that the temperature of the air cooled by the evaporator of the vehicle air-conditioning apparatus 2b becomes the sixth temperature. Then, the control unit 60 ends the process and returns to Step S601 to repeat the process.

Note that, in the above processing example, the thermal sensation parameter Z is determined on the basis of the temperature in the third ventilation path 33 and the vehicle interior temperature, but the control unit 60 may determine the thermal sensation parameter Z on the basis of a combination of environmental parameters different from this combination. Further, the control unit 60 may determine the thermal sensation parameter Z on the basis of three or more environmental parameters. For example, when the temperature inside the third ventilation path 33 is lower than 25° C. and the vehicle interior temperature is lower than 30° C., the control unit 60 may determine the thermal sensation parameter Z to be a value higher than 0 when the vehicle outside temperature is high or the solar radiation amount is high. Further, the third ventilation path 33 can correspond to a “outlet ventilation path” in the claims.

Further, the control unit 60 may vary air-conditioning control processing depending on whether the vehicle air-conditioning apparatus 2b is in an inside air circulation mode or an outside air introduction mode. Specifically, the control unit 60 may control the amount of decrease in the fifth flow rate in the outside air introduction mode to be larger than the amount of decrease in the inside air circulation mode in a case where the environmental parameters do not include the information indicating the temperature in the third ventilation path 33. For example, when the vehicle air-conditioning apparatus 2b is in the inside air circulation mode, the fifth flow rate is decreased by 20% as compared with the case where the environmental parameters do not include the information indicating the temperature in the third ventilation path 33. On the other hand, when the vehicle air-conditioning apparatus 2b is in the outside air introduction mode, the fifth flow rate is decreased by 40% as compared with the case where the environmental parameters do not include the information indicating the temperature in the third ventilation path 33. As described above, when the vehicle air-conditioning apparatus 2b is in the outside air introduction mode, the fifth flow rate can be more greatly reduced as compared with the case where the environmental parameters do not include the information indicating the temperature in the third ventilation path 33, so that the efficiency can be more easily improved.

### Advantageous Effect

Next, advantageous effects of the vehicle seat air-conditioning device according to the present embodiment will be described.

As described above, the vehicle seat air-conditioning device 3C of the present embodiment is disposed in a vehicle and used in the seat 1 including the seat back 13 and the bottom 11. The vehicle seat air-conditioning device 3C includes the blower 34 that is incorporated in the seat 1 and guides air generated by the vehicle air-conditioning apparatus 2b mounted on the vehicle, the third ventilation path 33 that guides the air guided from the blower 34 to the first outlet 33a provided in a front surface of the seat back 13 that is a surface located to face an occupant seated on the seat 1, and the control unit 60 that controls the blower 34. The control unit 60 controls at least one of the air volume of air and the temperature of air generated by the vehicle air-conditioning apparatus 2b on the basis of the thermal sensation parameter Z determined from the environmental parameters including a detection result of information regarding the temperature of air discharged from the first outlet 33a.

For example, when the output of the vehicle air-conditioning apparatus 2b is controlled on the basis of an environmental parameter that does not include the temperature of the air discharged from the first outlet 33a provided in the front surface of the seat back 13, the environment around the occupant cooled by the vehicle seat air-conditioning device cannot be sufficiently considered, which may lead to overcooling or deterioration of air-conditioning efficiency. According to the vehicle seat air-conditioning device 3C of the present embodiment, the output of the vehicle air-conditioning apparatus 2b can be controlled on the basis of the temperature of the air discharged from the first outlet 33a provided in the front surface of the seat back 13, that is, the temperature at the position close to the body of the occupant. Thus, air-conditioning control in accordance with thermal sensation of the occupant can be performed, and a comfortable air-conditioning environment can be provided for the occupant. Further, more efficient air-conditioning control can be achieved by more immediately executing air-conditioning control in accordance with thermal sensation of the occupant. For example, by the vehicle seat air-conditioning device 3C of the present embodiment, the first generation flow rate, the second generation flow rate, the third generation flow rate, and the fourth generation flow rate can be made smaller than those when the environmental parameters do not include the information indicating the temperature in the third ventilation path 33. Further, the third temperature, the fourth temperature, the fifth temperature, and the sixth temperature can be further increased. As described above, the vehicle seat air-conditioning device 3C of the present embodiment can achieve more efficient air-conditioning control as compared with the case where the environmental parameters do not include the information indicating the temperature in the third ventilation path 33.

More specifically, in the vehicle seat air-conditioning device 3C of the present embodiment, the environmental parameter further includes at least one detection result of the outside air temperature, the vehicle interior temperature, the solar radiation amount, and the solar radiation angle.

Accordingly, the output of the vehicle air-conditioning apparatus 2b can be controlled on the basis of at least one of the outside air temperature, the vehicle interior temperature, the solar radiation amount, and the solar radiation angle in addition to the temperature of the air discharged from the first outlet 33a. Thus, the air-conditioning control in accordance with the thermal sensation of the occupant can be further performed.

Further, in the vehicle seat air-conditioning device 3C of the present embodiment, the control unit 60 decreases the air volume of the air generated by the vehicle air-conditioning apparatus 2b as the degree of feeling cool by the occupant seated on the seat 1 indicated by the thermal sensation parameter Z is higher. Accordingly, when the thermal sensation parameter Z has a lower value, that is, when the occupant feels cooler, the control unit 60 further reduces the air volume of the air generated by the vehicle air-conditioning apparatus 2b. Thus, the air-conditioning control in accordance with the thermal sensation of the occupant can be further performed.

Further, in the vehicle seat air-conditioning device 3C of the present embodiment, the control unit 60 increases the temperature of the air generated by the vehicle air-conditioning apparatus 2b, specifically, the temperature of the air cooled by the evaporator of the vehicle air-conditioning apparatus 2b as the degree of feeling cool by the occupant seated on the seat 1 indicated by the thermal sensation parameter Z is higher. Accordingly, when the thermal sensation parameter Z has a lower value, that is, when the occupant feels cooler, the control unit 60 increases the temperature of the air cooled by the evaporator of the vehicle air-conditioning apparatus 2b. Thus, excessive cooling of the occupant can be suppressed, and air conditioning control in accordance with the thermal sensation of the occupant can be further performed.

### Modification of Second Embodiment

The present modification is different from the vehicle seat air-conditioning device of the second embodiment in that a vehicle seat air-conditioning device 3D used in the seat 1 switches whether or not to execute the processing illustrated in FIGS. 15, 18, 19, and 20 in accordance with the temperature in the first ventilation path 31. Other configurations according to the present modification are similar to those in the second embodiment, and the same configurations and functions are denoted by the same reference numerals and detailed description of the configurations and functions is omitted.

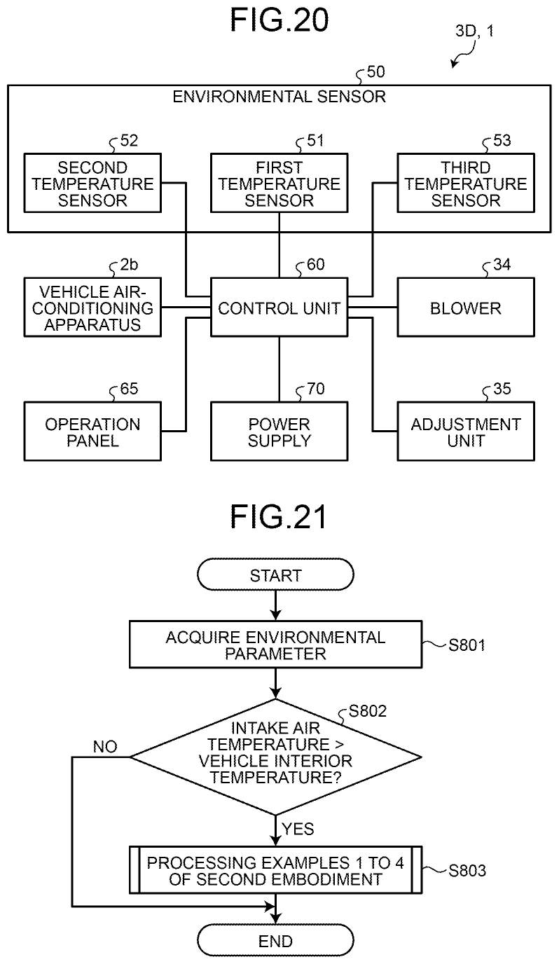

FIG. 20 is a block diagram illustrating a vehicle seat air-conditioning device 3D according to a modification of the second embodiment.

As illustrated in FIG. 20, in the vehicle seat air-conditioning device 3D, the control unit 60 is electrically connected to a third temperature sensor 53. The third temperature sensor 53 is a temperature sensor such as a thermistor that detects the temperature in the first ventilation path 31. For example, the third temperature sensor 53 is provided in the first ventilation path 31 or the first inlets 31a, and detects the temperature of the air sucked in from the first inlets 31a. The third temperature sensor 53 outputs information indicating the temperature in the first ventilation path 31 to the control unit 60 as a result of detecting the information.

### Processing

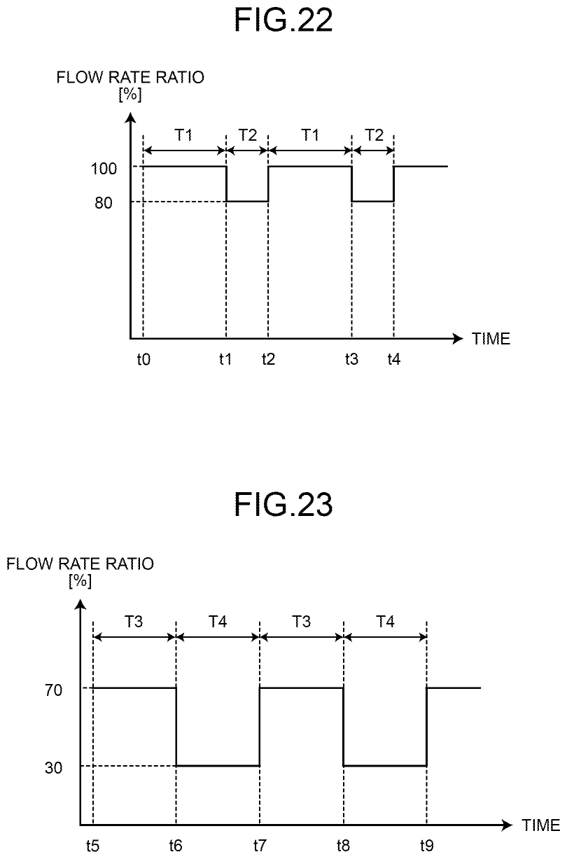

FIG. 21 is a flowchart illustrating processing of the vehicle seat air-conditioning device 3D according to the modification of the second embodiment. FIG. 22 is a diagram for describing a method of detecting a temperature in the first ventilation path 31 of the vehicle seat air-conditioning device 3D according to the modification of the second embodiment.

First, in Step S801, the control unit 60 acquires environmental parameters from the environmental sensor 50. The environmental parameters include information indicating a vehicle interior temperature detected by the vehicle interior temperature sensor and information indicating a temperature in the first ventilation path 31 (also referred to as intake air temperature) detected by the third temperature sensor 53.

Here, a method of detecting the temperature in the first ventilation path 31 by the third temperature sensor 53 will be described with reference to FIG. 22. In FIG. 22, the horizontal axis is a time axis, and times t0 to t4 are times set at predetermined intervals. A period between time t0 and time t1 and a period between time t2 and time t3 are defined as a first period T1 (also referred to as a first time), and a period between time t1 and time t2 and a period between time t3 and time t4 are defined as a second period T2 (also referred to as a second time). The first period T1 and the second period T2 are alternately and continuously set periods. For example, the first period T1 is 20 seconds, and the second period T2 is 10 seconds.

As illustrated in FIG. 22, the control unit 60 controls the adjustment unit 35 to thereby adjust the flow rate ratio to 100% in the first period T1. Thereafter, in the second period T2, the control unit 60 controls the adjustment unit 35 to thereby adjust the flow rate ratio to 80%. The control unit 60 then repeats the control of the first period T1 and the second period T2. Note that these flow rate ratios may be arbitrarily set, and these pieces of information are stored in the storage unit in advance, for example.

Here, when the flow rate ratio is 100%, the air is not sucked in from the first inlets 31a and the air does not flow in the first ventilation path 31, and thus the third temperature sensor 53 cannot detect the temperature of the air sucked in from the first inlets 31a. Accordingly, the control unit 60 sets the second period T2 in which the flow rate ratio is lower than 100%. That is, the adjustment unit 35 has a cooling mode in which the second ventilation path 32 is connected to the third ventilation path 33 and a mix mode in which the first ventilation path 31 and the second ventilation path 32 are connected to the third ventilation path 33, and one of the cooling mode and the mix mode by is selected by being controlled by the control unit 60. Then, by the control unit 60 selecting the cooling mode in the first period T1 and selecting the mix mode in the second period T2, the third temperature sensor 53 can detect the temperature in the first ventilation path 31 in the second period T2, that is, the temperature of the air sucked in from the first inlets 31a.

Next, in Step S802, the control unit 60 determines whether or not the intake air temperature is higher than the vehicle interior temperature.

When the control unit 60 determines that the intake air temperature is higher than the vehicle interior temperature (YES in S802), the process proceeds to Step S803. In Step S803, the control unit 60 executes any one of the processes illustrated in FIGS. 15, 18, 19, and 20. Then, the control unit 60 ends the process and returns to Step S801 to repeat the process.

As described above, the vehicle seat air-conditioning device 3D of the present modification further includes the first ventilation path 31 through which the air sucked in by the blower 34 from the first inlets 31a provided in the seat surface 11c of the bottom 11, which is the surface located to face the occupant seated on the seat 1, passes. The control unit 60 controls at least one of the air volume and the temperature of the air generated by the vehicle air-conditioning apparatus 2b on the basis of the temperature of the air sucked in from the first inlets 31a and the temperature of the interior of the vehicle.

Accordingly, the control unit 60 can estimate the vehicle interior environment on the basis of the temperature of the air sucked in from the first inlets 31a provided in the seat surface 11c of the bottom 11 and the temperature in the interior of the vehicle, and can control the output of the vehicle air-conditioning apparatus 2b. Thus, the air-conditioning control in accordance with the thermal sensation of the occupant can be further performed.

More specifically, in the vehicle seat air-conditioning device 3D of the present modification, when the temperature of the air sucked in from the first inlets 31a is equal to or higher than the temperature in the interior of the vehicle, the control unit 60 executes at least one of control to decrease the air volume of the air generated by the vehicle air-conditioning apparatus 2b or control to increase the temperature of the air generated by the vehicle air-conditioning apparatus 2b, specifically, the temperature of the air cooled by the evaporator of the vehicle air-conditioning apparatus 2b.

When the temperature of the air sucked in from the first inlets 31a is lower than the temperature in the interior of the vehicle although the air is warmed by the buttocks, thighs, and the like of the occupant, it is conceivable that the air generated by the vehicle air-conditioning apparatus 2b is not cooled and the vehicle interior is also not cooled. Therefore, by the vehicle seat air-conditioning device 3D of the present modification, when the temperature of the air sucked in from the first inlets 31a is equal to or higher than the temperature in the interior of the vehicle, the control unit 60 can reduce the output of the vehicle air-conditioning apparatus 2b because the air generated by the vehicle air-conditioning apparatus 2b is cooled and the vehicle interior is also cooled. Thus, the air-conditioning control in accordance with the thermal sensation of the occupant can be further performed.

Further, the vehicle seat air-conditioning device 3D of the present modification further includes a second ventilation path 32 that is an inlet different from the first inlets 31a and through which air sucked in by the blower 34 passes from the second inlet 32a provided at a position other than the front surface of the seat 1 in the seat 1, and the adjustment unit 35 that selects at least one of the first ventilation path 31 and the second ventilation path 32. The adjustment unit 35 has a cooling mode in which the second ventilation path 32 is connected to the third ventilation path 33 in order to guide air to the third ventilation path 33, and a mix mode in which the first ventilation path 31 and the second ventilation path 32 are connected to the third ventilation path 33. The control unit 60 switches the mode of the adjustment unit 35 by selecting one of the cooling mode and the mix mode.

Accordingly, the control unit 60 can cause only the air sucked in from the second inlet 32a to be discharged from the first outlet 33a, and can cause the air sucked in simultaneously from both the first inlets 31a and the second inlet 32a to be discharged from the first outlet 33a. That is, the temperature of the air discharged from the first outlet 33a can be made different. Thus, the air-conditioning control in accordance with the thermal sensation of the occupant can be further performed.

Further, in the vehicle seat air-conditioning device 3D of the present modification, the control unit 60 switches the mode of the adjustment unit 35 such that the mix mode is selected when the first time elapses after the cooling mode is selected, and the cooling mode is selected when the second time shorter than the first time elapses after the mix mode is selected. The control unit 60 acquires the temperature of the air sucked in from the first inlets 31a detected during the second time.

Accordingly, during the second time in which the air is sucked in from the first inlets 31a, the third temperature sensor 53 can detect the temperature of the air sucked in from the first inlets 31a, and the control unit 60 can acquire the temperature detected by the third temperature sensor 53. Thus, the air-conditioning control in accordance with the thermal sensation of the occupant can be further performed.

Note that the first ventilation path 31 and the second ventilation path 32 can correspond to a “first inlet ventilation path” and a “second inlet ventilation path”, respectively, in the claims.

### Third Embodiment

The present embodiment is different from the vehicle seat air-conditioning device and the like of the first embodiment in that a vehicle seat air-conditioning device 3E used in the seat 1 discharges air having different temperatures while alternately switching the air. A configuration of the vehicle seat air-conditioning device 3E in the present embodiment is similar to that of the vehicle seat air-conditioning device 3C according to the first embodiment, and the same configurations and functions are denoted by the same reference numerals and detailed description of the configurations and functions is omitted.

Note that, in the present embodiment, the second temperature sensor 52 of the second embodiment may be provided in the vehicle seat air-conditioning device 3E.

FIG. 23 is a time chart illustrating control of the flow rate ratio of the vehicle seat air-conditioning device 3E according to the third embodiment.

The control unit 60 controls the adjustment unit 35 to thereby adjust the flow rate ratio, which is a ratio of the flow rate of the air guided from the second ventilation path 32 to the third ventilation path 33 to the total flow rate of the air guided from the first ventilation path 31 to the third ventilation path 33 and the air guided from the second ventilation path 32 to the third ventilation path 33, to either a temperature decreasing ratio or a temperature increasing ratio. The temperature decreasing ratio is, for example, a flow rate ratio at which the flow rate of the air guided from the second ventilation path 32 to the third ventilation path 33 is larger than the flow rate of the air guided from the first ventilation path 31 to the third ventilation path 33. The temperature increasing ratio is a ratio lower than the temperature decreasing ratio, and is, for example, a flow rate ratio at which the flow rate of the air guided from the first ventilation path 31 to the third ventilation path 33 is larger than the flow rate of the air guided from the second ventilation path 32 to the third ventilation path 33. For example, the temperature decreasing ratio is 70%, and the temperature increasing ratio is 30%. Here, in the temperature decreasing ratio, since the flow rate of the air guided from the second ventilation path 32 to the third ventilation path 33 is large, the ratio of the cooled air generated by the vehicle air-conditioning apparatus 2b increases, and the temperature of the air discharged from the first outlet 33a can be decreased. Further, in the temperature increasing ratio, since the flow rate of the air guided from the first ventilation path 31 to the third ventilation path 33 is large, the ratio of the air sucked in from the first inlets 31a and warmed by the buttocks, thighs, and the like of the occupant is large, and the temperature of the air discharged from the first outlet 33a can be raised. The control unit 60 can adjust the flow rate of the air sucked in from the first inlets 31a and the temperature of the air discharged from the first outlet 33a by adjusting the flow rate ratio as described above. That is, the control unit 60 can select one of the temperature decreasing mode in which the flow rate ratio is adjusted to the temperature decreasing ratio to increase the ratio of the air cooled by the vehicle air-conditioning apparatus 2b and the temperature increasing mode in which the flow rate ratio is adjusted to the temperature increasing ratio to increase the ratio of the air sucked in from the first inlets 31a.

Note that, in actual control, the control unit 60 may control the opening degree of the damper of the adjustment unit 35. For example, respective opening degrees of the damper corresponding to the temperature decreasing ratio and the temperature increasing ratio may be stored in advance in the storage unit, and the control unit 60 may read these pieces of information from the storage unit to control the adjustment unit 35. Further, the temperature decreasing ratio and the temperature increasing ratio may be arbitrarily set.

The control unit 60 performs control to periodically switch between the temperature decreasing mode and the temperature increasing mode. This control will be described with reference to FIG. 23. In FIG. 23, the horizontal axis is a time axis, and times t5 to t9 are times set at predetermined intervals. The predetermined interval is, for example, two minutes. Then, a period between time t5 and time t6 and a period between time t7 and time t8 are defined as a third period T3, and a period between time t6 and time t7 and a period between time t8 and time t9 are defined as a fourth period T4. That is, the third period T3 and the fourth period T4 are periods corresponding to predetermined intervals, and are periods set alternately and continuously. Note that the third period T3 and the fourth period T4 can correspond to a “first predetermined time” and a “second predetermined time”, respectively, in the claims.

As illustrated in FIG. 23, in the third period T3, the control unit 60 controls the adjustment unit 35 to thereby adjust the flow rate ratio to the temperature decreasing ratio. Thereafter, in the fourth period T4, the control unit 60 controls the adjustment unit 35 to thereby adjust the flow rate ratio to the temperature increasing ratio. The control unit 60 then repeats the control of the third period T3 and the fourth period T4.

Note that the control unit 60 may execute control for switching between the temperature decreasing mode and the temperature increasing mode in accordance with the temperature in the third ventilation path 33 detected by second temperature sensor 52 instead of executing control for switching between the temperature decreasing mode and the temperature increasing mode at predetermined time intervals. For example, the control unit 60 executes the temperature decreasing mode and determines whether or not the temperature in the third ventilation path 33 is equal to or lower than a seventh temperature. When it is determined that the temperature in the third ventilation path 33 is equal to or lower than the seventh temperature, the control unit 60 switches to the temperature increasing mode and determines whether or not the temperature in the third ventilation path 33 is equal to or higher than an eighth temperature. The eighth temperature is higher than the seventh temperature. When it is determined that the temperature in the third ventilation path 33 is equal to or higher than the eighth temperature, the control unit 60 switches to the temperature decreasing mode. Note that the seventh temperature and the eighth temperature can correspond to a “first predetermined temperature” and a “second predetermined temperature”, respectively, in the claims.

Further, the third period T3, the fourth period T4, the seventh temperature, and the eighth temperature described above may be set such that the skin temperature of the occupant does not rise, for example. For example, by setting the eighth temperature to 32° C., an increase in the skin temperature of the occupant can be suppressed.

In addition, the control unit 60 may adjust the flow rate ratio so as to gradually increase or decrease as time passes. For example, in the third period T3, the control unit 60 may adjust the flow rate ratio so as to gradually raise the flow rate ratio to the temperature decreasing ratio, and then maintain the flow rate ratio. In addition, in the fourth period T4, the control unit 60 may adjust the flow rate ratio so as to gradually lower the flow rate ratio to the temperature increasing ratio, and then maintain the flow rate ratio.

### Advantageous Effect

Next, advantageous effects of the vehicle seat air-conditioning device according to the present embodiment will be described.

As described above, the vehicle seat air-conditioning device 3E of the present embodiment is disposed in a vehicle and used in the seat 1 including the seat back 13 and the bottom 11. A vehicle seat air-conditioning device 3E includes the blower 34 incorporated in a seat 1, the first ventilation path 31 through which air sucked in by the blower 34 passes from the first inlet 31a provided in a front surface of the seat 1 that is a surface positioned to face the occupant seated on the seat 1, the second ventilation path 32 through which air sucked in by the blower 34 passes from the second inlet 32a that is an inlet different from the first inlet 31a and is provided at a position other than the front surface of the seat 1 in the seat 1, the third ventilation path 33 that guides air guided from at least one of the first ventilation path 31 or the second ventilation path 32 to the first outlet 33a provided in a front surface of the seat back 13 that is a surface positioned to face the occupant seated on the seat 1, the adjustment unit 35 that adjusts the ratio (flow rate ratio) of the flow rate of air guided from the second ventilation path 32 to the third ventilation path 33 to the total flow rate of air guided from the first ventilation path 31 to the third ventilation path 33 and air guided from the second ventilation path 32 to the third ventilation path 33, and the control unit 60 that controls the blower 34 and the adjustment unit 35. The control unit 60 adjusts the flow rate ratio at a predetermined timing set on the basis of an elapsed time or a temperature of the air discharged from the first outlet 33a.

Accordingly, the control unit 60 can change the temperature of the air discharged from the first outlet 33a at a predetermined timing. Thus, it is possible to suppress temperature habituation of the occupant due to blowing of air at a constant temperature, and to provide a comfortable air-conditioning environment for the occupant.

More specifically, in the vehicle seat air-conditioning device 3E of the present embodiment, when the first predetermined time elapses after executing control for adjusting the flow rate ratio to the temperature decreasing ratio at which the flow rate of the air guided from the second ventilation path 32 to the third ventilation path 33 is larger than the flow rate of the air guided from the first ventilation path 31 to the third ventilation path 33, the control unit 60 executes control for adjusting the flow rate ratio to the temperature increasing ratio at which the flow rate of the air guided from the first ventilation path 31 to the third ventilation path 33 is larger than the flow rate of the air guided from the second ventilation path 32 to the third ventilation path 33, and executes, when the second predetermined time elapses after executing the control for adjusting the flow rate ratio to the temperature increasing ratio, control for adjusting the flow rate ratio to the temperature decreasing ratio.

Accordingly, the flow rate ratio can be changed every predetermined time. Thus, the temperature habituation of the occupant can be suppressed.

Further, in the vehicle seat air-conditioning device 3E of the present embodiment, when the temperature of the air discharged from the first outlet 33a reaches the first predetermined temperature after executing the control for adjusting the flow rate ratio to the temperature decreasing ratio, the control unit 60 executes the control for adjusting the flow rate ratio to the temperature increasing ratio at which the flow rate ratio is lower than the temperature decreasing ratio, and executes, when the temperature of the air discharged from the first outlet 33a reaches the second predetermined temperature higher than the first predetermined temperature after executing the control for adjusting the flow rate ratio to the temperature increasing ratio, the control for adjusting the flow rate ratio to the temperature decreasing ratio.

Accordingly, the flow rate ratio can be changed in accordance with the temperature of the air discharged from the first outlet 33a. Thus, the temperature habituation of the occupant can be suppressed.

Further, in the vehicle seat air-conditioning device 3E of the present embodiment, the control unit 60 connects the second ventilation path 32 to the third ventilation path 33 when adjusting the flow rate ratio to the temperature decreasing ratio, and connects the first ventilation path 31 and the second ventilation path 32 to the third ventilation path 33 when adjusting the flow rate ratio to the temperature increasing ratio.

Accordingly, when the flow rate ratio is adjusted to the temperature decreasing ratio, air guided only from the second ventilation path 32 is guided to the third ventilation path 33, so that the air can be discharged from the first outlet 33a, and the temperature of the air discharged from the first outlet 33a can be easily decreased. Thus, the temperature habituation of the occupant can be further suppressed.

Further, in the vehicle seat air-conditioning device 3E of the present embodiment, the control unit 60 connects the first ventilation path 31 and the second ventilation path 32 to the third ventilation path 33 when adjusting the flow rate ratio to the temperature decreasing ratio, and connects the first ventilation path 31 to the third ventilation path 33 when adjusting the flow rate ratio to the temperature increasing ratio.

Accordingly, when the flow rate ratio is adjusted to the temperature increasing ratio, air guided only from the first ventilation path 31 is guided to the third ventilation path 33, so that the air can be discharged from the first outlet 33a, and the temperature of the air discharged from the first outlet 33a can be easily raised. Thus, the temperature habituation of the occupant can be further suppressed.

Further, in the vehicle seat air-conditioning device 3E of the present embodiment, the control unit 60 connects the first ventilation path 31 to the third ventilation path 33 when adjusting the flow rate ratio to the temperature decreasing ratio, and connects the first ventilation path 31 to the third ventilation path 33 when adjusting the flow rate ratio to the temperature increasing ratio.

Accordingly, when the flow rate ratio is adjusted to the temperature decreasing ratio, air guided only from the second ventilation path 32 is guided to the third ventilation path 33, so that the air can be discharged from the first outlet 33a, and the temperature of the air discharged from the first outlet 33a can be easily decreased. Further, when the flow rate ratio is adjusted to the temperature increasing ratio, air guided only from the first ventilation path 31 is guided to the third ventilation path 33, so that the air can be discharged from the first outlet 33a, and the temperature of the air discharged from the first outlet 33a can be easily raised. Thus, the temperature habituation of the occupant can be further suppressed.

Further, in the vehicle seat air-conditioning device 3E of the present embodiment, the first inlets 31a are provided in the seat surface 11c of the bottom 11.

When the flow rate ratio is increased, the ratio of the air guided from the second ventilation path 32 to the air discharged from the first outlet 33a increases, so that the temperature of the air discharged from the first outlet 33a provided in the seat back 13 decreases. Further, the flow rate of the air sucked in from the first inlets 31a provided in the bottom 11 decreases, and thus the occupant hardly feels the cooling sensation of the portion in contact with the seat surface 11c. On the other hand, when the flow rate ratio is lowered, the ratio of the air guided from the first ventilation path 31 to the air discharged from the first outlet 33a increases, so that the temperature of the air discharged from the first outlet 33a increases. Further, since the flow rate of the air sucked in from the first inlets 31a increases, the occupant easily feels the cooling sensation of the portion in contact with the seat surface 11c.

That is, with the vehicle seat air-conditioning device 3E of the present embodiment, when the cooling capacity in the seat back 13 is relatively high, the cooling capacity in the bottom 11 is relatively low, and when the cooling capacity in the seat back 13 is relatively low, the cooling capacity in the bottom 11 is relatively high. Thus, the temperature habituation of the occupant can be suppressed. Furthermore, since a cooling sensation is given to the upper body or the lower body of the occupant, it is possible to provide a more comfortable air-conditioning environment for the occupant as compared with, for example, a configuration in which control of simultaneously cooling the upper body and the lower body of the occupant and control of simultaneously warming the upper body and the lower body of the occupant are repeated.

Further, as described above, since the temperature of the air sucked in from the first inlets 31a, that is, the air warmed by the body temperature of the occupant is used to increase the temperature of the air discharged from the first outlet 33a, the vehicle seat air-conditioning device 3E of the present embodiment can further simplify the structure in the vehicle.

### Modification of Third Embodiment

The present modification is different from the vehicle seat air-conditioning device of the third embodiment in that the control unit 60 controls the blower 34 so as to adjust the flow rate of air discharged from the first outlet 33a in accordance with switching of the flow rate ratio. Other configurations according to the present modification are similar to those in the third embodiment, and the same configurations and functions are denoted by the same reference numerals and description of the configurations and functions is omitted.

The control unit 60 controls the blower 34 to thereby adjust the flow rate of the air discharged from the first outlet 33a to either a fourth discharge flow rate or a fifth discharge flow rate. The fifth discharge flow rate is larger than the fourth discharge flow rate. For example, the fourth discharge flow rate is 20 m³/h, and the fifth discharge flow rate is 40 m³/h. The control unit 60 can adjust the flow rate of the air sucked in from the first inlets 31a by adjusting the flow rate of the air discharged from the first outlet 33a as described above. Note that the fourth discharge flow rate and the fifth discharge flow rate may be arbitrarily set, and these pieces of information are stored in the storage unit in advance, for example. Note that the fourth discharge flow rate and the fifth discharge flow rate can respectively correspond to a “first flow rate” and a “second flow rate” in the claims.

### Control Example 1

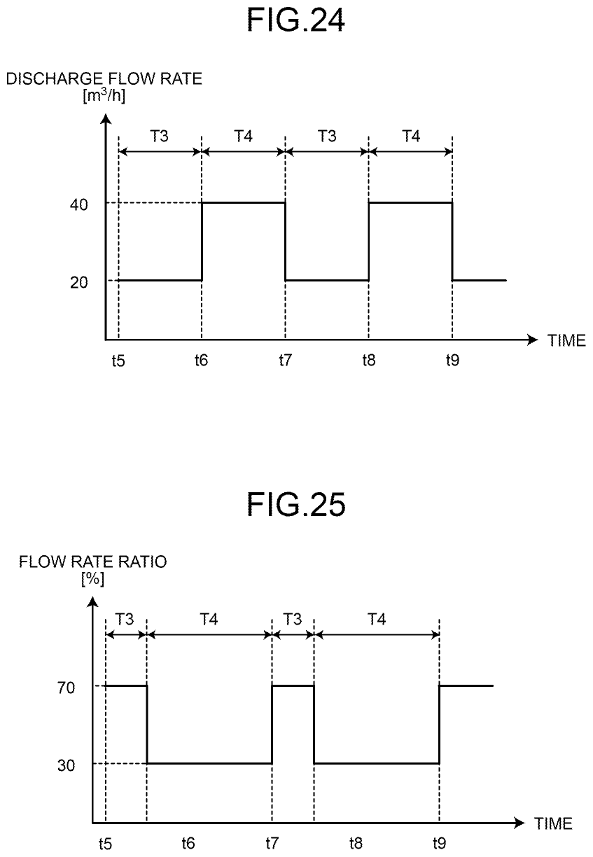

FIG. 24 is a time chart illustrating a first example of control of the discharge flow rate of a vehicle seat air-conditioning device 3F according to the modification of the third embodiment.

As illustrated in FIG. 23, in the third period T3, the control unit 60 controls the adjustment unit 35 to thereby adjust the flow rate ratio to the temperature decreasing ratio. Thereafter, in the fourth period T4, the control unit 60 controls the adjustment unit 35 to thereby adjust the flow rate ratio to the temperature increasing ratio. The control unit 60 then repeats the control of the third period T3 and the fourth period T4.

The control unit 60 further controls the blower 34 to thereby adjust the flow rate of the air discharged from the first outlet 33a. Specifically, as illustrated in FIG. 24, the control unit 60 controls the blower 34 in the third period T3 to thereby adjust the flow rate of the air discharged from the first outlet 33a to the fourth discharge flow rate. Thereafter, in the fourth period T4, the control unit 60 controls the blower 34 to thereby adjust the flow rate of the air discharged from the first outlet 33a to the fifth discharge flow rate. The control unit 60 then repeats the control of the third period T3 and the fourth period T4.

When the vehicle interior is cooled by the vehicle air-conditioning apparatus 2b or the like, the temperature of the air sucked in from the first inlets 31a is also low, and thus, even if the flow rate ratio is adjusted to the temperature increasing ratio, the temperature of the air discharged from the first outlet 33a is unlikely to increase. Thus, according to the present control example, when the flow rate ratio is adjusted to the temperature increasing ratio, the control unit 60 controls the blower 34 so as to increase the flow rate of the air discharged from the first outlet 33a, so that the temperature of the air discharged from the first outlet 33a can be easily raised. Thus, the temperature habituation of the occupant can be further suppressed.

### Control Example 2

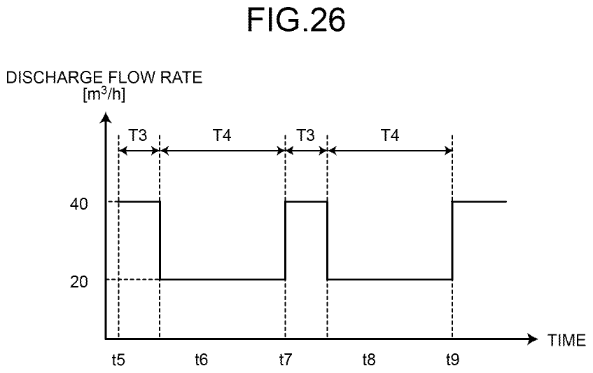

FIG. 25 is a time chart illustrating a second example of control of the flow rate ratio of the vehicle seat air-conditioning device 3F according to the modification of the third embodiment. FIG. 26 is a time chart illustrating a second example of control of the discharge flow rate of the vehicle seat air-conditioning device 3F according to the modification of the third embodiment.

In FIGS. 25 and 26, the fourth period T4 is set longer than the third period T3. For example, the third period T3 is one minute, and the fourth period T4 is three minutes.

As illustrated in FIG. 25, in the third period T3, the control unit 60 controls the adjustment unit 35 to thereby adjust the flow rate ratio to the temperature decreasing ratio. Thereafter, in the fourth period T4, the control unit 60 controls the adjustment unit 35 to thereby adjust the flow rate ratio to the temperature increasing ratio. The control unit 60 then repeats the control of the third period T3 and the fourth period T4.

The control unit 60 further controls the blower 34 to thereby adjust the flow rate of the air discharged from the first outlet 33a. Specifically, as illustrated in FIG. 26, in the third period T3, the control unit 60 controls the blower 34 to thereby adjust the flow rate of the air discharged from the first outlet 33a to the fifth discharge flow rate. Thereafter, in the fourth period T4, the control unit 60 controls the blower 34 to thereby adjust the flow rate of the air discharged from the first outlet 33a to the fourth discharge flow rate. The control unit 60 then repeats the control of the third period T3 and the fourth period T4.

When the flow rate ratio is adjusted to the temperature decreasing ratio, more air cooled by the vehicle air-conditioning apparatus 2b is guided to the third ventilation path 33 and discharged from the first outlet 33a, so that the temperature of the air discharged from the first outlet 33a tends to decrease. In addition, according to the present processing example, when the flow rate ratio is adjusted to the temperature decreasing ratio, the control unit 60 controls the blower 34 so as to increase the flow rate of the air discharged from the first outlet 33a, so that the temperature of the air discharged from the first outlet 33a can be further easily lowered. Thus, the occupant feels that the temperature of the air discharged from the first outlet 33a has rapidly decreased, and the occupant can be awakened from drowsiness.

As described above, in the vehicle seat air-conditioning device 3F of the present modification, the control unit 60 controls the blower 34 so as to adjust the flow rate of the air discharged from the first outlet 33a at a predetermined timing.

Accordingly, in addition to the temperature of the air discharged from the first outlet 33a, the flow rate of the air can also be changed at a predetermined timing. Thus, the temperature habituation of the occupant can be further suppressed.

Further, in the vehicle seat air-conditioning device 3F of the present modification, the control unit 60 controls the blower 34 so as to decrease the flow rate of the air discharged from the first outlet 33a when the flow rate ratio is adjusted to the temperature decreasing ratio, and to increase the flow rate of the air discharged from the first outlet 33a when the flow rate ratio is adjusted to the temperature increasing ratio.

When the vehicle interior is cooled by the vehicle air-conditioning apparatus 2b or the like, the temperature of the air sucked in from the first inlets 31a is also low, and thus, even if the flow rate ratio is adjusted to the temperature increasing ratio, the temperature of the air discharged from the first outlet 33a is unlikely to increase. Accordingly, by the vehicle seat air-conditioning device 3F of the present modification, when the flow rate ratio is adjusted to the temperature increasing ratio, the control unit 60 controls the blower 34 so as to increase the flow rate of the air discharged from the first outlet 33a, so that the temperature of the air discharged from the first outlet 33a can be easily increased. Thus, the temperature habituation of the occupant can be further suppressed.

Note that, when the temperature of the air discharged from the first outlet 33a is changed within a predetermined temperature range, the control unit 60 may adjust the flow rate of the air discharged from the first outlet 33a so that the time from when the flow rate ratio is adjusted to the temperature decreasing ratio until the temperature reaches a lower limit temperature (for example, the seventh temperature) within the temperature range and the time from when the flow rate ratio is adjusted to the temperature increasing ratio until the temperature reaches an upper limit temperature (for example, the eighth temperature) within the temperature range become the same. At this time, the control unit 60 may make the period from the execution of control for adjusting the flow rate ratio to the temperature increasing ratio to the execution of control for adjusting the flow rate ratio to the temperature decreasing ratio equal to the period from the execution of control for adjusting the flow rate ratio to the temperature decreasing ratio to the execution of control for adjusting the flow rate ratio to the temperature increasing ratio. Accordingly, the discomfort of the occupant can be reduced, and a more comfortable air-conditioning environment can be provided for the occupant. Here, the periods being the same or equal includes that the lengths of the periods are different due to variations in error.

Further, in the vehicle seat air-conditioning device 3F of the present modification, the control unit 60 controls the blower 34 so as to decrease the flow rate of the air discharged from the first outlet 33a to a first air volume and maintain the first air volume when the flow rate ratio is adjusted to the temperature decreasing ratio, and controls the blower 34 so as to increase the flow rate of the air discharged from the first outlet 33a to a second air volume larger than the first air volume and maintain the second air volume when the flow rate ratio is adjusted to the temperature increasing ratio.

Accordingly, when the flow rate ratio is adjusted to the temperature increasing ratio, the flow rate of the air discharged from the first outlet 33a can be increased to the second air volume more quickly and the second air volume can be maintained, so that the temperature of the air discharged from the first outlet 33a can be easily raised. Thus, the temperature habituation of the occupant can be further suppressed.

Further, in the vehicle seat air-conditioning device 3F of the present modification, the control unit 60 controls the blower 34 so as to increase the flow rate of the air discharged from the first outlet 33a when the flow rate ratio is adjusted to the temperature decreasing ratio, and to decrease the flow rate of the air discharged from the first outlet 33a when the flow rate ratio is adjusted to the temperature increasing ratio.

When the flow rate ratio is adjusted to the temperature decreasing ratio, more air cooled by the vehicle air-conditioning apparatus 2b is guided to the third ventilation path 33 and discharged from the first outlet 33a, so that the temperature of the air discharged from the first outlet 33a tends to decrease. In addition, by the vehicle seat air-conditioning device 3F of the present modification, when the flow rate ratio is adjusted to the temperature decreasing ratio, the control unit 60 controls the blower 34 so as to increase the flow rate of the air discharged from the first outlet 33a, so that the temperature of the air discharged from the first outlet 33a can be further easily decreased. Thus, the occupant feels that the temperature of the air discharged from the first outlet 33a has rapidly decreased, and the occupant can be awakened from drowsiness.

Further, in the vehicle seat air-conditioning device 3F of the present modification, the control unit 60 makes the period from the execution of control for adjusting the flow rate ratio to the temperature increasing ratio to the execution of control for adjusting the flow rate ratio to the temperature decreasing ratio longer than the period from the execution of control for adjusting the flow rate ratio to the temperature decreasing ratio to the execution of control for adjusting the flow rate ratio to the temperature increasing ratio.

Accordingly, the period during which the flow rate ratio is adjusted to the temperature increasing ratio to raise the temperature of the air discharged from the first outlet 33a can be made longer than the period during which the flow rate ratio is adjusted to the temperature decreasing ratio to lower the temperature of the air discharged from the first outlet 33a. Thus, the occupant feels that the temperature of the air discharged from the first outlet 33a has rapidly decreased, and the occupant can be awakened from drowsiness.

Further, in the vehicle seat air-conditioning device 3F of the present modification, the control unit 60 controls the blower 34 so as to decrease the flow rate of the air discharged from the first outlet 33a to the first air volume and maintain the first air volume when the flow rate ratio is adjusted to the temperature increasing ratio, and controls the blower 34 so as to increase the flow rate of the air discharged from the first outlet 33a to the second air volume larger than the first air volume and maintain the second air volume when the flow rate ratio is adjusted to the temperature decreasing ratio.

Accordingly, when the flow rate ratio is adjusted to the temperature decreasing ratio, the flow rate of the air discharged from the first outlet 33a can be increased to the second air volume more quickly and the second air volume can be maintained, so that the temperature of the air discharged from first outlet 33a can be easily decreased. Thus, the temperature habituation of the occupant can be further suppressed, and the occupant can be awakened from drowsiness.

### Fourth Embodiment

In the present embodiment, a vehicle seat air-conditioning device 3G executes the control described in each of the first to third embodiments. A configuration of the vehicle seat air-conditioning device 3G according to the present embodiment is similar to that of the vehicle seat air-conditioning device 3 and the like in the first embodiment, and the same configurations and functions are denoted by the same reference numerals and detailed description of the configurations and functions is omitted.

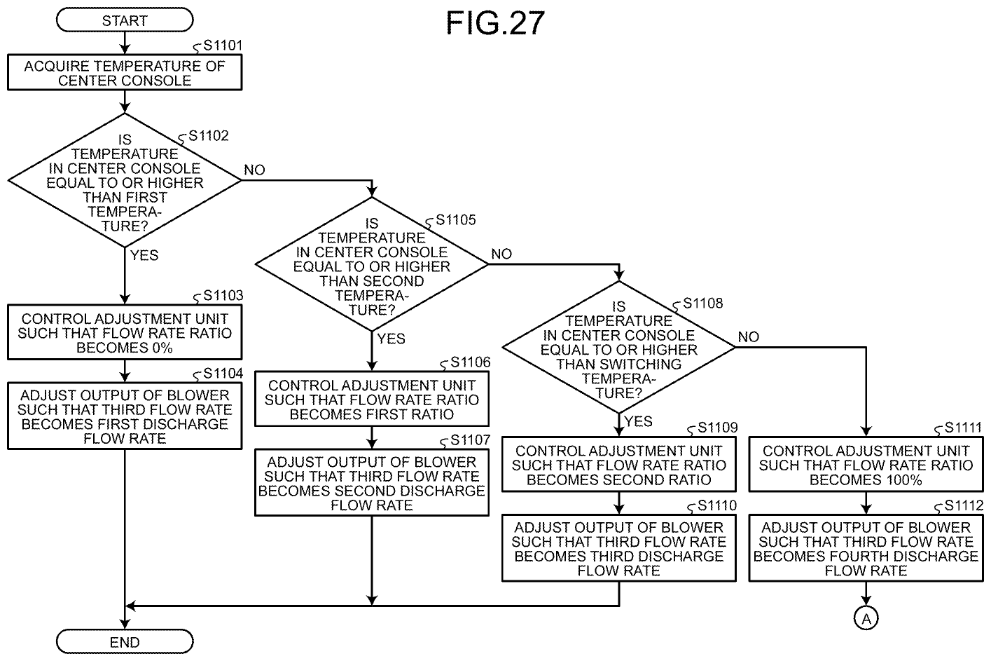

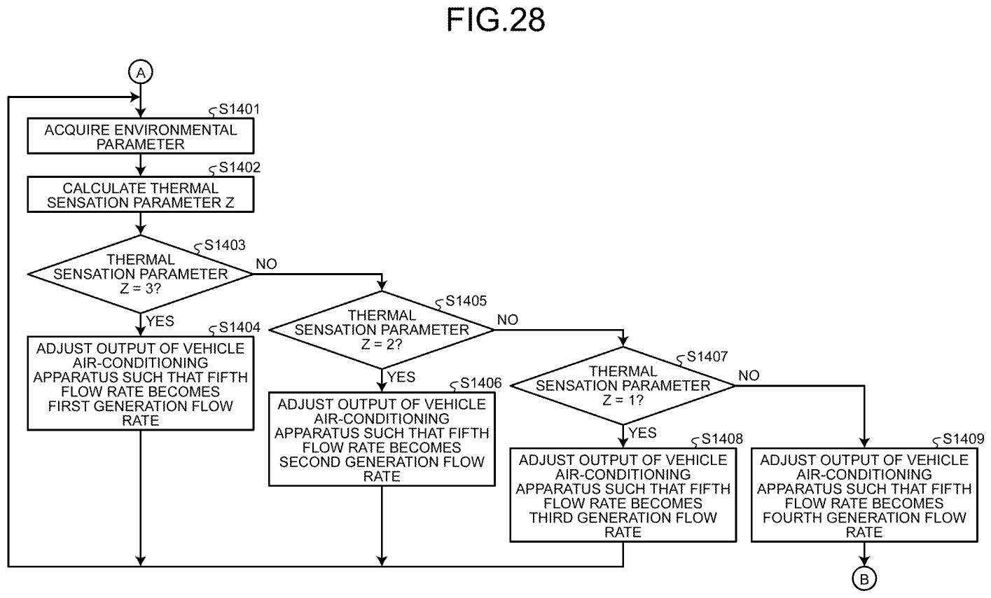

FIGS. 27 to 29 are flowcharts illustrating processing of the vehicle seat air-conditioning device 3G according to the fourth embodiment.

The processes in Steps S1101 to S1107 illustrated in FIG. 27 are similar to the processes in Steps S101 to S107 in the vehicle seat air-conditioning device according to the first embodiment.

When the control unit 60 determines that the temperature in the center console is lower than the second temperature (NO in S1105), the process proceeds to Step S1108. In Step S1108, the control unit 60 determines whether or not the temperature in the center console is equal to or higher than a switching temperature. The switching temperature is lower than the second temperature, and is, for example, 30° C.

When the control unit 60 determines that the temperature in the center console is equal to or higher than the switching temperature (YES in S1108), the process proceeds to Step S1109. The processes in Steps S1109 to S1110 are similar to the processes in Steps S108 to S109 in the vehicle seat air-conditioning device according to the first embodiment.

When the control unit 60 determines that the temperature in the center console is lower than the switching temperature (NO in S1108), the process proceeds to Step S1111. In Step S1111, the control unit 60 controls the adjustment unit 35 to thereby adjust the flow rate ratio to 100%.

Next, in Step S1112, the control unit 60 controls the blower 34 to thereby adjust the output of the blower 34 so that the flow rate of the air discharged from the first outlet 33a becomes the fourth discharge flow rate. Then, the process proceeds to Step S1401.

The processes in Steps S1401 to S1409 are similar to the processes in Steps S401 to S409 in the vehicle seat air-conditioning device according to the second embodiment. After Step S1409, the process proceeds to Step S1901.

In Step S1901, the control unit 60 controls the adjustment unit 35 to thereby adjust the flow rate ratio to the temperature decreasing ratio.

Next, in Step S1902, the control unit 60 determines whether or not the third period T3 has elapsed after the flow rate ratio is adjusted to the temperature decreasing ratio in Step S1901.

When the control unit 60 determines that the third period T3 has elapsed (YES in S1902), the process proceeds to Step S1903. In Step S1903, the control unit 60 controls the adjustment unit 35 to thereby adjust the flow rate ratio to the temperature increasing ratio.

When the control unit 60 determines that third period T3 has not elapsed (NO in S1902), the control unit 60 repeats the processing in Step S1902.

After Step S1903, in Step S1904, the control unit 60 determines whether or not the fourth period T4 has elapsed since the flow rate ratio was adjusted to the temperature increasing ratio in Step S1903. When the control unit 60 determines that the fourth period T4 has elapsed (YES in S1904), the control unit 60 returns the process to Step S1901 and repeats the process.

When the control unit 60 determines that fourth period T4 has not elapsed (NO in S1904), the control unit 60 repeats the processing in Step S1904.

Note that, in the above-described processing, the order of the determination processing may be appropriately changed.

Further, as in Modification 1 and Modification 2 of the first embodiment, a process for suppressing blowing of high temperature air to the occupant may be executed.

Further, as in Processing Example 2 and Processing Example 3 of the second embodiment, the temperature of the air generated by the vehicle air-conditioning apparatus 2b may be adjusted instead of or in addition to the air volume of the air generated by the vehicle air-conditioning apparatus 2b.

Further, as in Processing Example 4 of the second embodiment, different processes may be executed depending on whether the vehicle air-conditioning apparatus 2b is in the inside air circulation mode or the outside air introduction mode.

Further, as in the modification of the second embodiment, the process according to the temperature in the first ventilation path 31 may be executed.

Further, as in the modification of the third embodiment, the flow rate of the air discharged from the first outlet 33a may be adjusted in response to switching of the flow rate ratio.

### Modification of Fourth Embodiment

The present modification is different from the vehicle seat air-conditioning device of the fourth embodiment in that a third inlet 41a is provided in the seat back 13. Other configurations according to the present modification are similar to those in the fourth embodiment, and the same configurations and functions are denoted by the same reference numerals and detailed description of the configurations and functions is omitted.

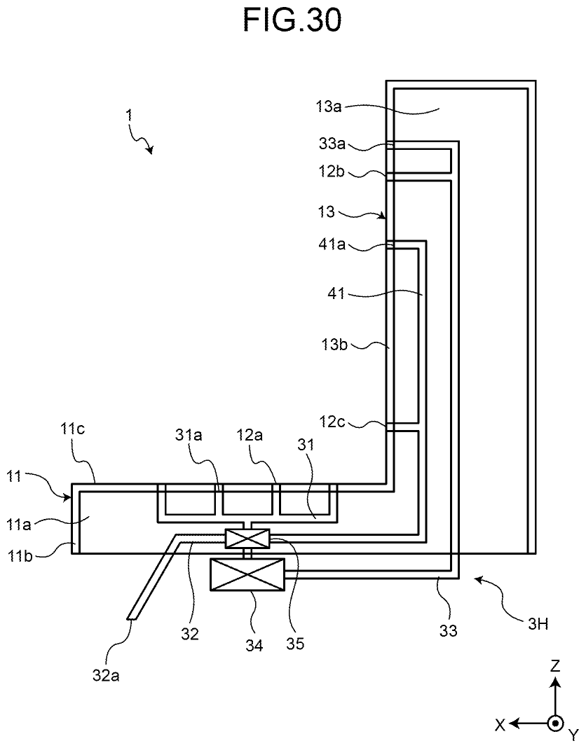

FIG. 30 is a cross-sectional view of a seat provided with a vehicle seat air-conditioning device according to the modification of the fourth embodiment.

As illustrated in FIG. 30, the third inlet 41a and a fifth ventilation path 41 are formed in the seat 1 provided with a vehicle seat air-conditioning device 3H according to the present modification. In the present modification, the third inlet 41a is formed in the second seat pad 13a of the seat back 13. Further, in the second seat cover 13b, the third ventilation port 12c is formed in a surface (a surface to the X-axis plus direction) opposed to the occupant seated on the bottom 11, and at a position corresponding to the third inlet 41a of the fifth ventilation path 41. In the present modification, the height at which the third inlet 41a is disposed with respect to a floor surface of the vehicle interior is disposed below the height at which the first outlet 33a is disposed with respect to the floor surface of the vehicle interior. In the present modification, a plurality of the third ventilation ports 12c is formed in the second seat cover 13b. The plurality of the third ventilation ports 12c is formed, for example, in a portion of the second seat cover 13b corresponding to the back and the waist of the occupant, and a plurality of rows arranged in the Y-axis direction are formed.

In the present modification, the fifth ventilation path 41 of the vehicle seat air-conditioning device 3H guides air sucked in from the third inlet 41a provided in the second seat cover 13b of the seat back 13 to the adjustment unit 35 by the blower 34.

In the present modification, the adjustment unit 35 adjusts a ratio (hereinafter, also simply referred to as a flow rate ratio) between the flow rate of the air guided from the first ventilation path 31 to the third ventilation path 33 and the flow rate of the air guided from the fifth ventilation path 41 to the third ventilation path 33 (also referred to as a sixth flow rate) and the flow rate of the air guided from the second ventilation path 32 to the third ventilation path 33 (also referred to as a second flow rate). For example, it is a switching unit (ventilation path switching unit) capable of switching the flow path of air to the third ventilation path 33 among the first ventilation path 31, the second ventilation path 32, and the fifth ventilation path 41 such that air is guided from the first ventilation path 31 to the third ventilation path 33, air is guided from the fifth ventilation path 41 to the third ventilation path 33, and/or air is guided from the second ventilation path 32 to the third ventilation path 33. The adjustment unit 35 is constituted by, for example, a damper or the like.

Here, the flow rate ratio according to the present modification means a ratio of the second flow rate to the total flow rate of the sixth flow rate and the second flow rate (second flow rate/total flow rate). For example, the flow rate ratio of 0% is a state in which the first ventilation path 31 and/or the fifth ventilation path 41 and the third ventilation path 33 are connected, and is a state in which air guided from the first ventilation path 31 and/or the fifth ventilation path 41 is guided to the third ventilation path 33 to thereby discharge the air from the first outlet 33a. Further, for example, the flow rate ratio of 100% is a state in which the second ventilation path 32 and the third ventilation path 33 are connected, and is a state in which air guided only from the second ventilation path 32 is guided to the third ventilation path 33 to thereby discharge the air from the first outlet 33a. Further, for example, the flow rate ratio of 50% is a state in which the first ventilation path 31 and/or the fifth ventilation path 41, the second ventilation path 32, and the third ventilation path 33 are connected to each other, and is a state in which substantially the same flow rate of air simultaneously guided from the first ventilation path 31 and/or the fifth ventilation path 41 and the second ventilation path 32 is guided to the third ventilation path 33 and mixed to discharge the air from the first outlet 33a. In other words, the flow rate ratio of 50% is a state in which (the total of) the flow rate of the air guided from the first ventilation path 31 and/or the fifth ventilation path 41 and the flow rate of the air guided from the second ventilation path 32 are substantially the same.

In the vehicle seat air-conditioning device 3H of the present modification, in the process illustrated in FIGS. 27 to 29, when controlling the adjustment unit 35 to guide at least the air guided from the first ventilation path 31 to the third ventilation path 33, the control unit 60 switches between guiding air guided only from the first ventilation path 31 to the third ventilation path 33 and guiding air guided from both the first ventilation path 31 and the fifth ventilation path 41 to the third ventilation path 33 by controlling the adjustment unit 35.

For example, in the process of Step S1103 illustrated in FIG. 27, the control unit 60 controls the adjustment unit 35 to thereby adjust the flow rate ratio such that the air guided from the first ventilation path 31 and the fifth ventilation path 41 is guided to the third ventilation path 33. That is, the control unit 60 controls the adjustment unit 35 to thereby adjust the flow rate ratio between the total of flow rates of the air guided from the first ventilation path 31 and the fifth ventilation path 41 and the flow rate of the air guided from the second ventilation path 32 to 0%. In Step S1104, the control unit 60 controls the blower 34 to thereby adjust the output (for example, the number of rotations) of the blower 34 such that the flow rate of the air discharged from the first outlet 33a becomes the first discharge flow rate.

Further, in the process of Step S1106 illustrated in FIG. 27, the control unit 60 controls the adjustment unit 35 to thereby adjust the flow rate ratio such that the air guided from the first ventilation path 31, the second ventilation path 32, and the fifth ventilation path 41 is guided to the third ventilation path 33. That is, the control unit 60 controls the adjustment unit 35 to thereby adjust the flow rate ratio between the total of the flow rates of the air guided from the first ventilation path 31 and the fifth ventilation path 41 and the flow rate of the air guided from the second ventilation path 32 to the first ratio. Then, in Step S1107, the control unit 60 controls the blower 34 to thereby adjust the output (for example, the number of rotations) of the blower 34 such that the flow rate of the air discharged from the first outlet 33a becomes the second discharge flow rate.

Further, in the process of Step S1109 illustrated in FIG. 27, the control unit 60 controls the adjustment unit 35 to thereby adjust the flow rate ratio such that the air guided from the first ventilation path 31, the second ventilation path 32, and the fifth ventilation path 41 is guided to the third ventilation path 33. That is, the control unit 60 controls the adjustment unit 35 to thereby adjust the flow rate ratio between the total of the flow rates of the air guided from the first ventilation path 31 and the fifth ventilation path 41 and the flow rate of the air guided from the second ventilation path 32 to the second ratio. In Step S1110, the control unit 60 controls the blower 34 to thereby adjust the output (for example, the number of rotations) of the blower 34 such that the flow rate of the air discharged from the first outlet 33a becomes the third discharge flow rate.

For example, when the outside air temperature is high, when the solar radiation amount is large, or the like the temperature in the vehicle interior tends to be high, and the air generated by the vehicle air-conditioning apparatus 2b also tends to be high. In this case, air is sucked in from the first inlets 31a on the seat surface 11c side of the seat 1 and the third inlet 41a of the seat back 13 of the seat 1, and the sucked air is discharged from the first outlet 33a, so that the air can be blown to the occupant seated on the seat 1. As a result, since air can be sucked in from the first inlets 31a and the third inlet 41a, it is possible to suppress stuffiness due to sweating of the buttocks, thighs, waist, and back of the occupant seated on the seat 1. Further, it is possible to generate an airflow in the vicinity of the buttocks, thighs, waist, and back of the occupant and give the occupant a cooling sensation by heat of vaporization due to sweat. That is, it is possible to suppress stuffiness due to sweating not only in the buttocks and thighs of the occupant but also in a wider range, and it is possible to provide a cooling sensation by heat of vaporization due to sweat.

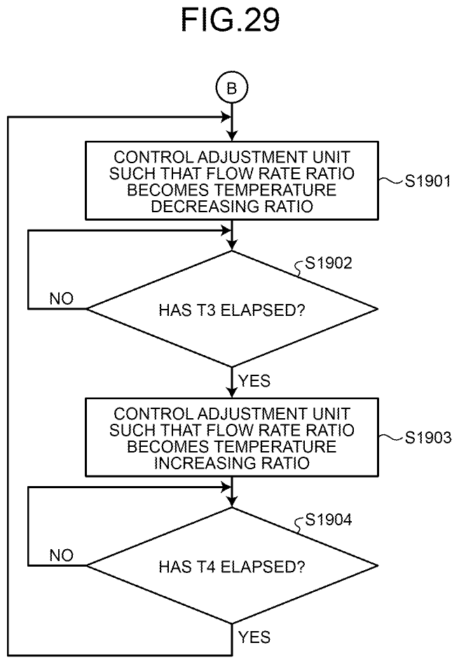

Further, in the process of Step S1901 illustrated in FIG. 29, the control unit 60 controls the adjustment unit 35 to thereby adjust the flow rate ratio such that the air guided from the first ventilation path 31 and the second ventilation path 32 is guided to the third ventilation path 33. That is, the control unit 60 controls the adjustment unit 35 to thereby adjust the flow rate ratio between the flow rate of the air guided from the first ventilation path 31 and the flow rate of the air guided from the second ventilation path 32 to the temperature decreasing ratio.

Further, in the process of Step S1903 illustrated in FIG. 29, the control unit 60 controls the adjustment unit 35 to thereby adjust the flow rate ratio such that the air guided from the first ventilation path 31 and the second ventilation path 32 is guided to the third ventilation path 33. That is, the control unit 60 controls the adjustment unit 35 to thereby adjust the flow rate ratio between the flow rate of the air guided from the first ventilation path 31 and the flow rate of the air guided from the second ventilation path 32 to the temperature increasing ratio.

For example, in a case where the processing illustrated in FIGS. 27 to 29 is executed when the outside air temperature is high, when the solar radiation amount is large, or the like, it is assumed that the air generated by the vehicle air-conditioning apparatus 2b is cooled and the temperature in the center console is also sufficiently lowered at the time of executing the processing illustrated in FIG. 29. In this case, the air cooled by the vehicle air-conditioning apparatus 2b is sucked in from the second inlet 32a and air is also sucked in from the first inlets 31a on the seat surface 11c side of the seat 1, and the air simultaneously sucked in from the first inlets 31a and the second inlet 32a is discharged from the first outlet 33a, so that the air can be blown to the occupant seated on the seat 1. As a result, since the air can be sucked in from the first inlets 31a, it is possible to suppress stuffiness due to sweating of the buttocks and the thighs of the occupant in contact with the seat surface 11c. Further, it is possible to generate an airflow in the vicinity of the buttocks and the thighs of the occupant and to impart a cooling sensation to the occupant by heat of vaporization due to sweating. That is, since the air is not sucked in from the third inlet 41a of the seat back 13 of the seat 1, it is possible to prevent the occupant from feeling discomfort due to excessive cooling of the waist and the back of the occupant.

Note that the fifth ventilation path 41 can correspond to a “third inlet ventilation path” in the claims.

As described above, the vehicle seat air-conditioning device 3H of the present modification includes the first ventilation path 31 through which air sucked in by the blower 34 passes from the first inlets 31a provided in a front surface of the bottom 11 that is a surface located to face the occupant seated on the seat 1, the second ventilation path 32 through which the air sucked in by the blower 34 passes from the second inlet 32a that is an inlet different from the first inlets 31a and is provided at a position other than the front surface of the seat 1 in the seat 1, the fifth ventilation path 41 through which the air sucked in by the blower 34 passes from the third inlet 41a that is an inlet different from the first inlets 31a and the second inlet 32a, and is provided in a front surface of the seat back 13 that is a surface located to face the occupant seated on the seat 1, and the adjustment unit 35 that adjusts a ratio of flow rates of air guided from the second ventilation path 32 to the third ventilation path 33 to a total flow rate of air guided from the first ventilation path 31 to the third ventilation path 33, air guided from the second ventilation path 32 to the third ventilation path 33, and air guided from the fifth ventilation path 41 to the third ventilation path 33. The control unit 60 adjusts the ratio by controlling the adjustment unit 35 on the basis of the temperature of the air generated by the vehicle air-conditioning apparatus 2b. When the temperature of the air generated by the vehicle air-conditioning apparatus 2b is equal to or higher than the first temperature, the control unit 60 adjusts the ratio such that the total of the flow rate of the air guided from the first ventilation path 31 to the third ventilation path 33 and the flow rate of the air guided from the fifth ventilation path 41 to the third ventilation path 33 is larger than the flow rate of the air guided from the second ventilation path 32 to the third ventilation path 33.

For example, when the outside air temperature is high, when the solar radiation amount is large, or the like, the air generated by the vehicle air-conditioning apparatus 2b becomes higher than the body temperature of the occupant immediately after an occupant gets in the vehicle, and the occupant may feel uncomfortable. By the vehicle seat air-conditioning device 3 of the present embodiment, when the temperature of the air generated by the vehicle air-conditioning apparatus 2b is equal to or higher than the first temperature, a total of the flow rate of the air sucked in from the first inlets 31a and guided from the first ventilation path 31 to the third ventilation path 33 and the flow rate of the air sucked in from the third inlet 41a and guided from the fifth ventilation path 41 to the third ventilation path 33 can be increased, and it is possible to suppress stuffiness due to sweating of the portion of the occupant in contact with the front surface of the seat 1 provided with the first inlets 31a and the third inlet 41a. Further, an airflow is generated near the portion of the occupant, and a cooling sensation can be given to the occupant by heat of vaporization due to sweat. That is, even in a period in which it is difficult for the occupant to obtain the cooling sensation due to the air generated by the vehicle air-conditioning apparatus 2b, such as immediately after the occupant gets in the vehicle, the occupant can obtain the cooling sensation at the portion of the occupant in contact with the front surface of the seat 1 where the first inlets 31a and the third inlet 41a are provided. That is, it is possible to suppress stuffiness due to sweating in a wider range including not only the portion of the occupant corresponding to the first inlets 31a but also the portion of the occupant corresponding to the third inlet 41a, and it is possible to provide a cooling sensation by heat of vaporization due to sweat. Thus, it is possible to provide a comfortable air-conditioning environment for the occupant.

Further, in the vehicle seat air-conditioning device 3H of the present modification, when the temperature of the air generated by the vehicle air-conditioning apparatus 2b is equal to or higher than the first temperature, the control unit 60 adjusts the ratio such that the air is guided from the first ventilation path 31 and the fifth ventilation path 41 to the third ventilation path 33.

Accordingly, only the air sucked in from the first inlets 31a and passing through the first ventilation path 31 and the air sucked in from the third inlet 41a and passing through the fifth ventilation path 41 can be guided to the third ventilation path 33, and more air can be sucked in from the first inlets 31a and the third inlet 41a. Thus, it is possible to further suppress stuffiness due to sweating of the portion of the occupant, and it is possible to impart a cooling sensation to the occupant by heat of vaporization due to sweat.

Further, in the vehicle seat air-conditioning device 3H of the present modification, when the temperature of the air generated by the vehicle air-conditioning apparatus 2b is equal to or higher than the second temperature that is lower than the first temperature and lower than the first temperature, the control unit 60 adjusts the ratio such that the air is guided from the first ventilation path 31, the second ventilation path 32, and the fifth ventilation path 41 to the third ventilation path 33 and the ratio increases as the temperature of the air generated by the vehicle air-conditioning apparatus 2b decreases.

Accordingly, the ratio of the air guided from the second ventilation path 32 to the third ventilation path 33 can be increased in accordance with the decrease in the temperature of the air generated by the vehicle air-conditioning apparatus 2b, and the surface temperature of the occupant can be more efficiently decreased.

In the vehicle seat air-conditioning device 3H of the present modification, when the degree of feeling cool by the occupant seated on the seat 1 indicated by the thermal sensation parameter is lower than a predetermined value, the control unit 60 adjusts the ratio at a predetermined timing set on the basis of the elapsed time or the temperature of the air discharged from the first outlet 33a.

Accordingly, the control unit 60 can change the temperature of the air discharged from the first outlet 33a at a predetermined timing. Thus, it is possible to suppress temperature habituation of the occupant due to blowing of air at a constant temperature, and to provide a comfortable air-conditioning environment for the occupant.

Further, in the vehicle seat air-conditioning device 3H of the present modification, when the temperature of the air generated by the vehicle air-conditioning apparatus 2b is equal to or higher than the second temperature, the control unit 60 adjusts the ratio such that the air is guided from at least the first ventilation path 31 and the fifth ventilation path 41 to the third ventilation path 33, and adjusts, when the degree of feeling cool by the occupant seated on the seat 1 indicated by the thermal sensation parameter is lower than the predetermined value, the ratio such that the air is guided from the first ventilation path 31 and the second ventilation path 32 to the third ventilation path 33.

Accordingly, when the temperature of the air generated by the vehicle air-conditioning apparatus 2b is equal to or higher than the second temperature, at least the air sucked in from the first inlets 31a and passing through the first ventilation path 31 and the air sucked in from the third inlet 41a and passing through the fifth ventilation path 41 can be guided to the third ventilation path 33, and the air can be sucked in from the first inlets 31a and the third inlet 41a. Thus, it is possible to suppress stuffiness due to sweating in a wider range including not only the portion of the occupant corresponding to the first inlets 31a but also the portion of the occupant corresponding to the third inlet 41a, and it is possible to provide a cooling sensation by heat of vaporization due to sweat. Further, when the degree of feeling cool by the occupant seated on the seat 1 indicated by the thermal sensation parameter is lower than the predetermined value, the air sucked in from the first inlets 31a and passing through the first ventilation path 31 and the air sucked in from the second inlet 32a and passing through the second ventilation path 32 can be guided to the third ventilation path 33. Thus, since air is not sucked in from the third inlet 41a, it is possible to prevent the occupant from feeling discomfort due to excessive cooling of the portion of the occupant corresponding to the third inlet 41a.

Further, in the vehicle seat air-conditioning device 3H of the present modification, the control unit 60 adjusts the ratio such that the air is guided from the first ventilation path 31 and the fifth ventilation path 41 to the third ventilation path 33 when the temperature of the air generated by the vehicle air-conditioning apparatus 2b is equal to or higher than the first temperature, and adjusts the ratio such that the air is guided from the first ventilation path 31, the second ventilation path 32, and the fifth ventilation path 41 to the third ventilation path 33 when the temperature of the air generated by the vehicle air-conditioning apparatus 2b is lower than the first temperature and equal to or higher than the second temperature.

Accordingly, when the temperature of the air generated by the vehicle air-conditioning apparatus 2b is equal to or higher than the first temperature, only the air sucked in from the first inlets 31a and passing through the first ventilation path 31 and the air sucked in from the third inlet 41a and passing through the fifth ventilation path 41 can be guided to the third ventilation path 33, and more air can be sucked in from the first inlets 31a and the third inlet 41a. Thus, it is possible to further suppress stuffiness due to sweating of the portion of the occupant, and it is possible to impart a cooling sensation to the occupant by heat of vaporization due to sweat. Further, when the temperature of the air generated by the vehicle air-conditioning apparatus 2b is lower than the first temperature and equal to or higher than the second temperature, that is, when the air generated by the vehicle air-conditioning apparatus 2b starts to cool, the air generated by the vehicle air-conditioning apparatus 2b and passing through the second ventilation path 32 can be guided to the third ventilation path 33, and the surface temperature of the occupant can be more efficiently lowered.

### Other Modifications and the Like

Although the present disclosure has been described on the basis of the first to fourth embodiments, the present disclosure is not limited to the first to fourth embodiments.

For example, in the vehicle seat air-conditioning device according to each of the above-described first to fourth embodiments, the first inlets 31a may be formed in the seat back 13. In this case, when the first inlets 31a are disposed at positions not covered with the back or the like of the occupant, such as an outer edge of the second seat pad 13a to the Y-axis plus direction and the Y-axis minus direction with respect to the central portion of the seat back 13, the effect described in the first embodiment can be easily obtained.

Further, in the vehicle seat air-conditioning device according to each of the above-described first to fourth embodiments, the second inlet 32a may not be connected to the vehicle air-conditioning apparatus 2b, may be configured to open toward the vehicle interior similarly to the first inlets 31a, or the second inlet 32a may not be formed in the seat 1. The vehicle seat air-conditioning device may include a Peltier module that cools or heats the air flowing through the ventilation path, and the air cooled by the Peltier module may be discharged from the first outlet 33a.

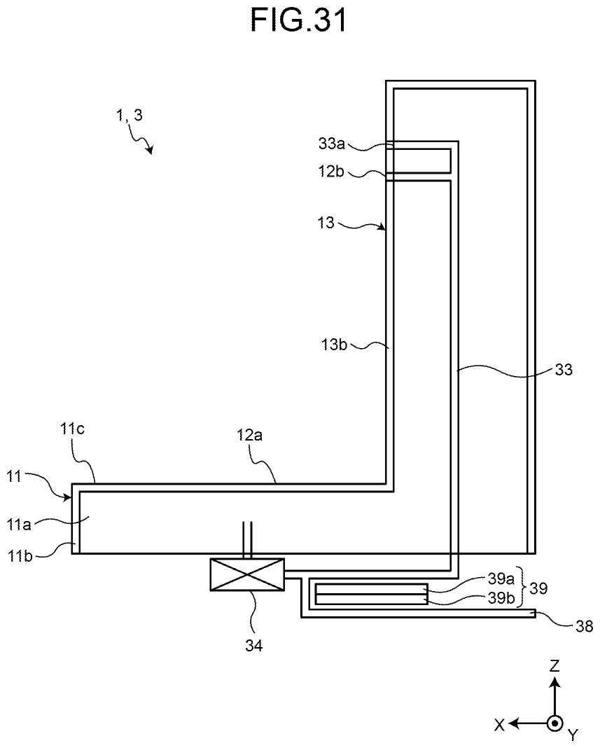

Specifically, as illustrated in FIG. 31, the air guided by the blower 34 flows to both the third ventilation path 33 and an air discharge path 38. For example, the control unit 60 applies a voltage to the Peltier module 39 so that a use heat surface 39a of the Peltier module 39 functions as a cooling surface. The air flowing to the third ventilation path 33 is cooled by the use heat surface 39a of the Peltier module 39, and the cooled air is discharged from the first outlet 33a. On the other hand, the air flowing to the air discharge path 38 is heated by a heat discharging surface 39b of Peltier module 39, and the heated air is discharged to the outside of the vehicle or the like from the air outlet 38a. In FIG. 31, the configuration upstream of the blower 34 is omitted. Further, FIG. 31 illustrates the configuration in which the Peltier module 39 is provided in the third ventilation path 33, but it is not limited to this configuration, and for example, the Peltier module 39 may be provided in the second ventilation path 32. The Peltier module 39 is an example of a “temperature adjustment unit” in the claims.

Further, each processing unit included in the vehicle seat air-conditioning device according to each of the above-described first to fourth embodiments is typically implemented as an LSI that is an integrated circuit. These may be individually integrated into one chip, or may be integrated into one chip so as to include a part or all of them.

Further, the circuit integration is not limited to LSI, and may be achieved by a dedicated circuit or a general-purpose processor. A field programmable gate array (FPGA) that can be programmed after manufacturing of the LSI or a reconfigurable processor in which connections and settings of circuit cells inside the LSI can be reconfigured may be used.

Note that, in each of the above embodiments, each component may be constituted by dedicated hardware or may be implemented by executing a software program suitable for each component. Each component may be implemented by a program execution unit such as a CPU or a processor reading and executing a software program recorded in a recording medium such as a hard disk or a semiconductor memory.

Further, the numbers used above are all exemplified to specifically describe the present disclosure, and the first to fourth embodiments of the present disclosure is not limited to the exemplified numbers.

Furthermore, the division of the functional blocks in the block diagram is an example, and a plurality of functional blocks may be achieved as one functional block, one functional block may be divided into a plurality of functional blocks, or some functions may be transferred to another functional block. In addition, functions of a plurality of functional blocks having similar functions may be processed in parallel or in a time division manner by single hardware or software.

Furthermore, the order in which each step in the flowchart is executed is exemplified to specifically describe the present disclosure, and may be an order other than the above. In addition, some of the above steps may be executed simultaneously (in parallel) with other steps.

The present disclosure also includes a mode obtained by making various modifications conceivable by those skilled in the art to the first to fourth embodiments, and a mode achieved by arbitrarily combining the components and functions of the first to fourth embodiments without departing from the gist of the present disclosure.

### Supplement

As is apparent from the above embodiments, the present disclosure includes the following aspects. In the following, reference numerals are given in parentheses only to clearly indicate the correspondence with the embodiment.

A vehicle seat air-conditioning device (3, 3A, 3B, 3G, and 3H) according to a first aspect is disposed in a vehicle and used in a seat (1) including a seat back (13) and a bottom (11). The vehicle seat air-conditioning device (3, 3A, 3B, 3G, and 3H) includes a blower (34), a first ventilation path (31), a second ventilation path (32), a third ventilation path (33), an adjustment unit (35), and a control unit (60). The blower (34) is incorporated in the seat (1). The air sucked in by the blower (34) passes through the first ventilation path (31) from a first inlet (31a) provided in a front surface of the seat (1) which is a surface located to face the person seated on the seat (1). The second ventilation path (32) is an inlet different from the first inlet (31a), and air sucked in by the blower (34) passes through a second inlet (32a) provided at a position other than the front surface of the seat (1) in the seat (1). The third ventilation path (33) guides air guided from at least one of the first ventilation path (31) or the second ventilation path (32) to a first outlet (33a) provided in a front surface of the seat back (13) which is a surface located to face the person seated on the seat (1). The adjustment unit (35) adjusts a ratio of a flow rate of air guided from the second ventilation path (32) to the third ventilation path (33) to a total flow rate of air guided from the first ventilation path (31) to the third ventilation path (33) and air guided from the second ventilation path (32) to the third ventilation path (33). The control unit (60) controls the blower (34) and the adjustment unit (35). The control unit (60) adjusts the ratio by controlling the adjustment unit (35) on the basis of the temperature of air whose temperature has been adjusted by the temperature adjustment unit. When the temperature of the air whose temperature has been adjusted by the temperature adjustment unit is equal to or higher than a first temperature, the control unit (60) adjusts the ratio such that the flow rate of the air guided from the first ventilation path (31) to the third ventilation path (33) is larger than the flow rate of the air guided from the second ventilation path (32) to the third ventilation path (33).

A vehicle seat air-conditioning device (3, 3A, 3B, 3G, and 3H) according to a second aspect can be implemented in combination with the first aspect. In the second aspect, when the temperature of the air whose temperature has been adjusted by the temperature adjustment unit is equal to or higher than the first temperature, the control unit (60) adjusts the ratio such that the ratio becomes 0%.

A vehicle seat air-conditioning device (3, 3A, 3B, 3G, and 3H) according to a third aspect can be implemented in combination with the second aspect. In the third aspect, when the temperature of the air whose temperature has been adjusted by the temperature adjustment unit is lower than the first temperature, the control unit (60) adjusts the ratio such that the ratio increases in accordance with a decrease in the temperature of the air whose temperature has been adjusted by the temperature adjustment unit.

A vehicle seat air-conditioning device (3, 3A, 3B, 3G, and 3H) according to a fourth aspect can be implemented in combination with the third aspect. In the fourth aspect, when the temperature of the air whose temperature has been adjusted by the temperature adjustment unit is lower than the second temperature lower than the first temperature, the control unit (60) adjusts the ratio such that the ratio becomes 100%.

A vehicle seat air-conditioning device (3, 3A, 3B, 3G, and 3H) according to a fifth aspect can be implemented in combination with any one of the second to fourth aspects. In the fifth aspect, when the temperature of the air whose temperature has been adjusted by the temperature adjustment unit is lower than the first temperature, the control unit (60) controls the blower (34) such that the flow rate of air discharged from the first outlet (33a) increases in accordance with a decrease in the temperature of the air whose temperature has been adjusted by the temperature adjustment unit.

A vehicle seat air-conditioning device (3, 3A, 3B, 3G, and 3H) according to a sixth aspect can be implemented in combination with the fifth aspect. In the sixth aspect, the control unit (60) controls the blower (34) such that a flow rate of air sucked in from the first inlet (31a) is constant.

A vehicle seat air-conditioning device (3, 3A, 3B, 3G, and 3H) according to a seventh aspect can be implemented in combination with any one of the first to sixth aspects. In the seventh aspect, the first inlet (31a) is provided in a front surface (11c) of the bottom (11).

A vehicle seat air-conditioning device (3A, 3G, and 3H) according to an eighth aspect can be implemented in combination with any one of the first to seventh aspects. In the eighth aspect, the vehicle seat air-conditioning device (3A, 3G, and 3H) further includes a fourth ventilation path (36) that guides air guided from at least one of the first ventilation path (31) or the second ventilation path (32) to a second outlet (36a) that is a outlet different from the first outlet (33a) and is provided at a position other than the front surface of the seat (1) in the seat (1). When the temperature of the air whose temperature has been adjusted by the temperature adjustment unit is equal to or higher than the first temperature, the control unit (60) performs control to discharge the air guided from at least one of the first ventilation path (31) or the second ventilation path (32) from the second outlet (36a).

A vehicle seat air-conditioning device (3B, 3G, and 3H) according to a ninth aspect can be implemented in combination with any one of the first to eighth aspects. In the ninth aspect, the first outlet (33a) is provided with an airflow direction changing member (120). When the temperature of the air whose temperature has been adjusted by the temperature adjustment unit is equal to or higher than the first temperature, the control unit (60) controls the airflow direction changing member (120) such that air discharged from the first outlet (33a) does not flow toward the person seated on the seat (1).

A vehicle seat air-conditioning device (3C, 3D, 3G, and 3H) according to a 10th aspect is disposed in a vehicle and used in the seat (1) including the seat back (13) and the bottom (11). A vehicle seat air-conditioning device (3C, 3D, 3G, and 3H) includes the blower (34), the outlet ventilation path (33), and the control unit (60). The blower (34) is incorporated in the seat (1) and guides air generated by a vehicle air-conditioning apparatus (2b) mounted on the vehicle. The outlet ventilation path (33) guides air guided from the blower (34) to the first outlet (33a) provided in a front surface of the seat back (13) which is a surface located to face the person seated on the seat (1). The control unit (60) controls the blower (34). The control unit (60) controls at least one of an air volume or a temperature of air generated by the vehicle air-conditioning apparatus (2b) on the basis of a thermal sensation parameter determined from an environmental parameter including a detection result of information regarding a temperature of air discharged from the first outlet (33a).

A vehicle seat air-conditioning device (3C, 3D, 3G, and 3H) according to an 11th aspect can be implemented in combination with the 10th aspect. In the 11th aspect, the environmental parameter further includes a detection result of at least one of an outside air temperature, a vehicle interior temperature, a solar radiation amount, or a solar radiation angle.

A vehicle seat air-conditioning device (3C, 3D, 3G, and 3H) according to a 12th aspect can be implemented in combination with the 10th or 11th aspect. In the 12th aspect, the control unit (60) decreases an air volume of the air generated by the vehicle air-conditioning apparatus (2b) as a degree of feeling cool by the person seated on the seat (1), which is indicated by the thermal sensation parameter, is higher.

A vehicle seat air-conditioning device (3C, 3D, 3G, and 3H) according to a 13th aspect can be implemented in combination with any one of the 10th to 12th aspects. In the 13th aspect, the control unit (60) increases the temperature of the air generated by the vehicle air-conditioning apparatus (2b) as the degree of feeling cool by the person seated on the seat (1) indicated by the thermal sensation parameter is higher.

A vehicle seat air-conditioning device (3D, 3G, and 3H) according to a 14th aspect can be implemented in combination with any one of the 10th to 13th aspects. In the 14th aspect, the vehicle seat air-conditioning device (3D, 3G, and 3H) further includes a first inlet ventilation path (31) through which air sucked in by the blower (34) passes from the first inlet (31a) provided in the front surface (11c) of the bottom (11) that is a surface located to face the person seated on the seat (1). The control unit (60) controls at least one of an air volume or a temperature of air generated by the vehicle air-conditioning apparatus (2b) on the basis of a temperature of air sucked in from the first inlet (31a) and a temperature in a vehicle interior of the vehicle.

A vehicle seat air-conditioning device (3D, 3G, and 3H) according to a 15th aspect can be implemented in combination with the 14th aspect. In the 15th aspect, when the temperature of the air sucked in from the first inlet (31a) is equal to or higher than the temperature in the vehicle interior of the vehicle, the control unit (60) executes at least one of control for reducing the air volume of the air generated by the vehicle air-conditioning apparatus (2b) or control for increasing the temperature of the air generated by the vehicle air-conditioning apparatus (2b).

A vehicle seat air-conditioning device (3D, 3G, and 3H) according to a 16th aspect can be implemented in combination with the 14th or 15th aspect. In the 16th aspect, a vehicle seat air-conditioning device (3D, 3G, and 3H) includes a second inlet ventilation path (32) and an adjustment unit (35). The second inlet ventilation path (32) is an inlet different from the first inlet (31a), and air sucked in by the blower (34) passes through the second inlet (32a) provided at a position other than the front surface of the seat (1) in the seat (1). The adjustment unit (35) selects at least one of the first inlet ventilation path (31) and the second inlet ventilation path (32). The adjustment unit (35) has a cooling mode in which the second inlet ventilation path (32) is connected to the outlet ventilation path (33) in order to guide air to the outlet ventilation path (33), and a mix mode in which the first inlet ventilation path (31) and the second inlet ventilation path (32) are connected to the outlet ventilation path (33). The control unit (60) switches the mode of the adjustment unit (35) by selecting either the cooling mode or the mix mode.

A vehicle seat air-conditioning device (3D, 3G, and 3H) according to a 17th aspect can be implemented in combination with the 16th aspect. In the 17th aspect, the control unit (60) switches the mode of the adjustment unit (35) such that the mix mode is selected when a first time elapses after the cooling mode is selected, and the cooling mode is selected when a second time shorter than the first time elapses after the cooling mode is selected. The control unit (60) acquires the temperature of the air sucked in from the first inlet (31a) detected during the second time.

A vehicle seat air-conditioning device (3E, 3F, 3G, and 3H) according to a 18th aspect is disposed in a vehicle and used in the seat (1) including the seat back (13) and the bottom (11). A vehicle seat air-conditioning device (3E, 3F, 3G, and 3H) includes the blower (34), the first ventilation path (31), the second ventilation path (32), the third ventilation path (33), the adjustment unit (35), and a control unit (60). The blower (34) is incorporated in the seat (1). The air sucked in by the blower (34) passes through the first ventilation path (31) from the first inlet (31a) provided in a front surface of the seat (1) which is a surface located to face the person seated on the seat (1). The second ventilation path (32) is an inlet different from the first inlet (31a), and air sucked in by the blower (34) passes through a second inlet (32a) provided at a position other than the front surface of the seat (1) in the seat (1). The third ventilation path (33) guides air guided from at least one of the first ventilation path (31) or the second ventilation path (32) to the first outlet (33a) provided in a front surface of the seat back (13) which is a surface located to face the person seated on the seat (1). The adjustment unit (35) adjusts a ratio of a flow rate of air guided from the second ventilation path (32) to the third ventilation path (33) to a total flow rate of air guided from the first ventilation path (31) to the third ventilation path (33) and air guided from the second ventilation path (32) to the third ventilation path (33). The control unit (60) controls the blower (34) and the adjustment unit (35). The control unit (60) adjusts the ratio at a predetermined timing set on the basis of an elapsed time or a temperature of the air discharged from the first outlet (33a).

A vehicle seat air-conditioning device (3E, 3F, 3G, and 3H) according to a 19th aspect can be implemented in combination with the 18th aspect. In the 19th aspect, when a first predetermined time elapses after executing control for adjusting the ratio to a temperature decreasing ratio at which the flow rate of the air guided from the second ventilation path (32) to the third ventilation path (33) is larger than the flow rate of the air guided from the first ventilation path (31) to the third ventilation path (33), the control unit (60) executes control for adjusting the ratio to a temperature increasing ratio at which the flow rate of the air guided from the first ventilation path (31) to the third ventilation path (33) is larger than the flow rate of the air guided from the second ventilation path (32) to the third ventilation path (33), and executes, when a second predetermined time elapses after executing the control for adjusting the ratio to the temperature increasing ratio, control to adjust the ratio to the temperature decreasing ratio.

A vehicle seat air-conditioning device (3E, 3F, 3G, and 3H) according to a 20th aspect can be implemented in combination with the 18th aspect. In the 20th aspect, when the temperature of the air discharged from the first outlet (33a) reaches a first predetermined temperature after executing control for adjusting the ratio to a temperature decreasing ratio at which the flow rate of the air guided from the second ventilation path (32) to the third ventilation path (33) is larger than the flow rate of the air guided from the first ventilation path (31) to the third ventilation path (33), the control unit (60) executes control for adjusting the ratio to a temperature increasing ratio at which the flow rate of the air guided from the first ventilation path (31) to the third ventilation path (33) is larger than the flow rate of the air guided from the second ventilation path (32) to the third ventilation path (33), and executes, when the temperature of the air discharged from the first outlet (33a) reaches a second predetermined temperature higher than the first predetermined temperature after the control for adjusting the ratio to the temperature increasing ratio is executed, the control for adjusting the ratio to the temperature decreasing ratio.

A vehicle seat air-conditioning device (3E, 3F, 3G, and 3H) according to a 21st aspect can be implemented in combination with the 19th or 20th aspect. In the 21st aspect, the control unit (60) connects the second ventilation path (32) to the third ventilation path (33) when adjusting the ratio to the temperature decreasing ratio, and connects the first ventilation path (31) and the second ventilation path (32) to the third ventilation path (33) when adjusting the ratio to the temperature increasing ratio.

A vehicle seat air-conditioning device (3E, 3F, 3G, and 3H) according to a 22nd aspect can be implemented in combination with the 19th or 20th aspect. In the 22nd aspect, the control unit (60) connects the first ventilation path (31) and the second ventilation path (32) to the third ventilation path (33) when adjusting the ratio to the temperature decreasing ratio, and connects the first ventilation path (31) to the third ventilation path (33) when adjusting the ratio to the temperature increasing ratio.

A vehicle seat air-conditioning device (3E, 3F, 3G, and 3H) according to a 23rd aspect can be implemented in combination with the 19th or 20th aspect. In the 23rd aspect, the control unit (60) connects the second ventilation path (32) to the third ventilation path (33) when adjusting the ratio to the temperature decreasing ratio, and connects the first ventilation path (31) to the third ventilation path (33) when adjusting the ratio to the temperature increasing ratio.

A vehicle seat air-conditioning device (3F, 3G, and 3H) according to a 24th aspect can be implemented in combination with any one of the 18th to 23rd aspects. In the 24th aspect, the control unit (60) controls the blower (34) to adjust a flow rate of the air discharged from the first outlet (33a) at a predetermined timing.

A vehicle seat air-conditioning device (3F, 3G, and 3H) according to a 25th aspect can be implemented in combination with the 24th aspect. In the 25th aspect, the control unit (60) controls the blower (34) so as to decrease the flow rate of the air discharged from the first outlet (33a) when the ratio is adjusted to the temperature decreasing ratio, and to increase the flow rate of the air discharged from the first outlet (33a) when the ratio is adjusted to the temperature increasing ratio.

A vehicle seat air-conditioning device (3F, 3G, and 3H) according to a 26th aspect can be implemented in combination with the 25th aspect. In the 26th aspect, the control unit (60) makes a period from the execution of control for adjusting the ratio to the temperature increasing ratio to the execution of control for adjusting the ratio to the temperature decreasing ratio equal to a period from the execution of control for adjusting the ratio to the temperature decreasing ratio to the execution of control for adjusting the ratio to the temperature increasing ratio.

A vehicle seat air-conditioning device (3F, 3G, and 3H) according to a 27th aspect can be implemented in combination with the 25th or 26th aspect. In the 27th aspect, the control unit (60) controls the blower (34) so as to decrease the flow rate of the air discharged from the first outlet (33a) to a first air volume and maintain the first air volume when the ratio is adjusted to the temperature decreasing ratio, and controls the blower (34) so as to increase the flow rate of the air discharged from the first outlet (33a) to a second air volume larger than the first air volume and maintain the second air volume when the ratio is adjusted to the temperature increasing ratio.

A vehicle seat air-conditioning device (3F, 3G, and 3H) according to a 28th aspect can be implemented in combination with the 24th aspect. In the 28th aspect, the control unit (60) controls the blower (34) so as to increase the flow rate of the air discharged from the first outlet (33a) when the ratio is adjusted to the temperature decreasing ratio, and to decrease the flow rate of the air discharged from the first outlet (33a) when the ratio is adjusted to the temperature increasing ratio.

A vehicle seat air-conditioning device (3F, 3G, and 3H) according to a 29th aspect can be implemented in combination with the 28th aspect. In the 29th aspect, the control unit (60) makes a period from the execution of control for adjusting the ratio to the temperature increasing ratio to the execution of control for adjusting the ratio to the temperature decreasing ratio longer than a period from the execution of control for adjusting the ratio to the temperature decreasing ratio to the execution of control for adjusting the ratio to the temperature increasing ratio.

A vehicle seat air-conditioning device (3F, 3G, and 3H) according to a 30th aspect can be implemented in combination with the 28th or 29th aspect. In the 30th aspect, the control unit (60) controls the blower (34) so as to decrease the flow rate of the air discharged from the first outlet (33a) to a first air volume and maintain the first air volume when the ratio is adjusted to the temperature increasing ratio, and controls the blower (34) so as to increase the flow rate of the air discharged from the first outlet (33a) to a second air volume larger than the first air volume and maintain the second air volume when the ratio is adjusted to the temperature decreasing ratio.

A vehicle seat air-conditioning device (3E, 3F, 3G, and 3H) according to a 31th aspect can be implemented in combination with any one of the 18th to 30th aspects. In the 31st aspect, the first inlet (31a) is provided in the front surface (11c) of the bottom (11).

A vehicle seat air-conditioning device (3H) according to a 32nd aspect can be implemented in combination with any one of the 10th to 17th aspects. In the 32nd aspect, when the temperature of the air generated by the vehicle air-conditioning apparatus (2b) is lower than the switching temperature, the control unit (60) controls at least one of the air volume or the temperature of the air generated by the vehicle air-conditioning apparatus (2b) on the basis of the thermal sensation parameter. When the temperature of the air generated by the vehicle air-conditioning apparatus (2b) is equal to or higher than the switching temperature, the control unit (60) does not execute control of at least one the air volume or the temperature of the air generated by the vehicle air-conditioning apparatus (2b) based on the thermal sensation parameter.

A vehicle seat air-conditioning device (3H) according to a 33rd aspect can be implemented in combination with the 32nd aspect. In the 33rd aspect, the first inlet ventilation path (31), the second inlet ventilation path (32), a third inlet ventilation path (41), and the adjustment unit (35) are further included. The air sucked in by the blower (34) passes through the first inlet ventilation path (31) from the first inlet (31a) provided in the front surface (11c) of the bottom (11) which is a surface located to face the person seated on the seat (1). The second inlet ventilation path (32) is an inlet different from the first inlet (31a), and air sucked in by the blower (34) passes through the second inlet (32a) provided at a position other than the front surface of the seat (1) in the seat (1). The third inlet ventilation path (41) is an inlet different from the first inlet (31a) and the second inlet (32a), and air sucked in by the blower (34) passes through the third inlet (41a) provided in the front surface of the seat back (13) which is a surface located to face the person seated on the seat (1). The adjustment unit (35) adjusts a ratio of a flow rate of the air guided from the second inlet ventilation path (32) to the outlet ventilation path (33) to a total flow rate of air guided from the first inlet ventilation path (31) to the outlet ventilation path (33), air guided from the second inlet ventilation path (32) to the outlet ventilation path (33), and air guided from the third inlet ventilation path (41) to the outlet ventilation path (33). The control unit (60) adjusts the ratio by controlling the adjustment unit (35) on the basis of the temperature of the air generated by the vehicle air-conditioning apparatus (2b). When the temperature of the air generated by the vehicle air-conditioning apparatus (2b) is equal to or higher than the first temperature, the control unit (60) adjusts the ratio such that the total of the flow rate of the air guided from the first inlet ventilation path (31) to the outlet ventilation path (33) and the flow rate of the air guided from the third inlet ventilation path (41) to the outlet ventilation path (33) is larger than the flow rate of the air guided from the second inlet ventilation path (32) to the outlet ventilation path (33).

A vehicle seat air-conditioning device (3H) according to a 34th aspect can be implemented in combination with the 33rd aspect. In the 34th aspect, when the temperature of the air generated by the vehicle air-conditioning apparatus (2b) is equal to or higher than the first temperature, the control unit (60) adjusts the ratio such that the air is guided from the first inlet ventilation path (31) and the third inlet ventilation path (41) to the outlet ventilation path (33).

A vehicle seat air-conditioning device (3H) according to a 35th aspect can be implemented in combination with the 33rd or 34th aspect. In the 35th aspect, when the temperature of the air generated by the vehicle air-conditioning apparatus (2b) is lower than the first temperature and equal to or higher than the second temperature that is lower than the first temperature, the control unit (60) adjusts the ratio such that the air is guided from the first inlet ventilation path (31), the second inlet ventilation path (32), and the third inlet ventilation path (41) to the outlet ventilation path (33), and the ratio increases as the temperature of the air generated by the vehicle air-conditioning apparatus (2b) decreases.

A vehicle seat air-conditioning device (3H) according to a 36th aspect can be implemented in combination with any one of the 33rd to 35th aspects. In the 36th aspect, when the degree of feeling cool by the person seated on the seat (1) indicated by the thermal sensation parameter is lower than a predetermined value, the control unit (60) adjusts the ratio at a predetermined timing set on the basis of an elapsed time or a temperature of the air discharged from the first outlet (33a).

A vehicle seat air-conditioning device (3H) according to a 37th aspect can be implemented in combination with the 36th aspect. In the 37th aspect, when the temperature of the air generated by the vehicle air-conditioning apparatus (2b) is equal to or higher than the second temperature that is lower than the first temperature, the control unit (60) adjusts the ratio such that the air is guided from at least the first inlet ventilation path (31) and the third inlet ventilation path (41) to the outlet ventilation path (33). When the degree of feeling cool by the person seated on the seat (1) indicated by the thermal sensation parameter is lower than the predetermined value, the control unit (60) adjusts the ratio such that air is guided from the first inlet ventilation path (31) and the second inlet ventilation path (32) to the outlet ventilation path (33).

A vehicle seat air-conditioning device (3H) according to a 38th aspect can be implemented in combination with the 37th aspect. In the 38th aspect, when the temperature of the air generated by the vehicle air-conditioning apparatus (2b) is equal to or higher than the first temperature, the control unit (60) adjusts the ratio such that the air is guided from the first inlet ventilation path (31) and the third inlet ventilation path (41) to the outlet ventilation path (33). When the temperature of the air generated by the vehicle air-conditioning apparatus (2b) is lower than the first temperature and equal to or higher than the second temperature, the control unit (60) adjusts the ratio such that the air is guided from the first inlet ventilation path (31), the second inlet ventilation path (32), and the third inlet ventilation path (41) to the outlet ventilation path (33).

Note that the vehicle seat air-conditioning device (3G, 3H) according to any one of the first to ninth aspects may be implemented in combination with any one of the 10th to 38th aspects. Further, the vehicle seat air-conditioning device (3G, 3H) according to any one of the 10th to 17th and 32nd to 38th aspects may be implemented in combination with any one of the first to ninth and 18th to 31st aspects. Further, the vehicle seat air-conditioning device (3G, 3H) according to any one of the 18th to 31st aspects may be implemented in combination with any one of the first to 17th and 32nd to 38th aspects.

A vehicle seat air-conditioning device according to the present disclosure can provide a more comfortable air-conditioning environment for an occupant seated on a seat.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle seat air-conditioning device disposed in a vehicle and used for a seat having a seat back and a bottom, the vehicle seat air-conditioning device comprising:
a blower that is incorporated in the seat and guides air generated by a vehicle air-conditioning apparatus mounted on the vehicle;
an outlet ventilation path that guides air guided from the blower to a first outlet provided in a front surface of the seat back that is a surface located to face a person seated on the seat;
a memory; and
a processor coupled to the memory and configured to control the blower when executing the program, wherein
the processor is configured to control at least one of an air volume or a temperature of the air generated by the vehicle air-conditioning apparatus, based on a thermal sensation parameter determined from an environmental parameter including a detection result of information regarding a temperature of air discharged from the first outlet.

2. The vehicle seat air-conditioning device according to claim 1, wherein
the environmental parameter further includes a detection result of at least one of an outside air temperature, a vehicle interior temperature, a solar radiation amount, or a solar radiation angle.

3. The vehicle seat air-conditioning device according to claim 1, wherein
the processor is configured to decrease the air volume of the air generated by the vehicle air-conditioning apparatus as a degree of feeling cool by the person seated on the seat indicated by the thermal sensation parameter is higher.

4. The vehicle seat air-conditioning device according to claim 1, wherein
the processor is configured to increase the temperature of the air generated by the vehicle air-conditioning apparatus as a degree of feeling cool by the person seated on the seat indicated by the thermal sensation parameter is higher.

5. The vehicle seat air-conditioning device according to claim 1, further comprising:
a first inlet ventilation path through which air sucked in by the blower passes from a first inlet provided in a front surface of the bottom that is a surface located to face the person seated on the seat, wherein
the processor is configured to control at least one of the air volume or the temperature of the air generated by the vehicle air-conditioning apparatus, based on a temperature of air sucked in from the first inlet and a temperature in a vehicle interior of the vehicle.

6. The vehicle seat air-conditioning device according to claim 5, wherein
the processor is configured to execute at least one of control for reducing the air volume of the air generated by the vehicle air-conditioning apparatus or control for increasing the temperature of the air generated by the vehicle air-conditioning apparatus, when the temperature of the air sucked in from the first inlet is equal to or higher than the temperature in the vehicle interior of the vehicle.

7. The vehicle seat air-conditioning device according to claim 5, further comprising:
a second inlet ventilation path through which air sucked in by the blower passes from a second inlet that is an inlet different from the first inlet and is provided at a position other than the front surface of the seat in the seat; and
an adjuster that selects at least one of the first inlet ventilation path and the second inlet ventilation path, wherein
the adjuster has a cooling mode in which the second inlet ventilation path is connected to the outlet ventilation path, and a mix mode in which the first inlet ventilation path and the second inlet ventilation path are connected to the outlet ventilation path, to guide air to the outlet ventilation path, and
the processor is configured to switch a mode of the adjuster by selecting one of the cooling mode and the mix mode.

8. The vehicle seat air-conditioning device according to claim 7, wherein
the processor is configured to switch the mode of the adjuster in such a manner as to select the mix mode when a first time elapses after selecting the cooling mode, and to select the cooling mode when a second time shorter than the first time elapses after selecting the mix mode, and
the processor is configured to acquire a temperature of air sucked in from the first inlet detected during the second time.

9. The vehicle seat air-conditioning device according to claim 1, wherein
the processor is configured to:
control at least one of the air volume and the temperature of the air generated by the vehicle air-conditioning apparatus, based on the thermal sensation parameter, when the temperature of the air generated by the vehicle air-conditioning apparatus is lower than a switching temperature; and
not execute control of at least one of the air volume and the temperature of the air generated by the vehicle air-conditioning apparatus, based on the thermal sensation parameter, when the temperature of the air generated by the vehicle air-conditioning apparatus is equal to or higher than the switching temperature.

10. The vehicle seat air-conditioning device according to claim 9, further comprising:
a first inlet ventilation path through which air sucked in by the blower passes from a first inlet provided in a front surface of the bottom that is a surface located to face the person seated on the seat;
a second inlet ventilation path through which air sucked in by the blower passes from a second inlet that is an inlet different from the first inlet and is provided at a position other than the front surface of the seat in the seat; and
an adjuster that adjusts a ratio of a flow rate of air guided from the second inlet ventilation path to the outlet ventilation path, to a total flow rate of air guided from the first inlet ventilation path to the outlet ventilation path and the air guided from the second inlet ventilation path to the outlet ventilation path, wherein
the processor is configured to adjust the ratio by controlling the adjuster based on the temperature of the air generated by the vehicle air-conditioning apparatus, and
the processor is configured to adjust the ratio in such a manner that a flow rate of the air guided from the first inlet ventilation path to the outlet ventilation path is larger than a flow rate of the air guided from the second inlet ventilation path to the outlet ventilation path, when the temperature of the air generated by the vehicle air-conditioning apparatus is equal to or higher than a first temperature.

11. The vehicle seat air-conditioning device according to claim 10, wherein
the processor is configured to adjust the ratio in such a manner that the ratio becomes 0%, when the temperature of the air generated by the vehicle air-conditioning apparatus is equal to or higher than the first temperature.

12. The vehicle seat air-conditioning device according to claim 11, wherein
the processor is configured to adjust the ratio in such a manner that the ratio increases in accordance with a decrease in the temperature of the air generated by the vehicle air-conditioning apparatus, when the temperature of the air generated by the vehicle air-conditioning apparatus is lower than the first temperature.

13. The vehicle seat air-conditioning device according to claim 12, wherein
the processor is configured to adjust the ratio in such a manner that the ratio becomes 100%, when the temperature of the air generated by the vehicle air-conditioning apparatus is lower than a second temperature lower than the first temperature.

14. The vehicle seat air-conditioning device according to claim 9, further comprising:
a first inlet ventilation path through which air sucked in by the blower passes from a first inlet provided in a front surface of the bottom that is a surface located to face the person seated on the seat;
a second inlet ventilation path through which air sucked in by the blower passes from a second inlet that is an inlet different from the first inlet and is provided at a position other than the front surface of the seat in the seat;
a third inlet ventilation path through which air sucked in by the blower passes from a third inlet that is an inlet different from the first inlet and the second inlet, and is provided in a front surface of the seat back that is a surface located to face the person seated on the seat; and
an adjuster that adjusts a ratio of a flow rate of air guided from the second inlet ventilation path to the outlet ventilation path, to a total flow rate of air guided from the first inlet ventilation path to the outlet ventilation path, the air guided from the second inlet ventilation path to the outlet ventilation path, and air guided from the third inlet ventilation path to the outlet ventilation path, wherein
the processor is configured to adjust the ratio by controlling the adjuster based on the temperature of the air generated by the vehicle air-conditioning apparatus, and
when the temperature of the air generated by the vehicle air-conditioning apparatus is equal to or higher than a first temperature, the processor is configured to adjust the ratio in such a manner that a total of a flow rate of air guided from the first inlet ventilation path to the outlet ventilation path and a flow rate of air guided from the third inlet ventilation path to the outlet ventilation path is larger than a flow rate of air guided from the second inlet ventilation path to the outlet ventilation path.

15. The vehicle seat air-conditioning device according to claim 14, wherein
the processor is configured to adjust the ratio in such a manner that air is guided from the first inlet ventilation path and the third inlet ventilation path to the outlet ventilation path, when the temperature of the air generated by the vehicle air-conditioning apparatus is equal to or higher than the first temperature.

16. The vehicle seat air-conditioning device according to claim 14, wherein
the processor is configured to adjust the ratio in such a manner that air is guided from the first inlet ventilation path, the second inlet ventilation path, and the third inlet ventilation path to the outlet ventilation path, and the ratio increases in accordance with a decrease in the temperature of the air generated by the vehicle air-conditioning apparatus, when the temperature of the air generated by the vehicle air-conditioning apparatus is lower than the first temperature and equal to or higher than a second temperature lower than the first temperature.

17. The vehicle seat air-conditioning device according to claim 1, further comprising:
a first inlet ventilation path through which air sucked in by the blower passes from a first inlet provided in a front surface of the bottom that is a surface located to face the person seated on the seat;
a second inlet ventilation path through which air sucked in by the blower passes from a second inlet that is an inlet different from the first inlet and is provided at a position other than the front surface of the seat in the seat; and
an adjuster that adjusts a ratio of a flow rate of air guided from the second inlet ventilation path to the outlet ventilation path, to a total flow rate of air guided from the first inlet ventilation path to the outlet ventilation path and the air guided from the second inlet ventilation path to the outlet ventilation path, wherein
the processor is configured to adjust the ratio at a predetermined timing set based on an elapsed time or a temperature of air discharged from the first outlet, when a degree of feeling cool by the person seated on the seat indicated by the thermal sensation parameter is lower than a predetermined value.

18. The vehicle seat air-conditioning device according to claim 14, wherein
the processor is configured to adjust the ratio at a predetermined timing set based on an elapsed time or a temperature of air discharged from the first outlet, when a degree of feeling cool by the person seated on the seat indicated by the thermal sensation parameter is lower than a predetermined value.

19. The vehicle seat air-conditioning device according to claim 18, wherein
the processor is configured to:
adjust the ratio in such a manner that air is guided from at least the first inlet ventilation path and the third inlet ventilation path to the outlet ventilation path, when the temperature of the air generated by the vehicle air-conditioning apparatus is equal to or higher than a second temperature that is lower than the first temperature; and
adjust the ratio in such a manner that air is guided from the first inlet ventilation path and the second inlet ventilation path to the outlet ventilation path, when a degree of feeling cool by the person seated on the seat indicated by the thermal sensation parameter is lower than a predetermined value.

20. The vehicle seat air-conditioning device according to claim 19, wherein
the processor is configured to:
adjust the ratio in such a manner that air is guided from the first inlet ventilation path and the third inlet ventilation path to the outlet ventilation path, when the temperature of the air generated by the vehicle air-conditioning apparatus is equal to or higher than the first temperature; and
adjust the ratio in such a manner that air is guided from the first inlet ventilation path, the second inlet ventilation path, and the third inlet ventilation path to the outlet ventilation path, when the temperature of the air generated by the vehicle air-conditioning apparatus is lower than the first temperature and equal to or higher than the second temperature.
